(19) United States
(12) Patent Application Publication
(10) Pub. No.: US 2025/0103992 A1
(43) Pub. Date: Mar. 27, 2025

(54) SYSTEM AND METHOD FOR DETERMINING PAVEMENT CONDITION INDEX OF A FAMILY OF PAVEMENT

(71) Applicant: United States of America as Represented by The Secretary of the Army, Alexandria, VA (US)

(72) Inventors: Mohamed Y. Shahin, Windsor, CO (US); Robert E. Reinke, Indianapolis, IN (US); Spencer H. Dickey, Indianapolis, IN (US)

(21) Appl. No.: 18/372,136

(22) Filed: Sep. 25, 2023

(51) Int. Cl. G06Q 10/0637

(52) U.S. Cl. CPC G06Q 10/06375

(57) ABSTRACT

A specialized computer running pavement management application (PMA) software may be configured to apply risk cost and return on investment analysis to determine an optimized work plan for maintenance and repairs of a network of pavement sections. The PMA may be configured to incorporate global maintenance and repair activities (such as surface treatments), major maintenance and repair activities (such as overlays and reconstruction), and localized preventative maintenance and repair activities (such as crack sealing and patching).

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### CROSS CITATIONS

Co-pending application (COE-871A) filed on the same day as this application and incorporated by reference in its entirety contains detailed information on determining estimated uniform annual cost with and without global M&R at time tₑᵥₐₗ; localized cost component of estimated uniform annual cost for Global and Major M&R; and estimated uniform annual cost with and without major M&R at time tₑᵥₐₗ.

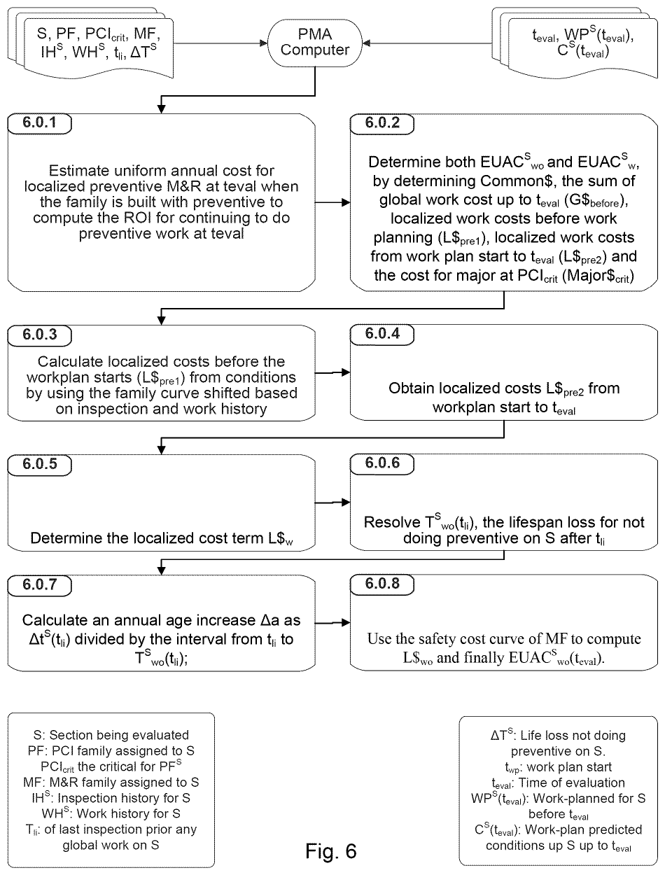

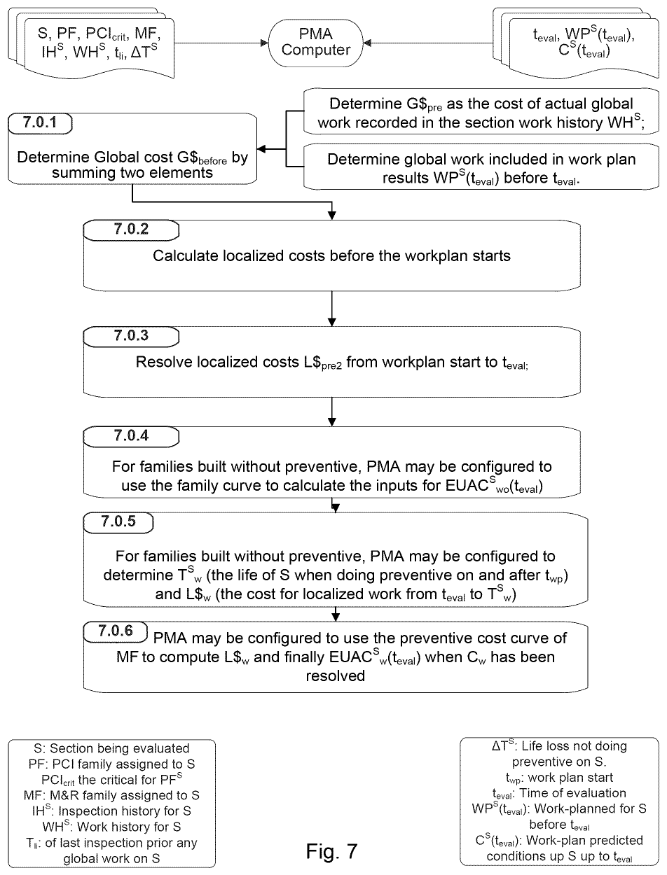

Co-pending application (COE-871C) filed on the same day as this application and incorporated by reference in its entirety contains detailed information on the algorithm and method to: determine critical estimated uniform annual costs for preventive M&R at tₑᵥₐₗ when the family is built with preventive to compute the ROI for continuing to do preventive work at tₑᵥₐₗ; determine critical estimated uniform annual costs for preventive M&R at tₑᵥₐₗ when the family is built with preventive to compute the ROI for starting to do preventive work at tₑᵥₐₗ (see FIG. 6B and related description); estimate uniform annual cost for localized preventive M&R at tₑᵥₐₗ when the family is built without preventive to compute the ROI for continuing to do preventive work at tₑᵥₐₗ; and determine estimated uniform annual cost for localized preventive M&R at tₑᵥₐₗ when the family is built without preventive to compute the ROI for starting to do preventive work at tₑᵥₐₗ (see FIG. 7B and related description).

### FIELD OF INVENTION

This invention relates to systems and methods for repairing pavement.

### BACKGROUND OF THE INVENTION

The U.S. Government is responsible for the repair and maintenance of billions of dollars of infrastructure assets, including roads, parking lots, airfields and buildings. The government and industry use standardized classification systems to assess and rank the condition in order of these assets to prioritize repairs and allocate resources.

Some classifications systems may classify cracks or faults in pavements as low, medium, or high severity. Roads and pavement may have deteriorations. The severity of each deterioration factor identified in an asset is recorded, and the frequency of occurrences is tracked. An asset having less severe manifestations of a deterioration factor may have a higher density (more frequent) manifestations. Conversely, an asset with few manifestations of a deterioration factor could have instances which are severe and warrant more immediate attention.

It is difficult to compare assets (roads, bridges, etc.) It is difficult to compare assets having many instances of deterioration factors at multiple levels of severity, and to accurately prioritize them for repair. For example, it is difficult to determine how particular assets including roads, bridges, walls, and other structures exhibiting anywhere from dozens to thousands of deterioration factors having various levels of severity and density should be prioritized.

The following materials and patents provide background information on the invention.
Patent: US 2010/0235203 A1 (incorporated by reference in its entirety), titled “Engineered Management System Particularly Suited for Maintenance and Repair (M&R) Management of Structure Such as Pavements.”
U.S. Pat. No. 10,936,282 B2 (incorporated by reference in its entirety), titled “System for Processing Multi-Level Condition Data to Achieve Standardized Prioritization.”
Textbook: Shahin, M. Y., “Pavement Management for Airports, Roads, and Parking Lots”, Second Edition.
U.S. Air Force Technical Letter (ETL), “Preventive Maintenance Plan (PMP) for Airfield Pavements.”
Shahin, M. Y. and Dodson, E. “Procedures for Determining the Risk of Not Performing Pavement Preventive Maintenance”, 17^{th} International Road Federation World Meeting, November 2013.

### BRIEF SUMMARY OF THE INVENTION

Configurations of the present invention may also relate to a PMA computer comprising a processor and tangible memory storing non-transitory computer readable software configured to cause the processor to execute a pavement repair program specialized in determining major maintenance and repair costs (Major M&R). The program may comprise an input interface configured to allow a user to specify to the program: a Section of pavement for evaluation (S); a PCI family (PF) assigned to Section (S) defined as PF^{S}; wherein PCI is a pavement condition index of the Section; an input estimated critical PCI (PCI_{crit}) for PF^{S}; a M&R family (MF^{S}) assigned to S; an inspection history (IH^{S}) for S; a work history (WH^{S}) for S; a work plan start (t_{WP}); a time of evaluation (tₑᵥₐₗ); a work-planned work for S before (tₑᵥₐₗ); and a work-plan predicted conditions (C^{S}(tₑᵥₐₗ)) for S up to tₑᵥₐₗ.

Configurations of the present invention may also relate to a PMA computer comprising a PCI_{crit} determination module configured to indicate a point in time wherein spending additional resources on preventive maintenance work no longer economically makes sense to perform on a local or global level on a section in the family. The pavement repair program may be configured to use a calculated value of critical PCI to determine an ROI calculation requiring a method of determining PCI_{crit} without relying on the calculated value of PCI_{crit}. The program may be configured to use a loop setting PCI_{crit} for PF to the current estimate C_{curr}. The program may comprise a EUAC calculator configured to execute a program loop comprising steps of: determining EUAC for major repairs to calculate the ROI for major work at each age from 0 to t_{recon}; using ROI^{PF}(t) to resolve the ROI; and determining a critical PCI for a PCI family PF.

Configurations of the present invention may also relate to a computer comprising a processor and tangible memory storing non-transitory computer readable software configured to cause the processor to execute a pavement repair program specialized in determining major maintenance and repair costs (Major M&R). The program may comprise an input interface configured to allow a user to specify to the program: a Section of road for evaluation (S); a PCI family (PF) assigned to Section (S) defined as PF^{S}; wherein PCI is a pavement condition index of the Section; an input estimated critical PCI (PCI_{crit}) for PF^{S}; a M&R family (MF^{S}) assigned to S; an inspection history (IH^{S}) for S; a work history (WH^{S}) for S; a work plan start (t_{wp}); a time of evaluation (tₑᵥₐₗ); a work-planned work for S before (tₑᵥₐₗ); and a work-plan predicted conditions (C^{S}(tₑᵥₐₗ)) for S up to tₑᵥₐₗ.

The pavement repair program may be configured to analyze two different scenarios depending on whether the PCI family assigned to S was built using data from sections on which localized preventive was performed regularly (“family built with preventive maintenance”) or not (“family built without preventive maintenance”). For scenarios involving a PCI family built with preventive maintenance, the pavement repair program may be configured to: use the PCI family to determine EUAC^{S}_{w}(tₑᵥₐₗ); and estimate a lifespan loss of the Section for not doing preventive maintenance. For scenarios involving a PCI family built without preventive maintenance, the pavement repair program may be configured to estimate the lifespan gain for doing preventive maintenance. The repair program may be configured to calculate K₂₀.

### Color Drawings

The patent or application file contains at least one drawing executed in color. Copies of this patent or patent application publication with color drawing(s) will be provided by the Office upon request and payment of the necessary fee.

### BRIEF DESCRIPTION OF THE DRAWINGS

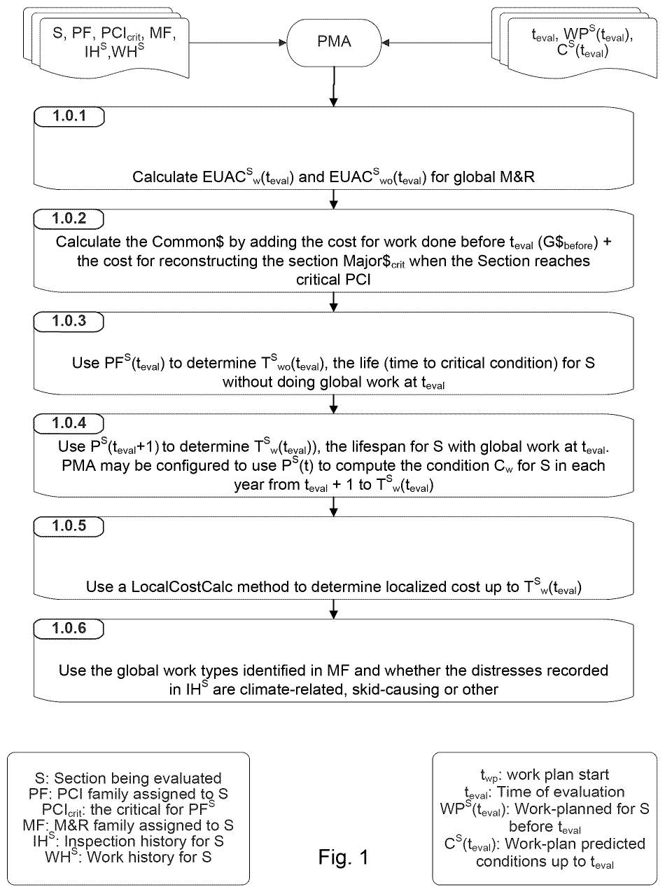

FIG. 1 is a flowchart for a method of determining estimated uniform annual cost with and without global M&R at time tₑᵥₐₗ.

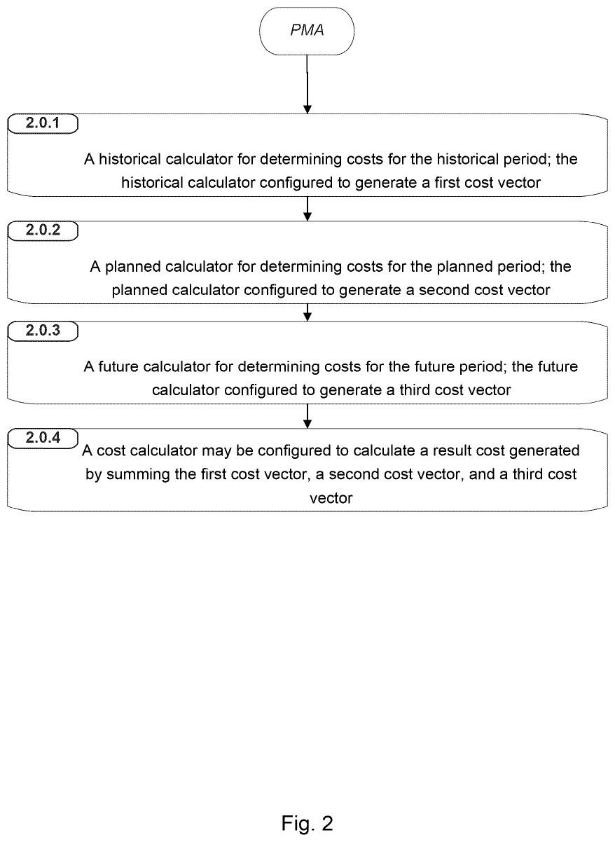

FIG. 2 is a flowchart for calculating the localized cost component of estimated uniform annual cost for Global and Major M&R.

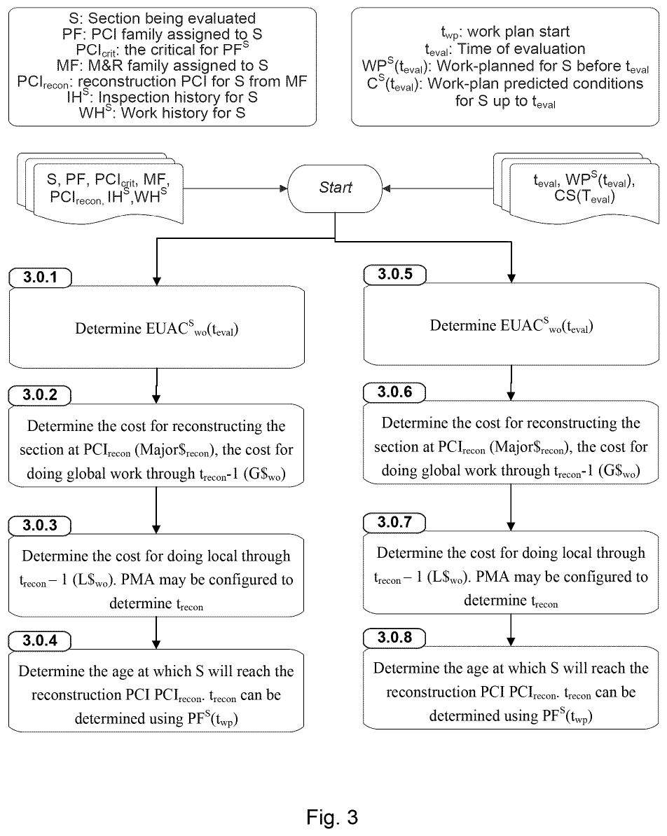

FIG. 3 is a flowchart for determining estimated uniform annual cost with and without major M&R at time tₑᵥₐₗ.

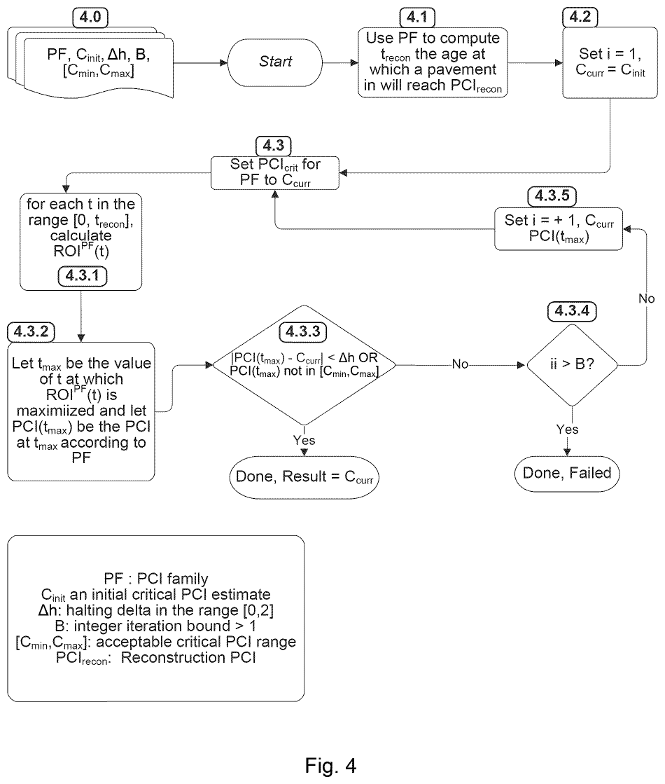

FIG. 4 is a flowchart detailing an algorithm for using major ROI calculation to determine critical PCI for a PCI family PF.

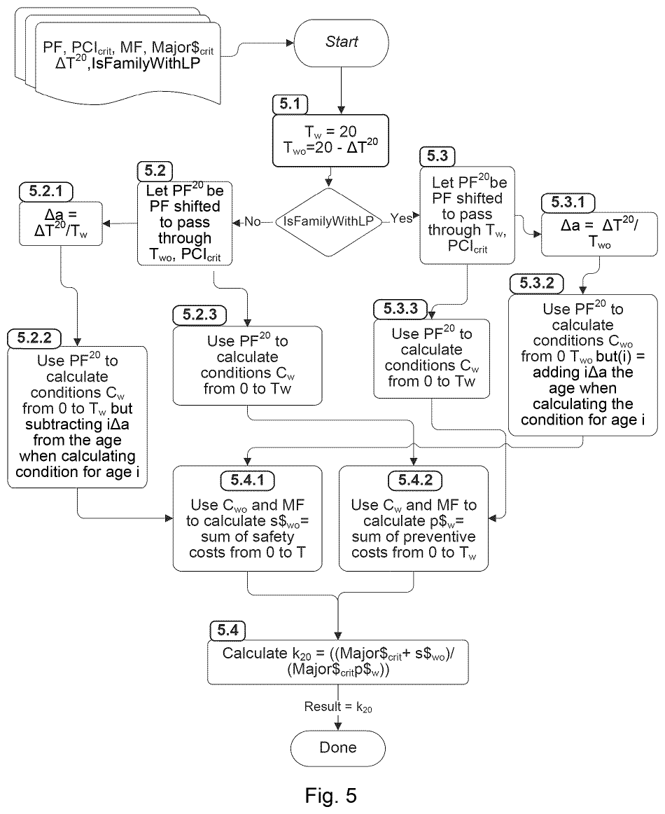

FIG. 5 is a flowchart for calculating the value of k₂₀ in the proportionality function P(PF, MF).

FIG. 6 is a flowchart for determining an estimated uniform annual cost for localized preventive M&R at tₑᵥₐₗ when the family is built with preventive to compute the ROI for continuing to do preventive work at tₑᵥₐₗ.

FIG. 7 is a flowchart for determining estimated uniform annual cost for localized preventive M&R at tₑᵥₐₗ when the family is built without preventive to compute the ROI for continuing to do preventive work at tₑᵥₐₗ.

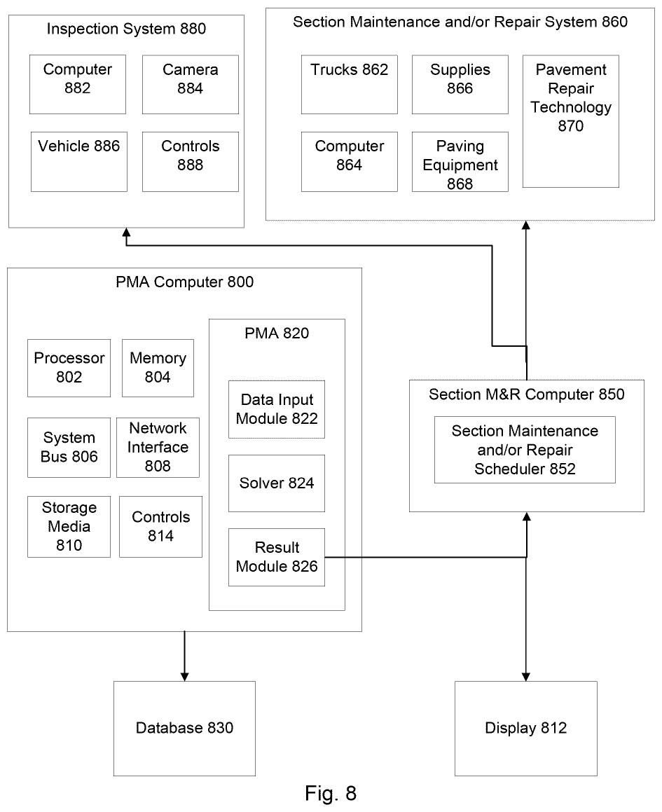

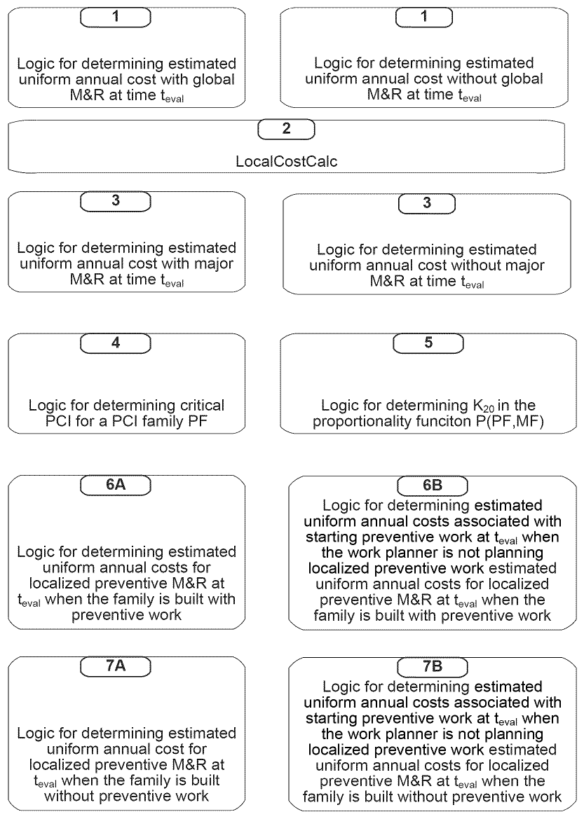

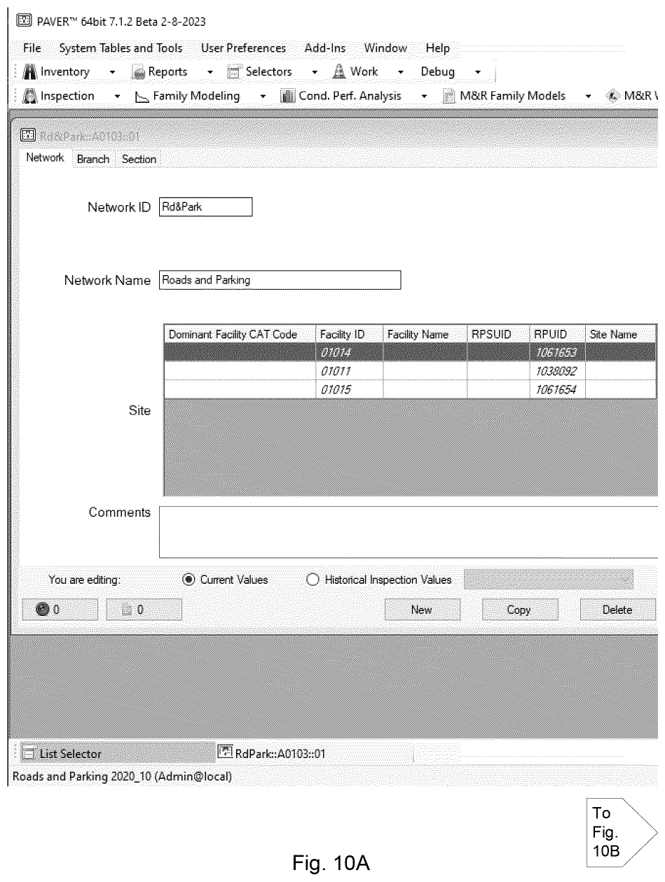

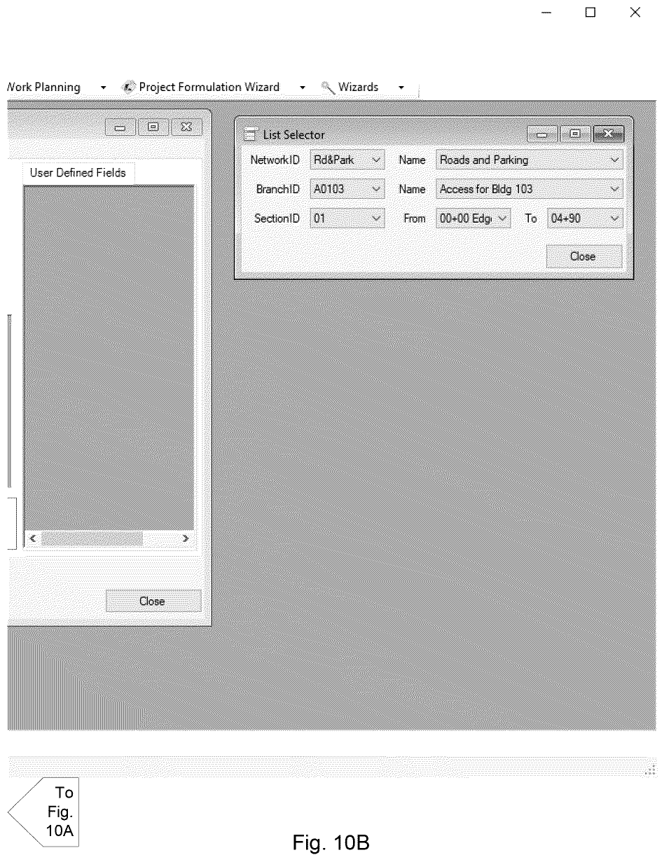

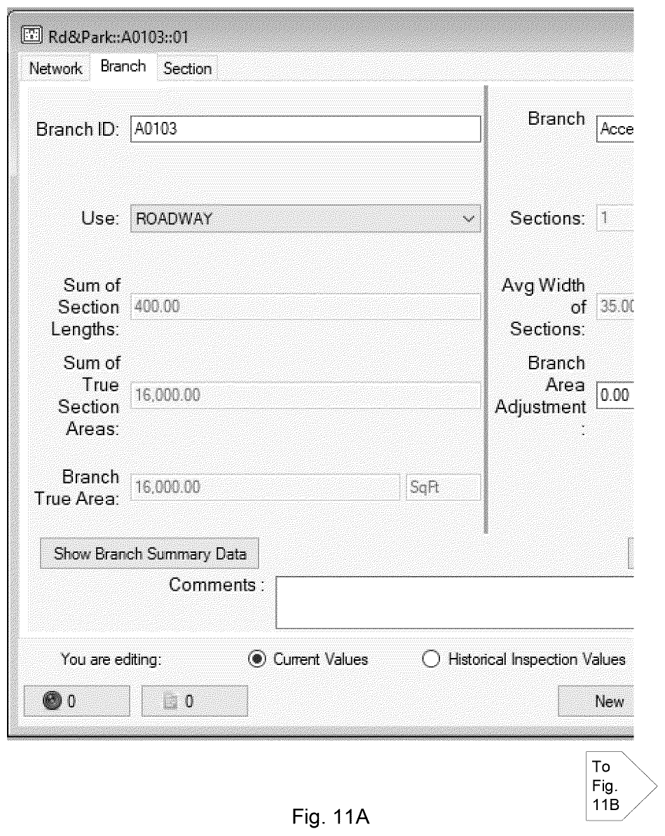

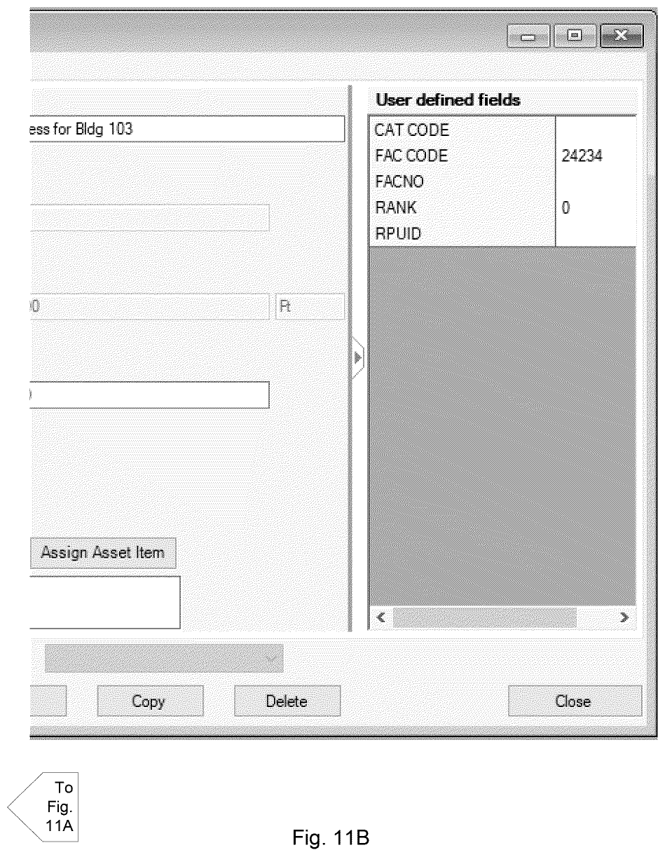

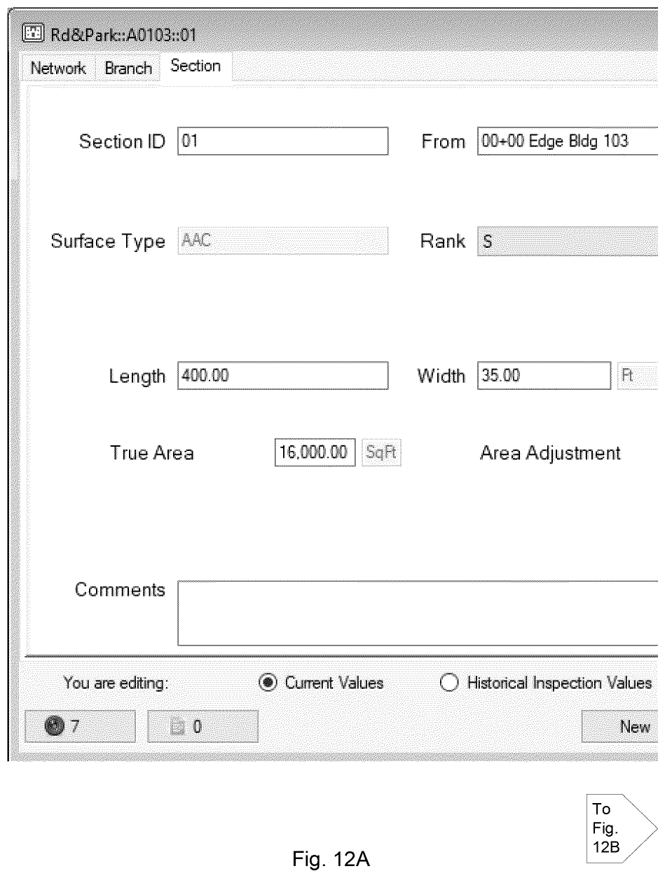

FIG. 8 shows a schematic view of the PMA computer section M&R computer, inspection system and section maintenance and/or repair system.

FIG. 9 shows an overall view of various algorithms that PMA may be programmed to execute.

FIGS. 10A-10B shows an inventory window in PMA.

FIGS. 11A-11B show the inventory window of the branch tab, the branch tab may show branch properties.

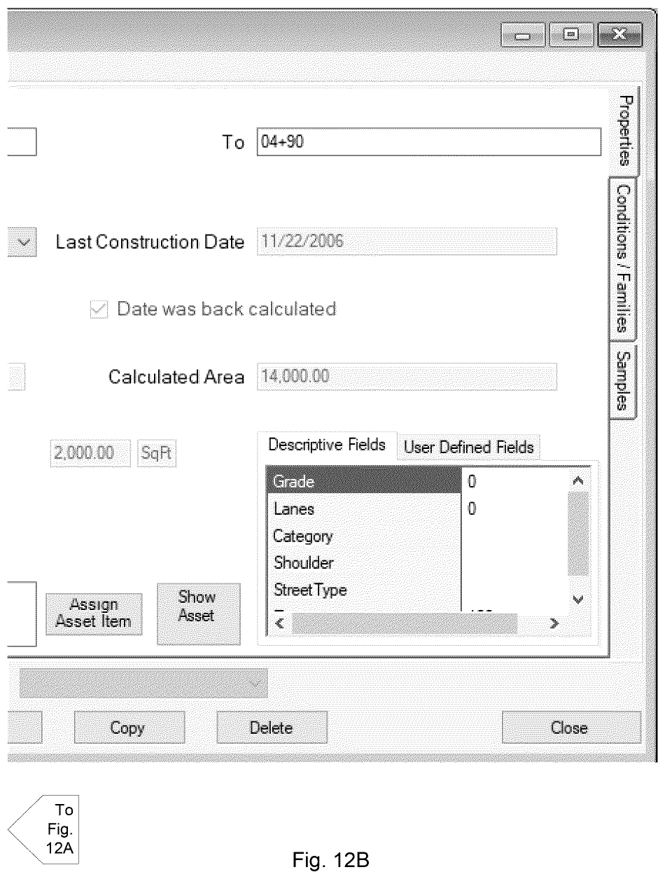

FIGS. 12A-12B shows the inventory window of the section tab.

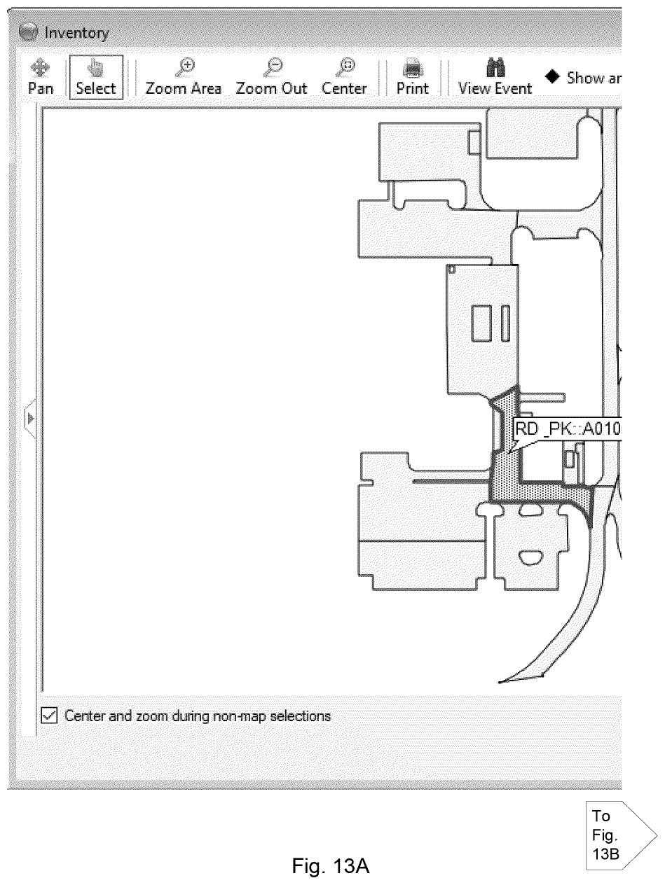

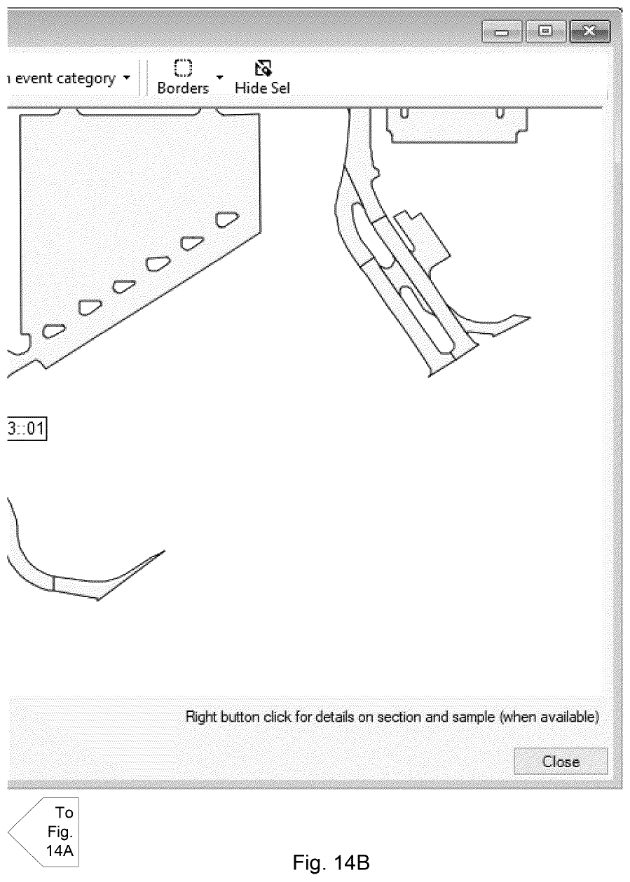

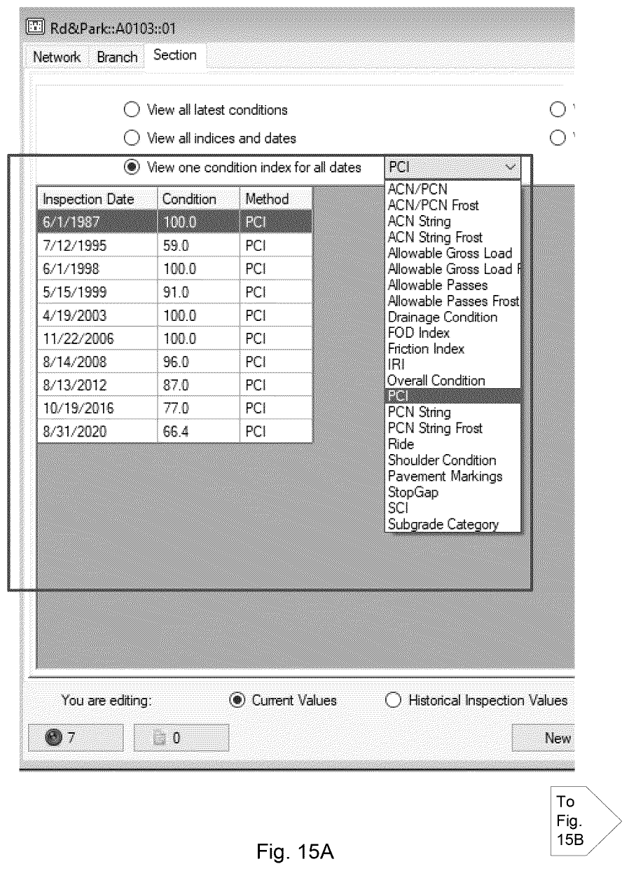

FIGS. 13A-13B shows a window of GIS maps. GIS Maps can be used to give context to the inventory. FIGS. 13A-13B show a current selection section.

FIGS. 14A-14B shows the inventory window with the conditions/families tab selected.

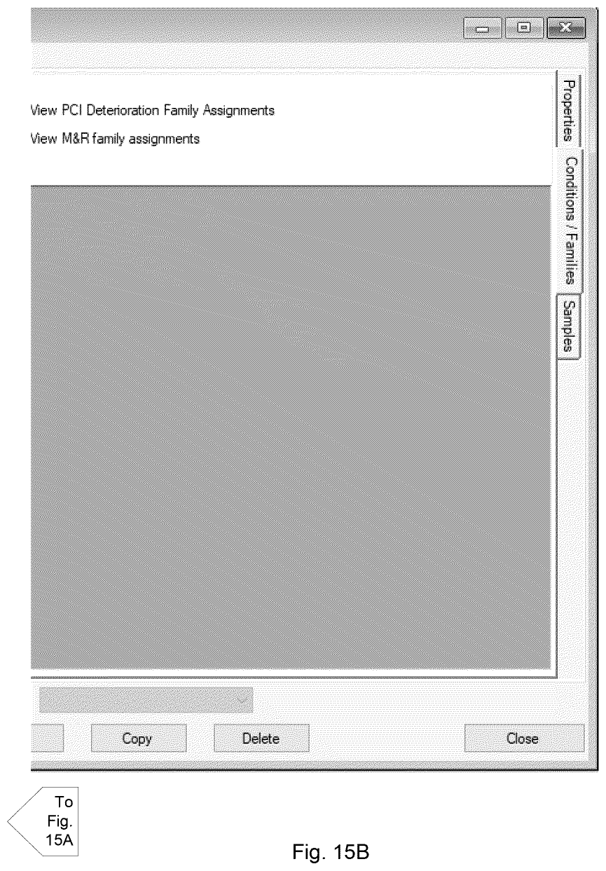

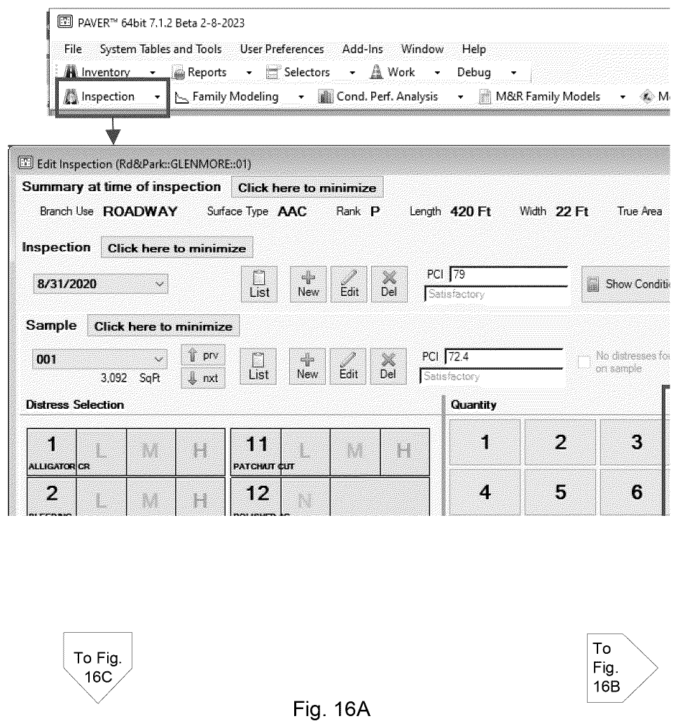

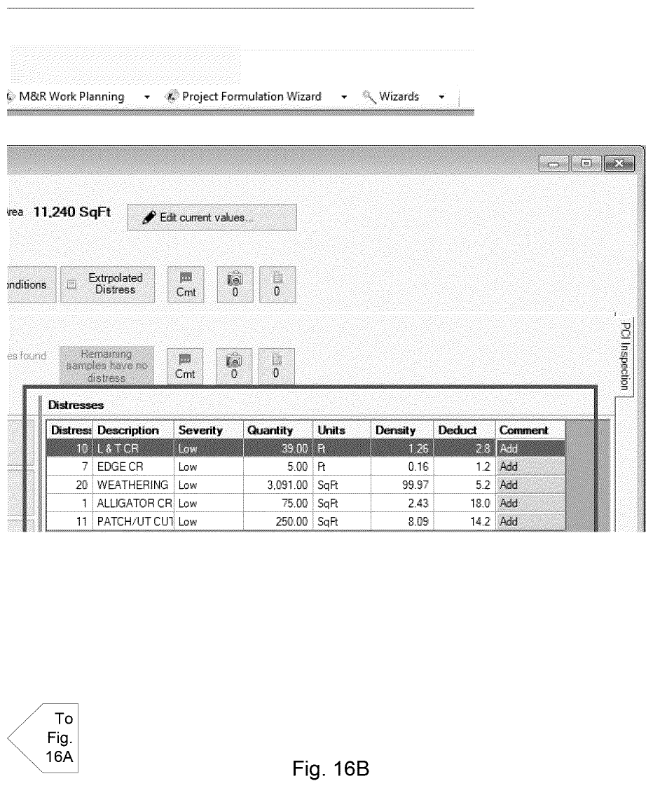

FIGS. 15A-15B shows the inventory window with the conditions/families tab selected and the view M&R family assignments radial selector selected. The box indicates M&R families (MF) assigned to this section.

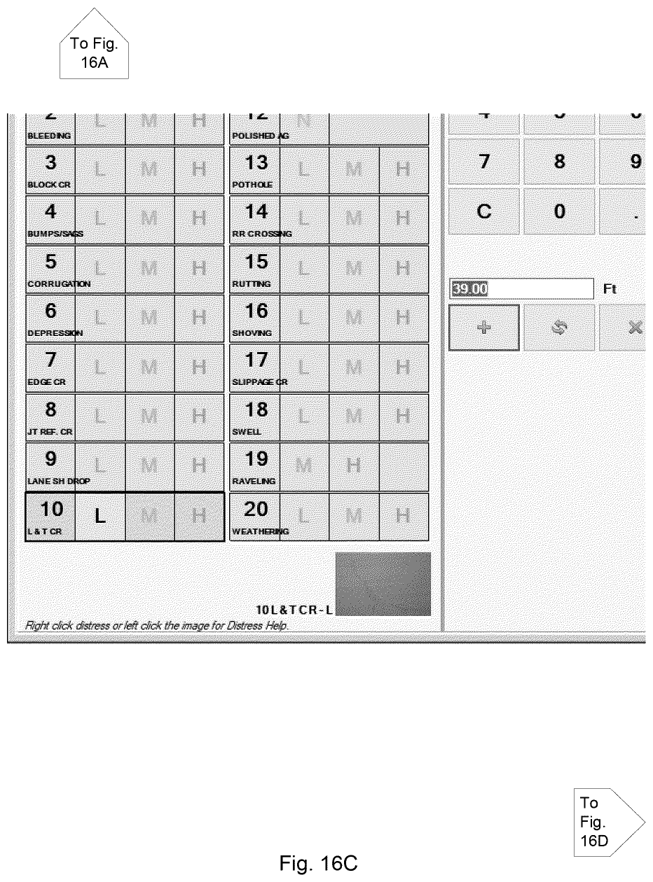

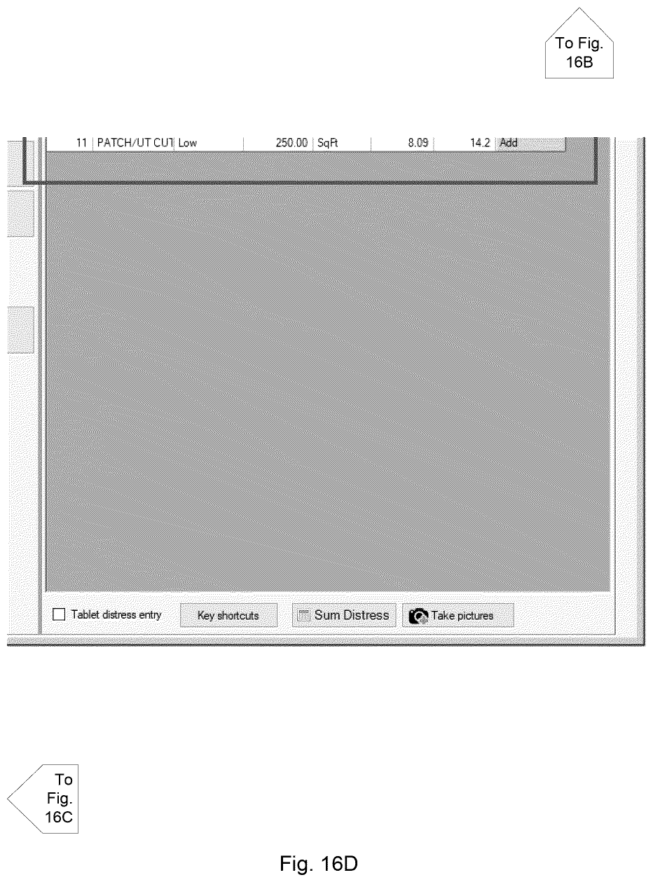

FIGS. 16A-16D shows an inspection window of the inspection submenu.

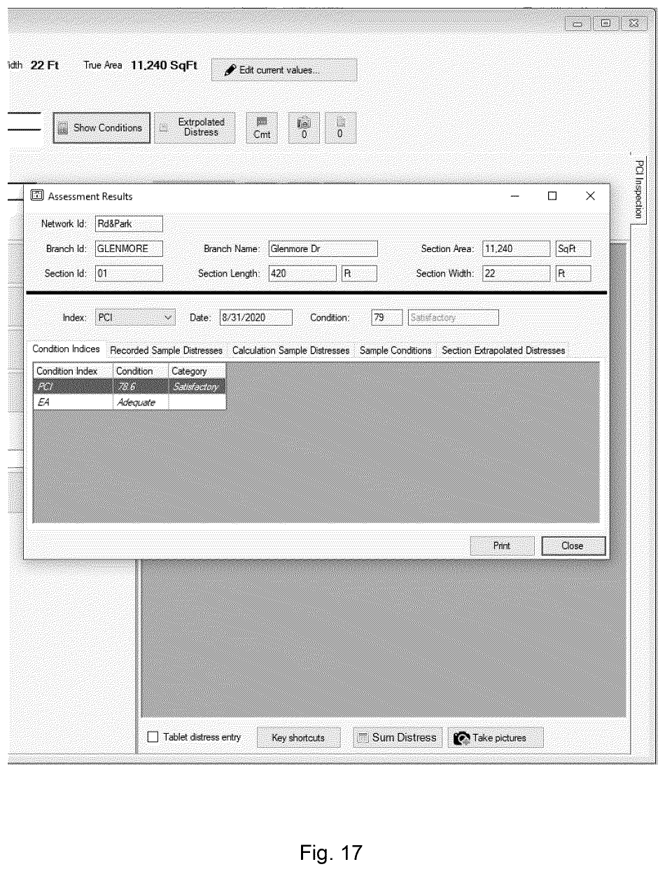

FIG. 17 shows a window called or displayed when the show conditions button is clicked.

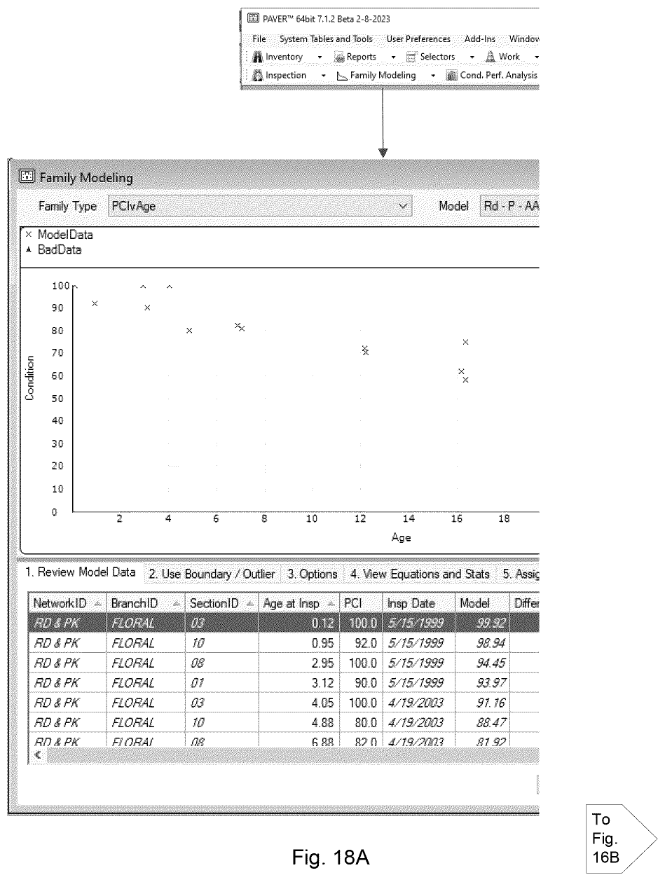

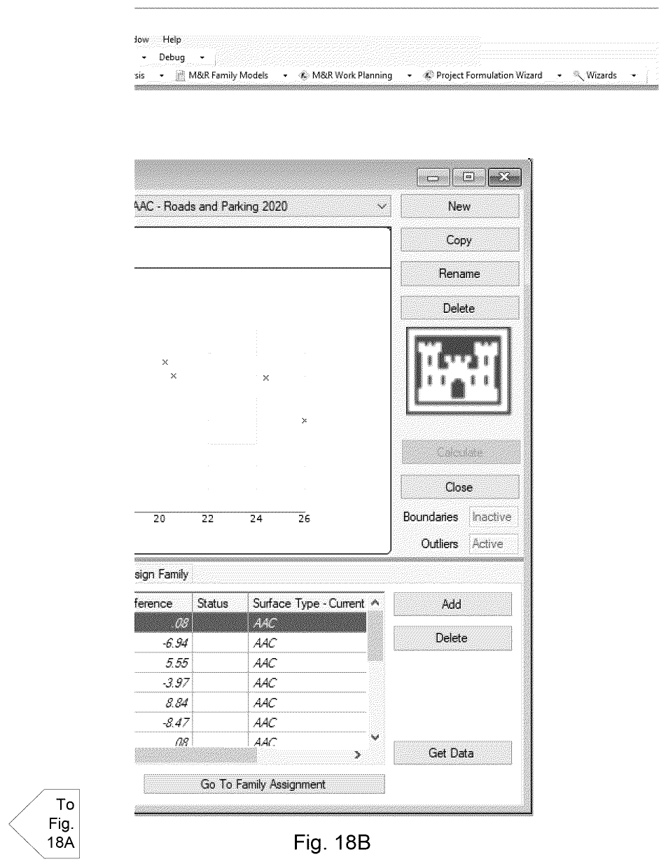

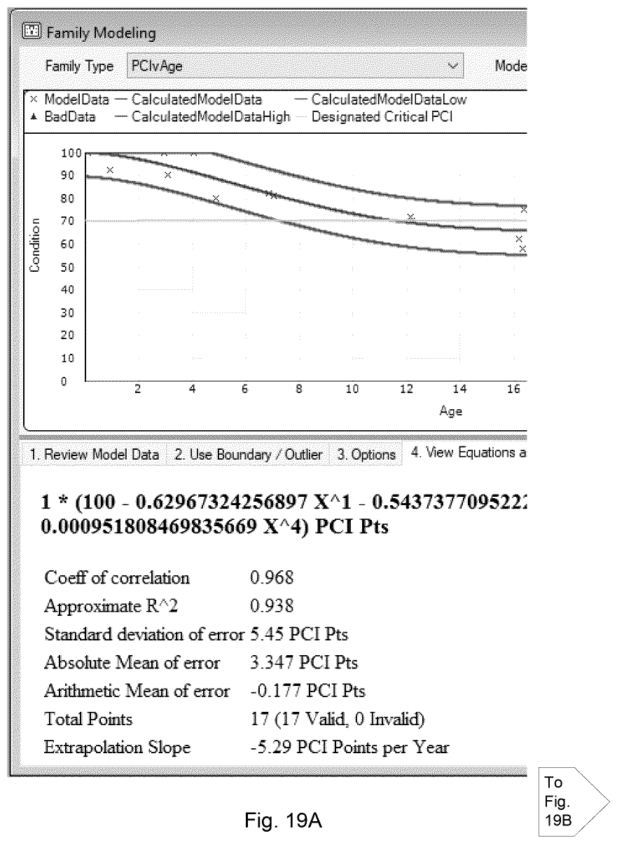

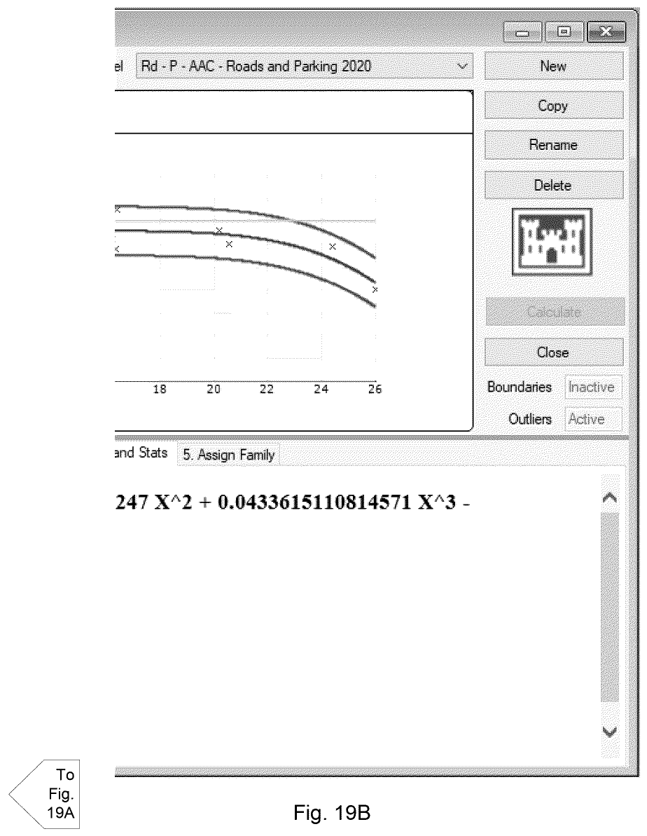

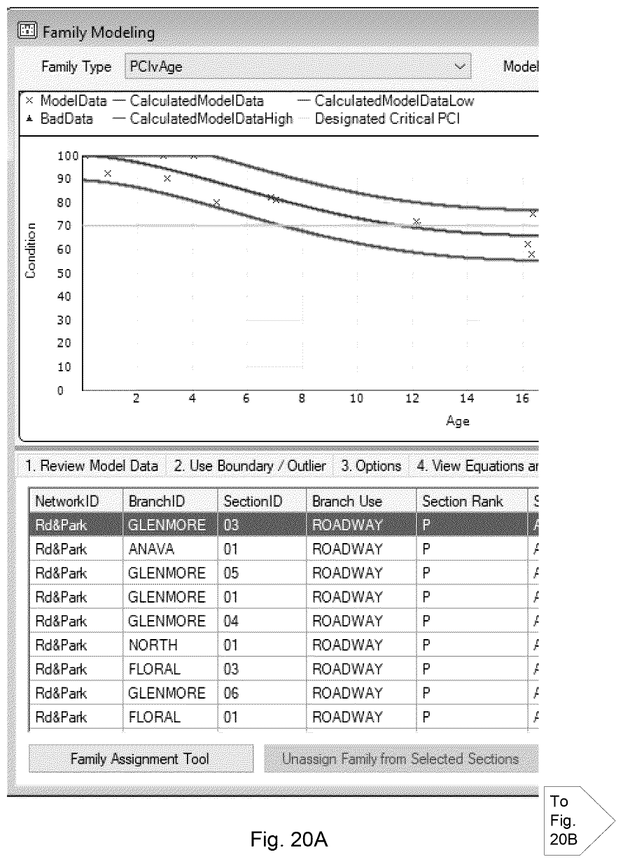

FIGS. 18A and 18B show a PCI Family Models (PF) window.

FIGS. 19A and 19B show the PCI family model window with the view equations and stats tab selected.

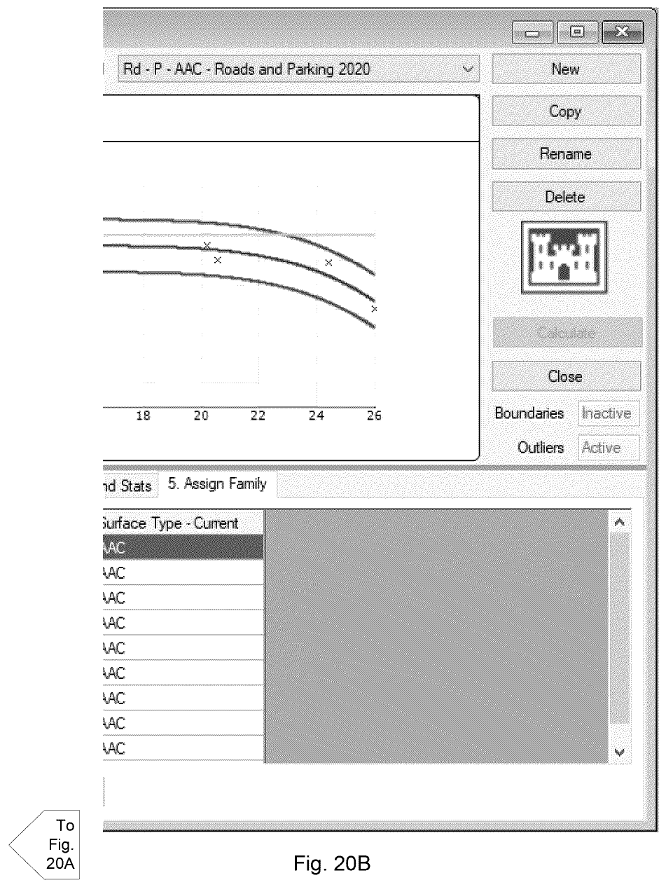

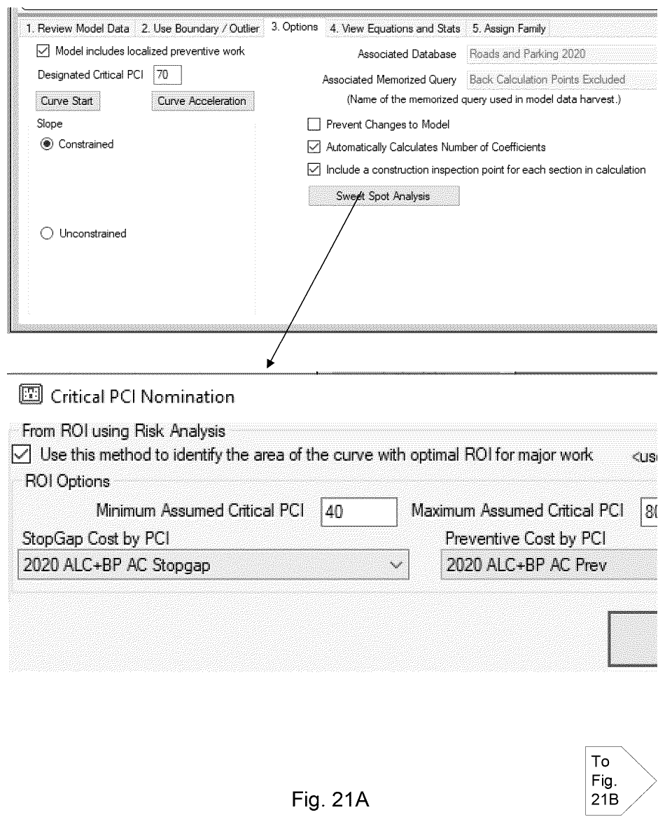

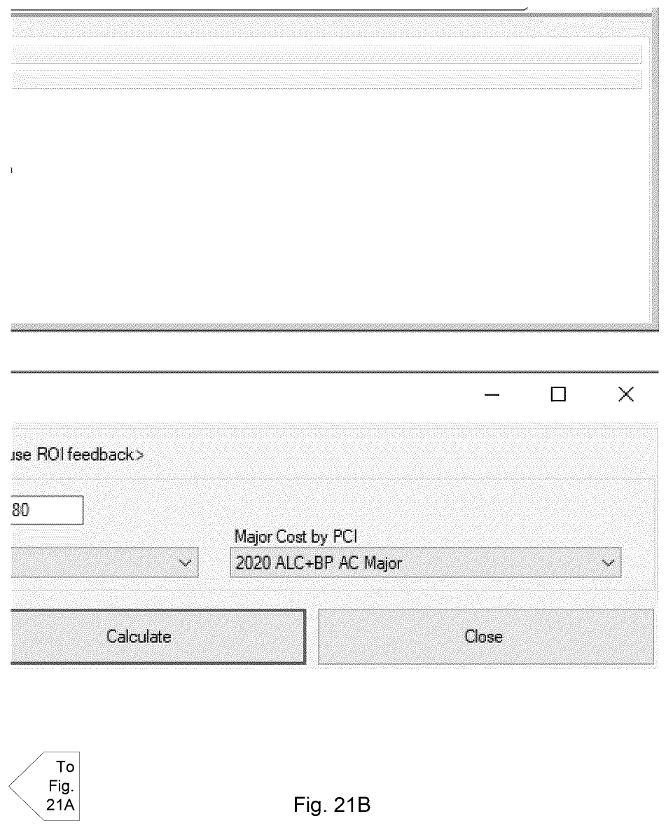

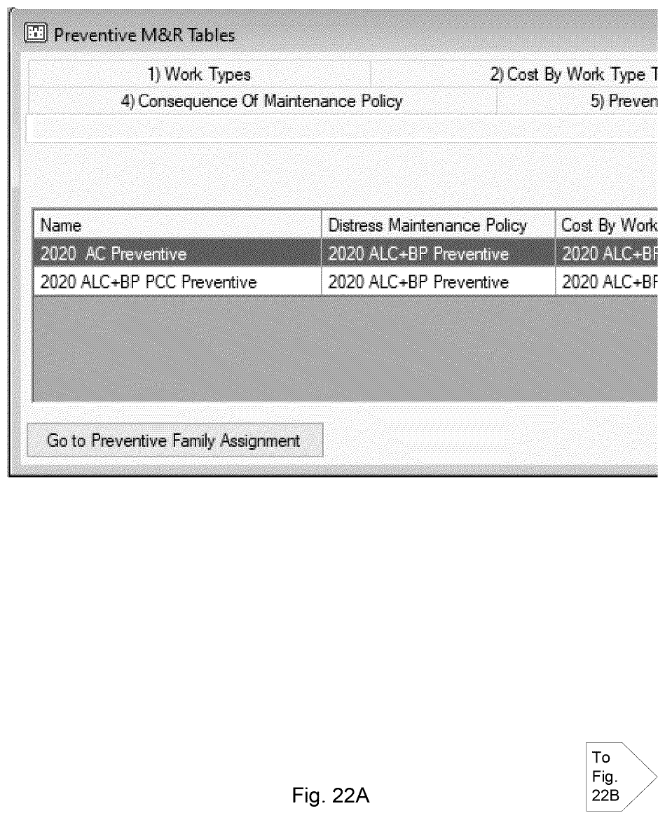

FIGS. 20A and 20B show the PCI family model window with the Assign Family tab selected.

FIGS. 21A and 21B show the PCI family model window with the Assign Family tab selected, but the top graph is not shown for illustration purposes.

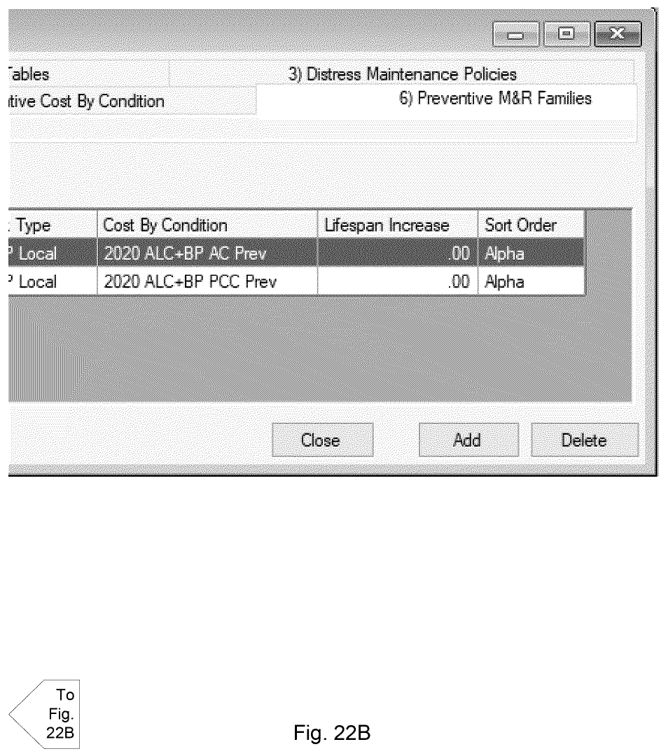

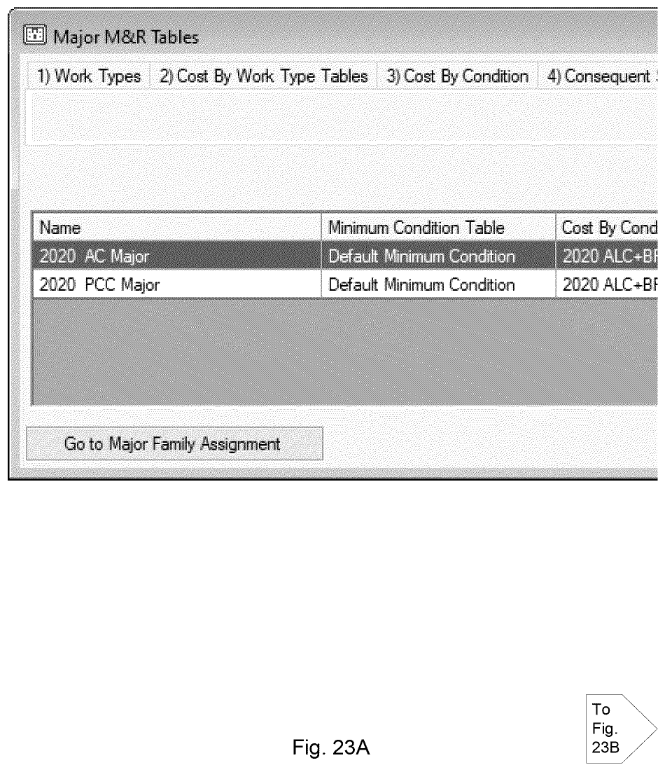

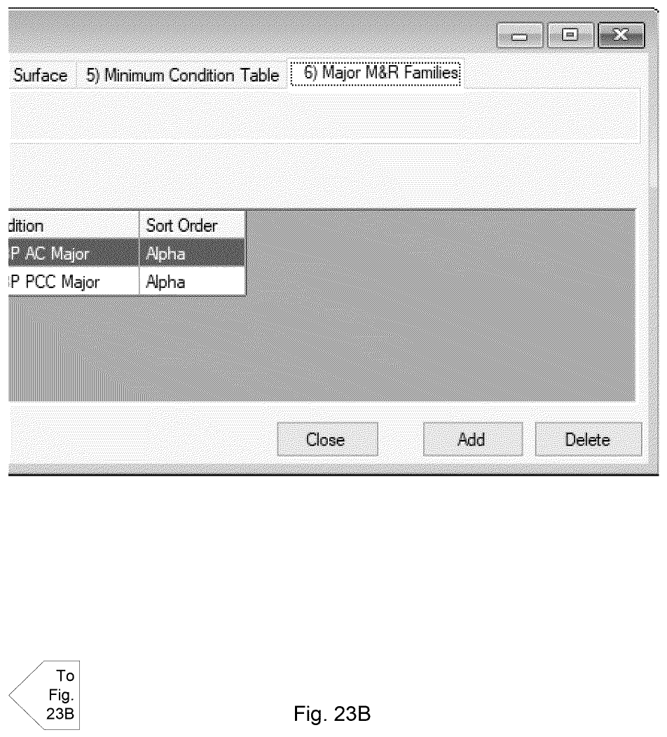

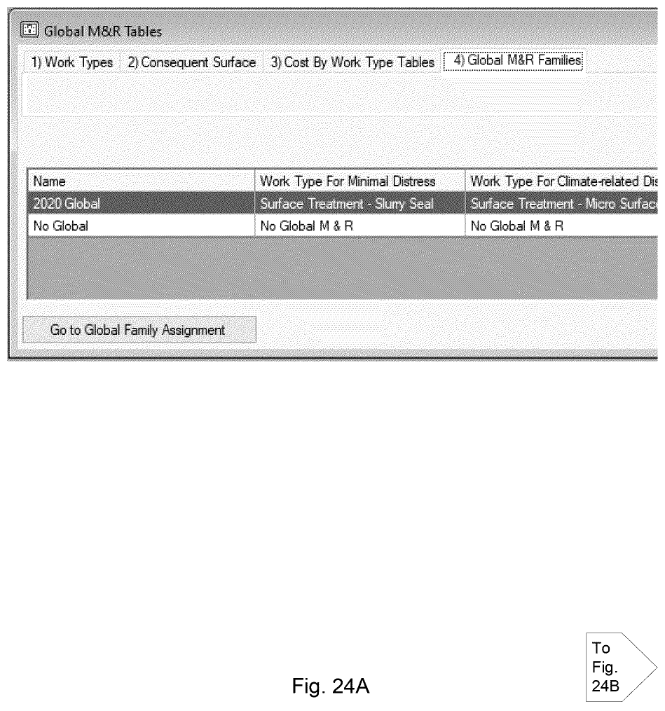

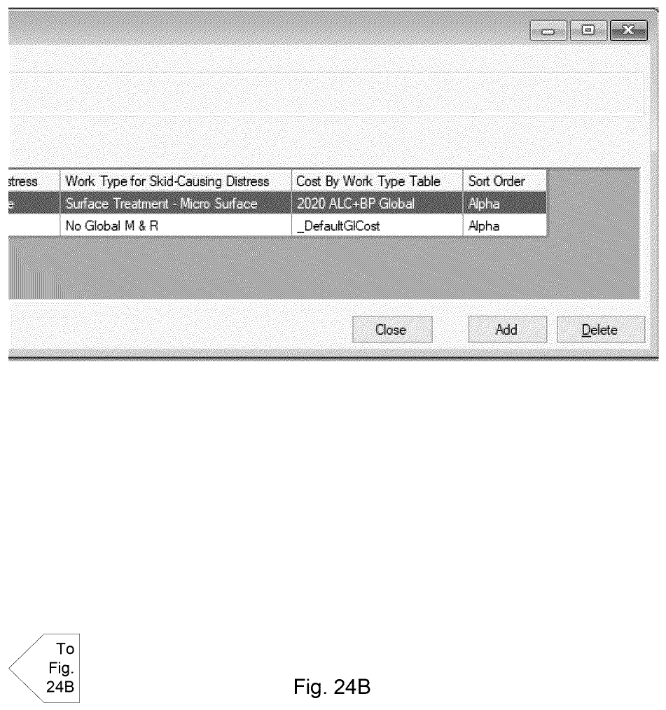

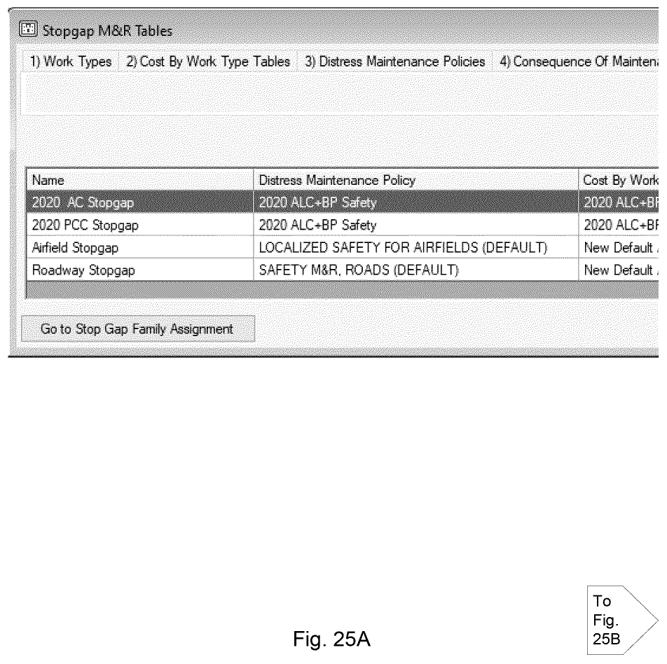

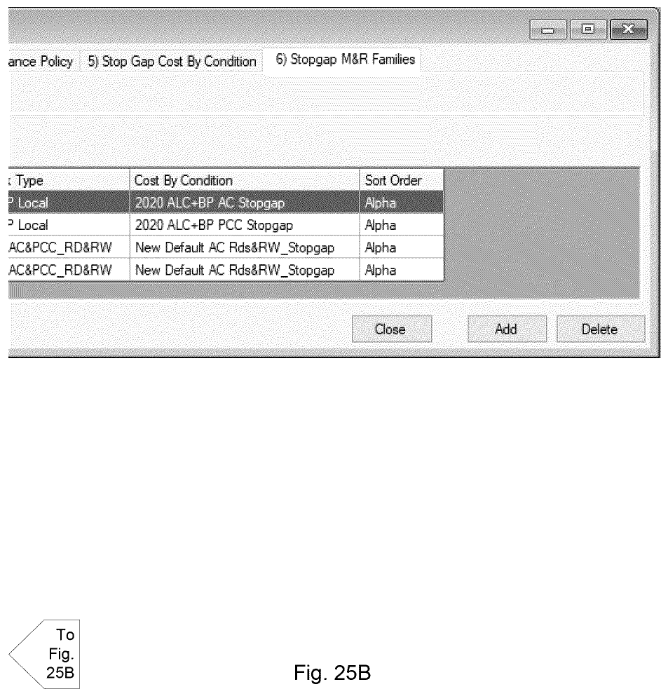

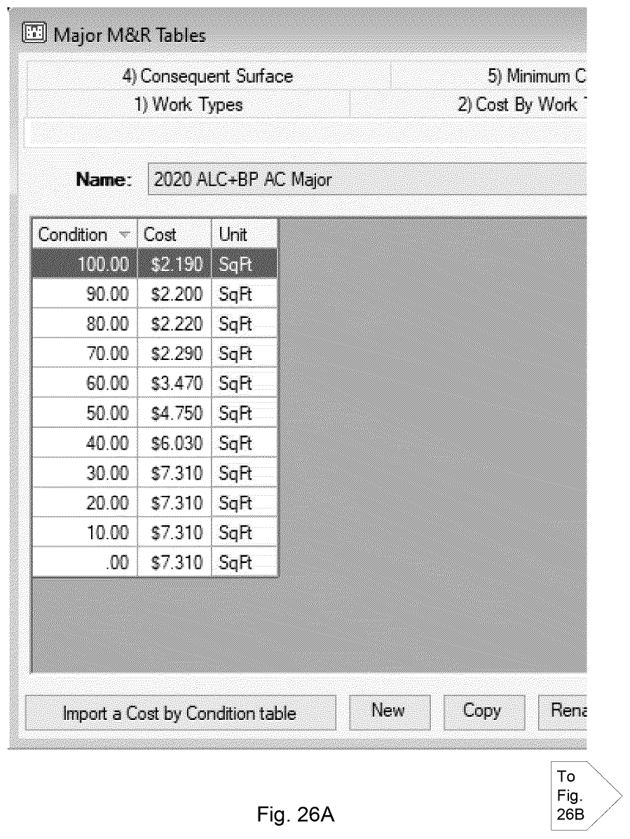

FIGS. 22A-22B, 23A-23B, 24A-24B, 25A-25B show examples of M&R Family windows.

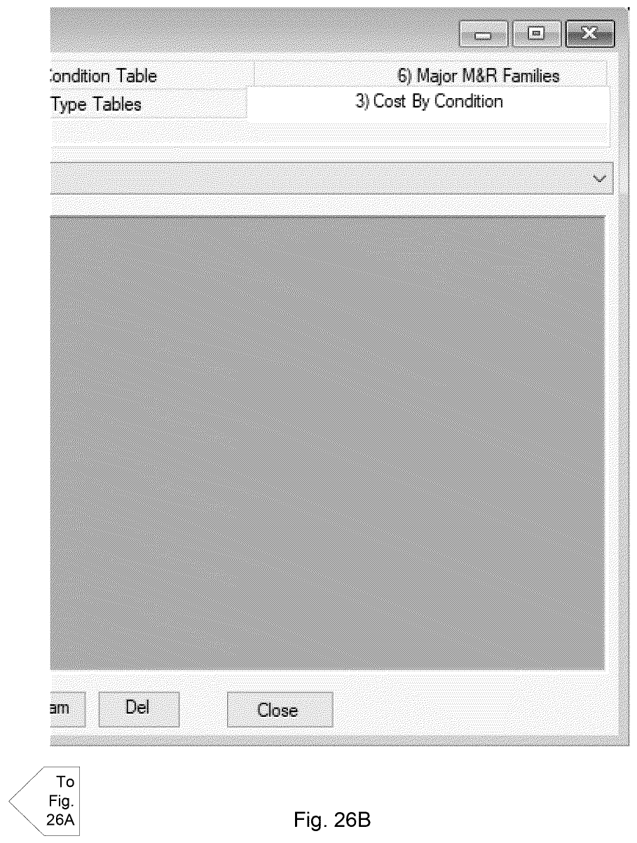

FIGS. 26A and 26B show a major M&R cost table window.

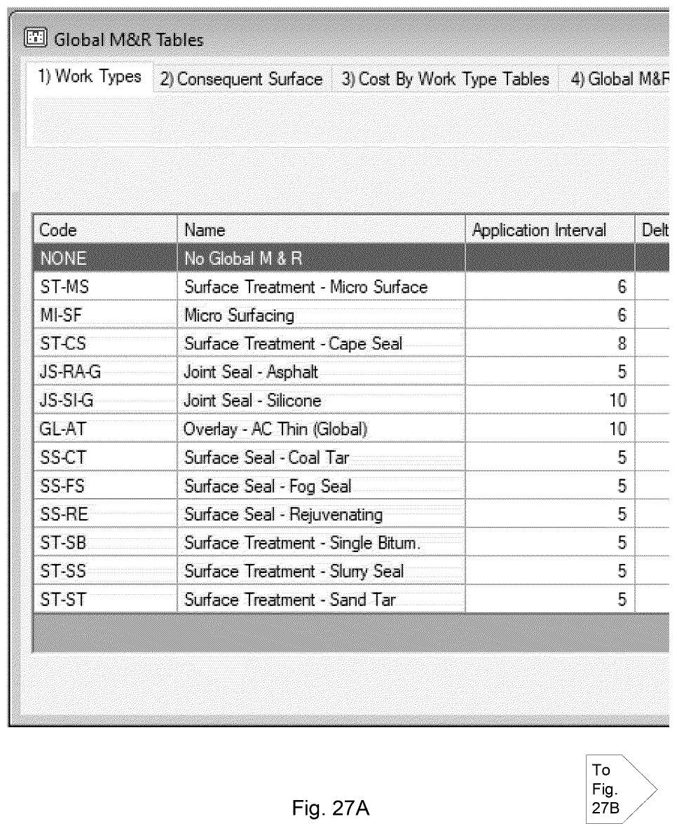

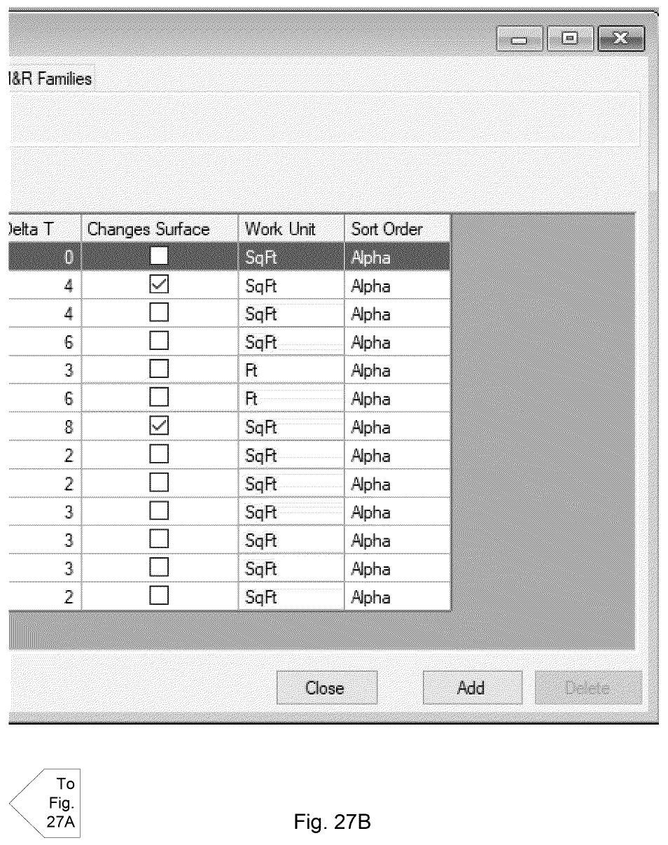

FIGS. 27A and 27B show a global M&R work type window.

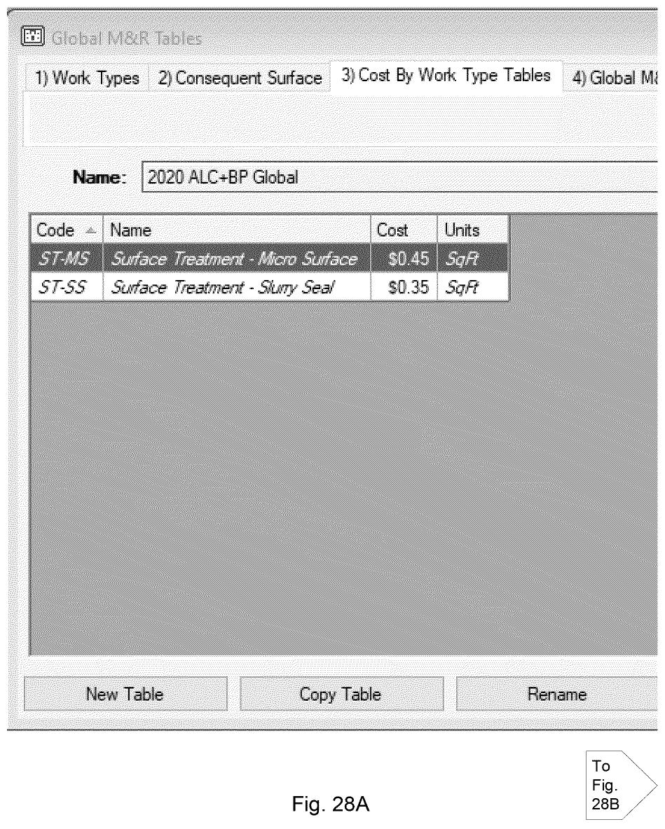

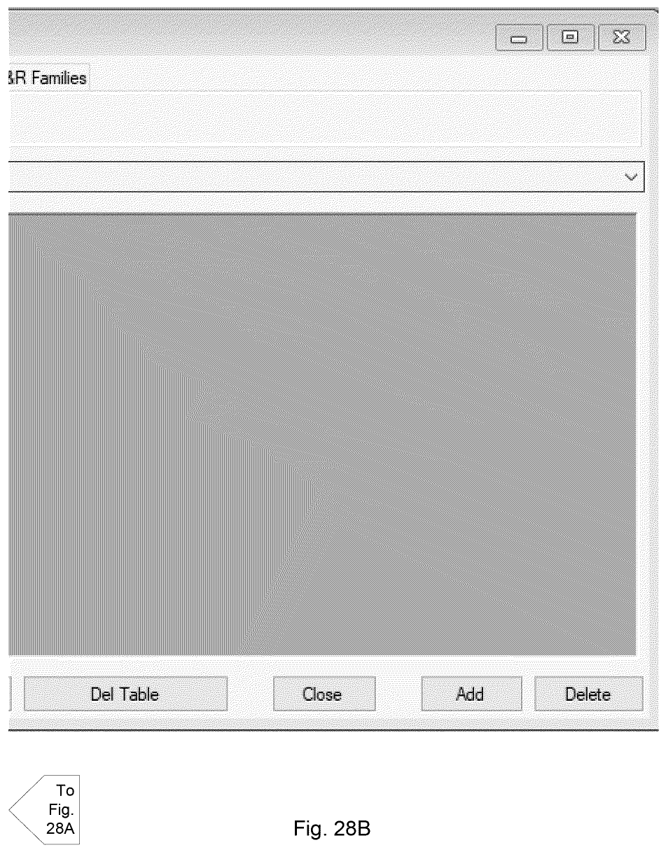

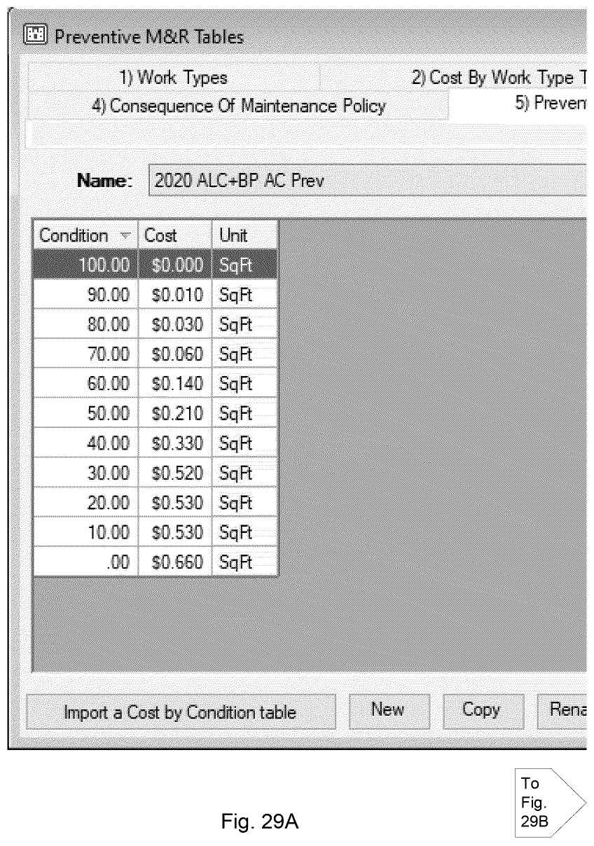

FIGS. 28A and 28B show a global work is priced by work types instead of condition.

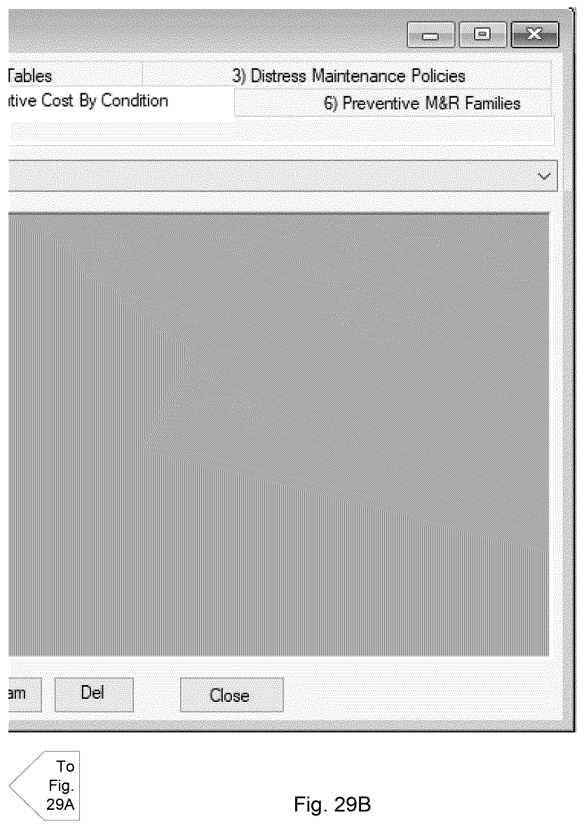

FIGS. 29A-29B shows a window for preventative cost by condition.

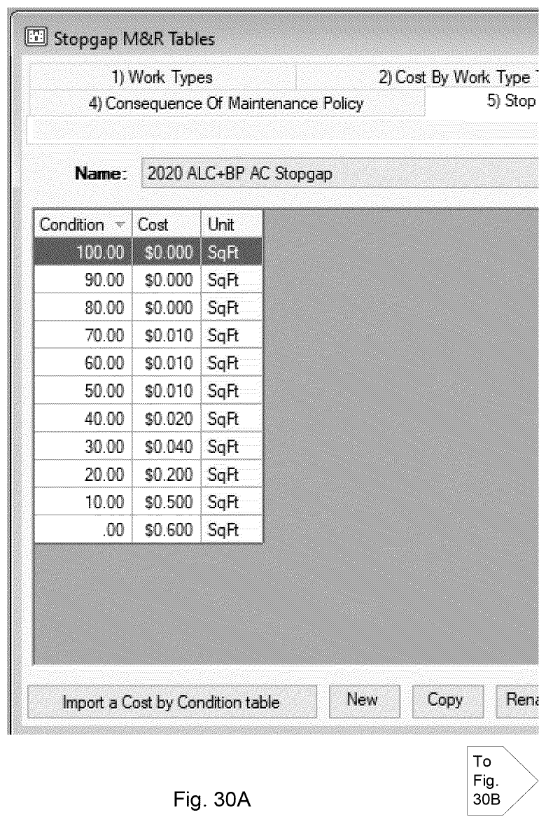

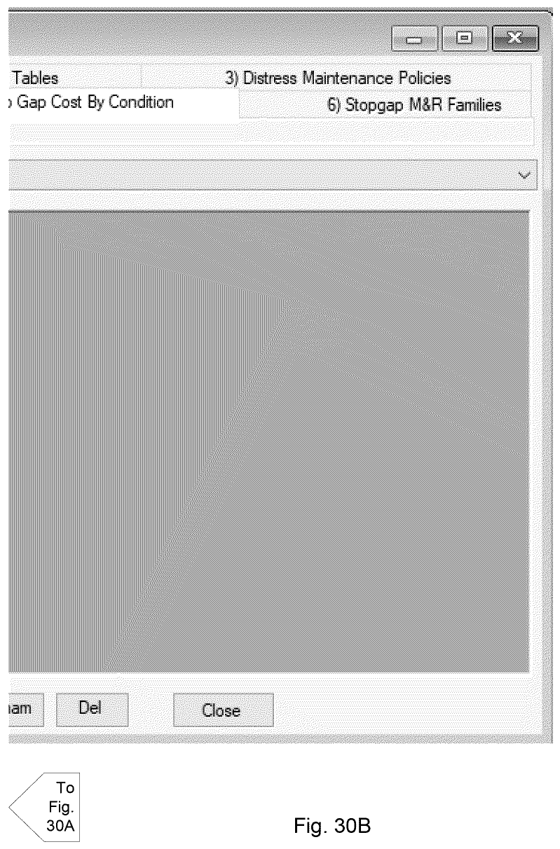

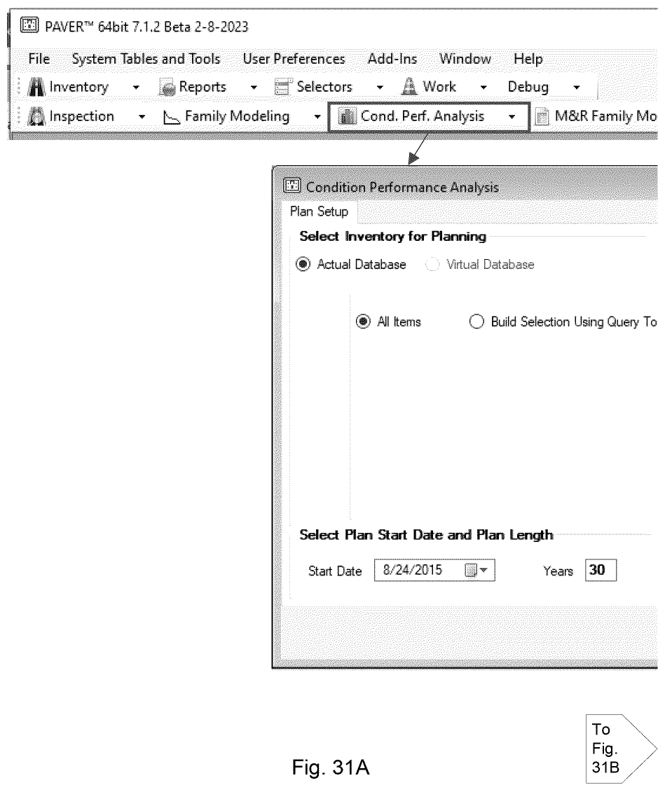

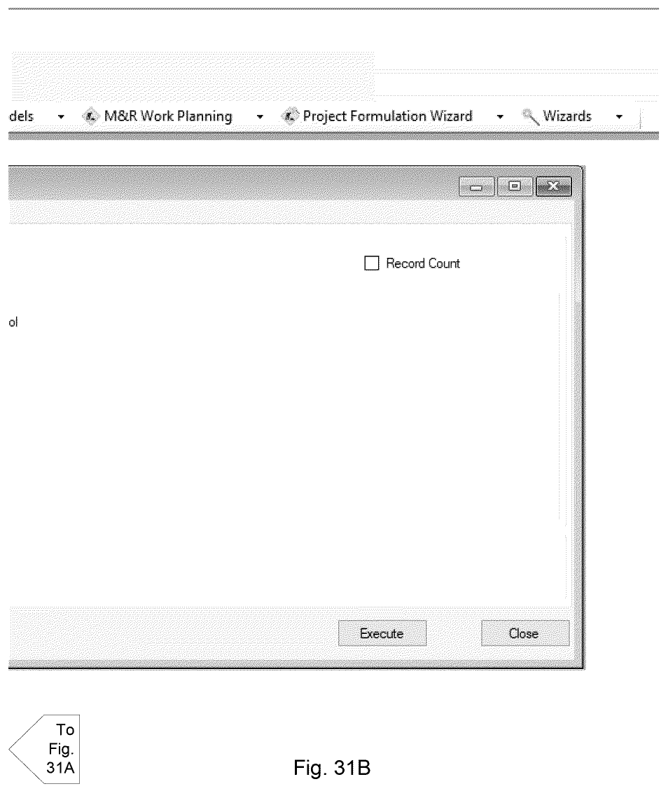

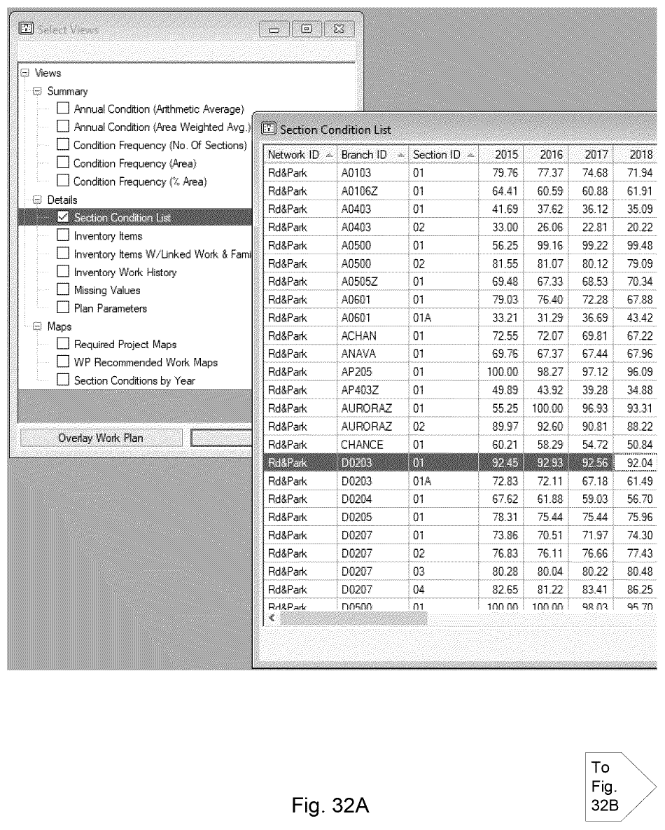

FIGS. 30A-30B shows a window for stopgap cost by condition.

FIGS. 31A-31B shows a condition performance analysis window.

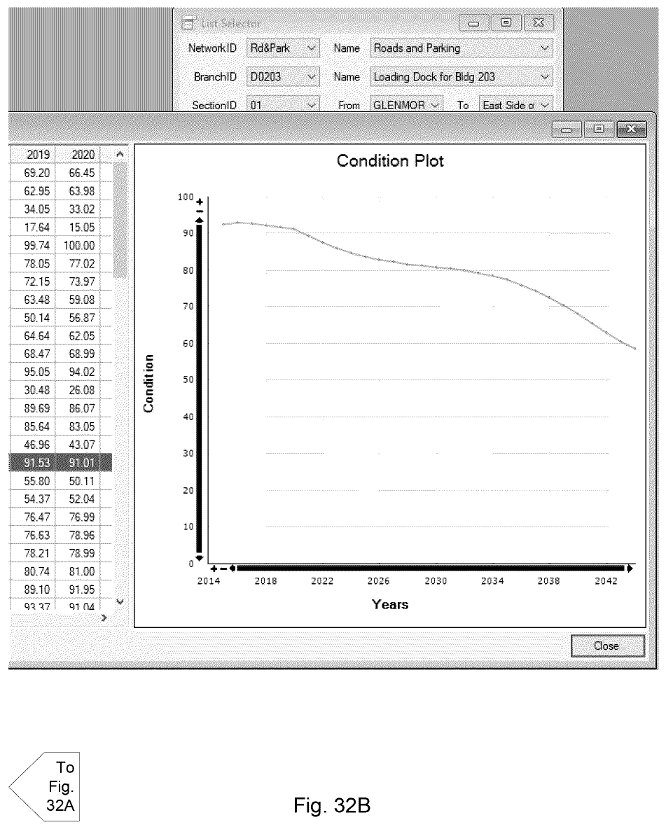

FIGS. 32A-32B shows a section condition list associated with the condition performance analysis window.

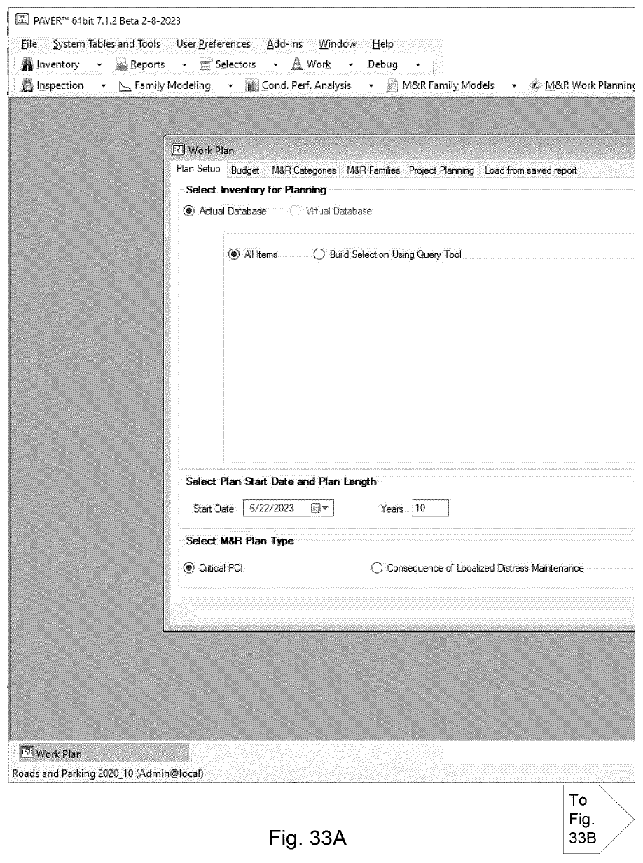

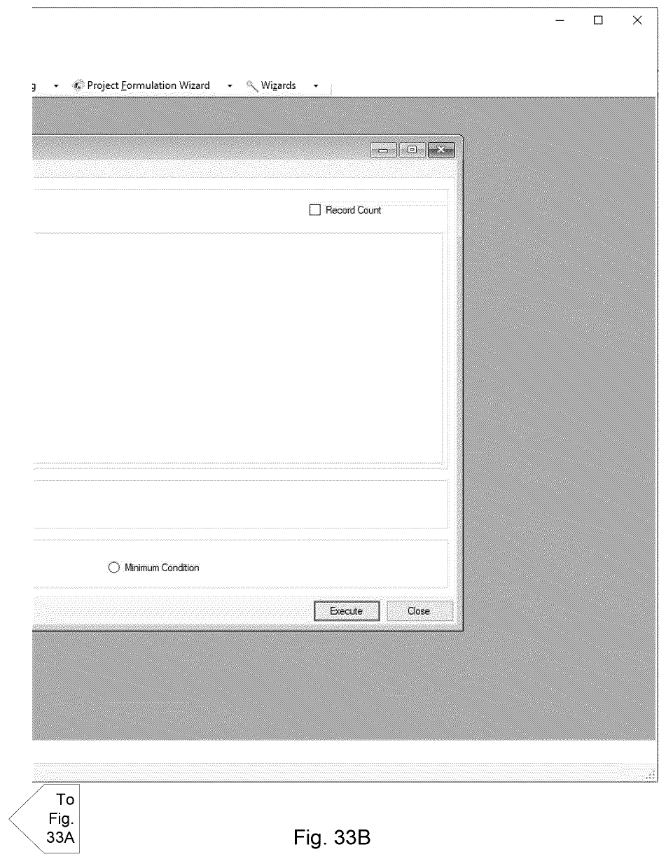

FIGS. 33A-33B shows a work plan analysis window.

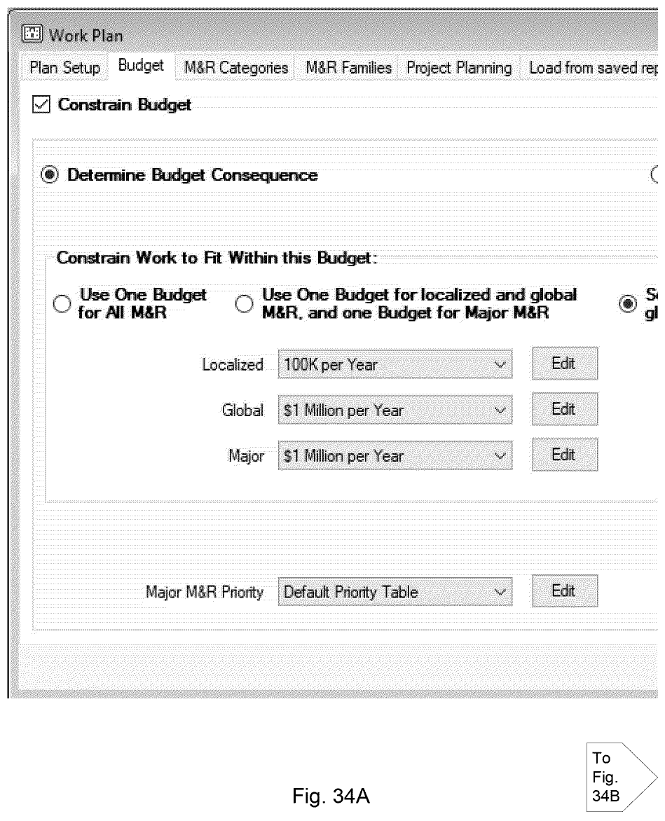

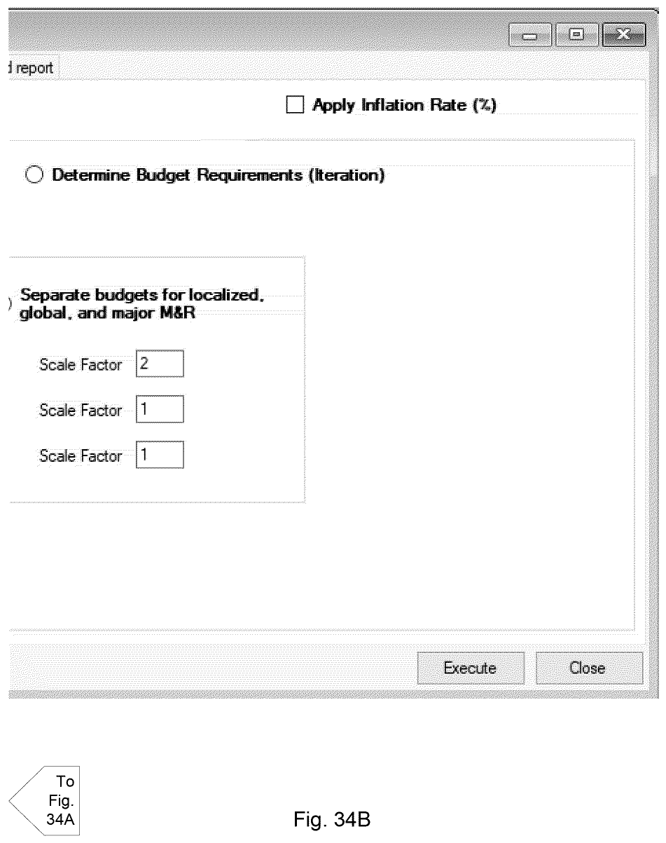

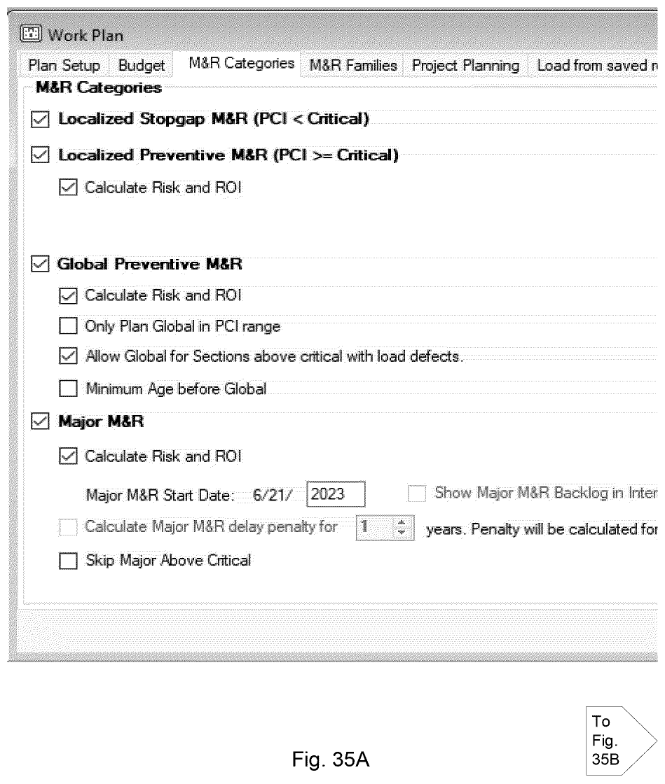

FIGS. 34A-34B shows a work plan analysis window with a budget tab selected.

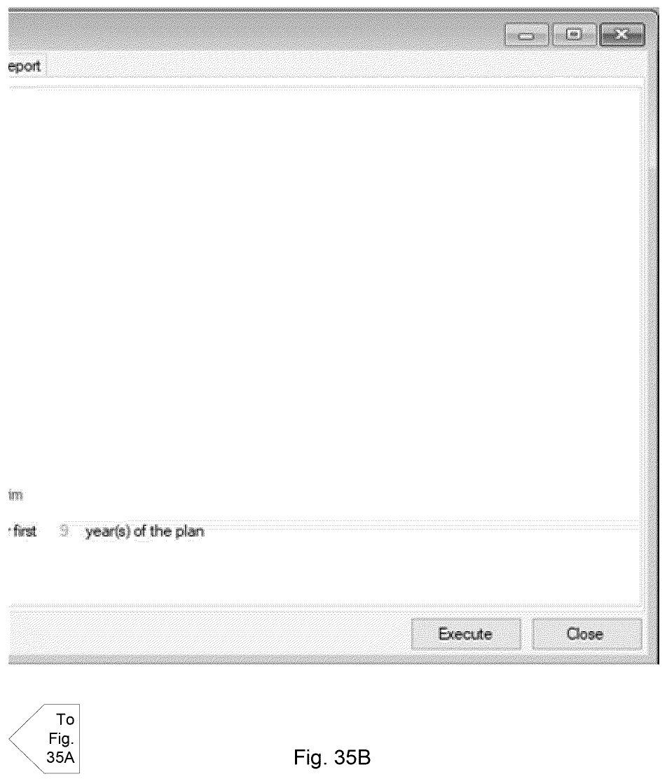

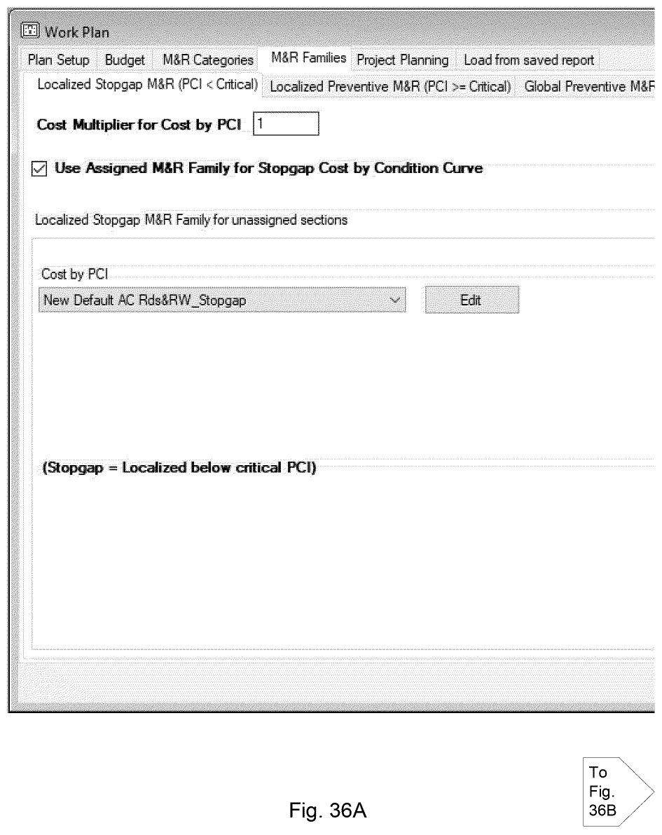

FIGS. 35A-35B show a risk calculation window.

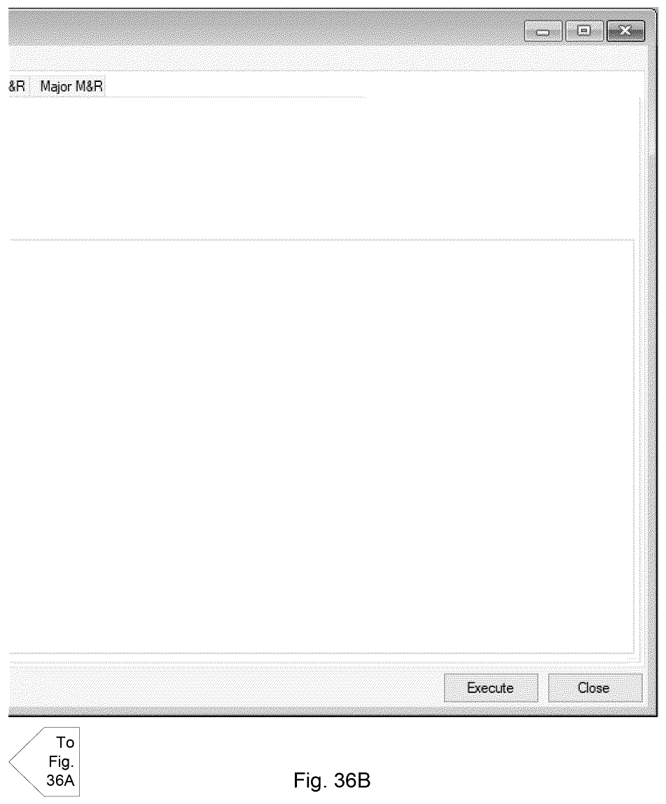

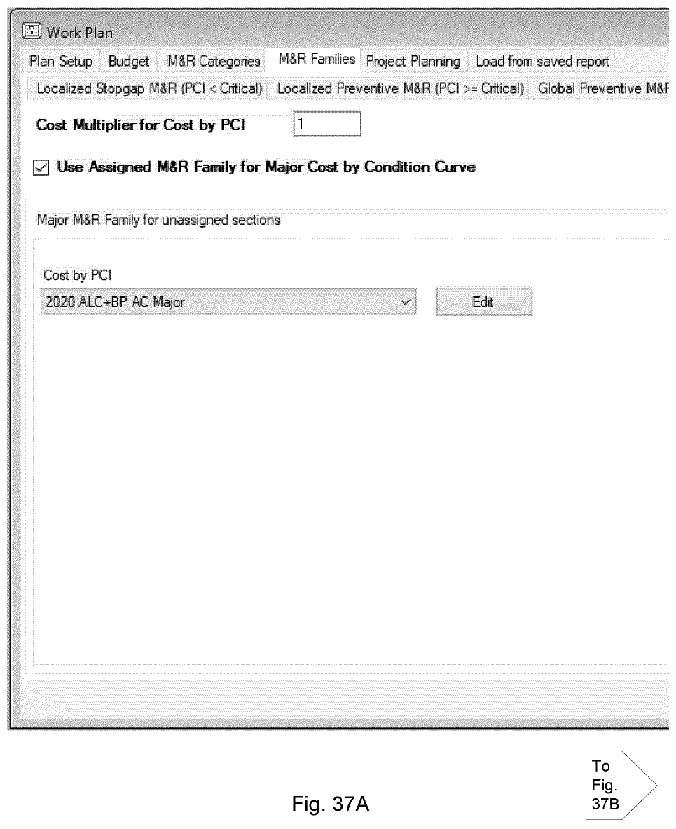

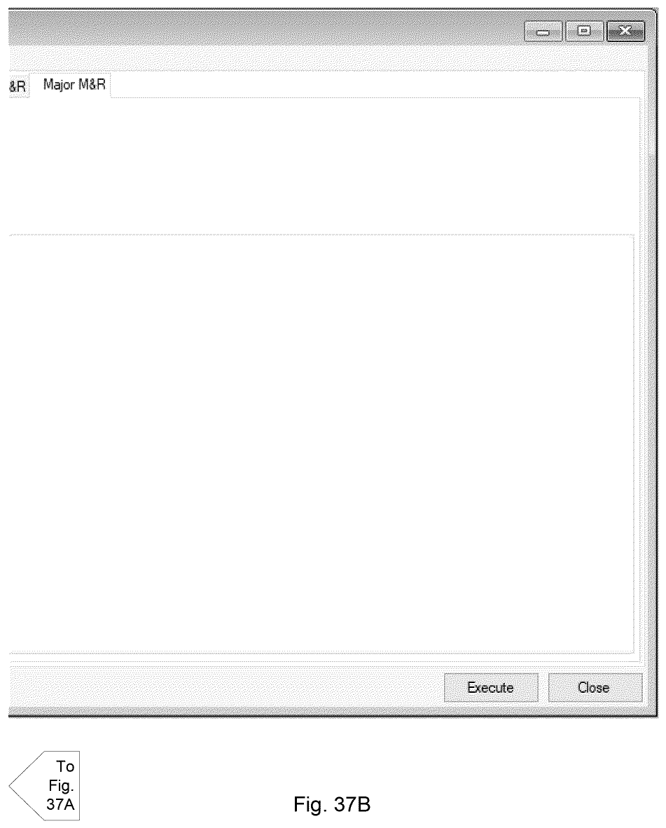

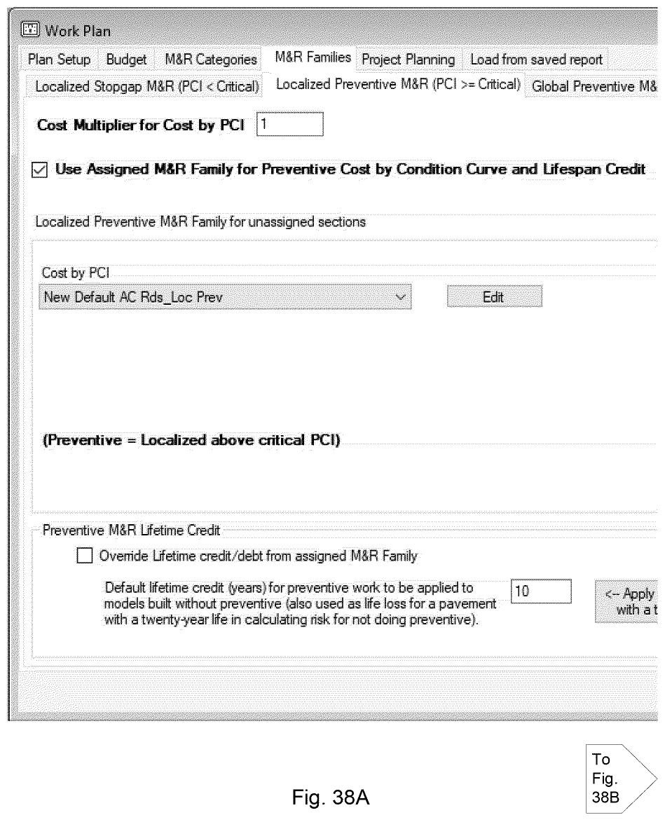

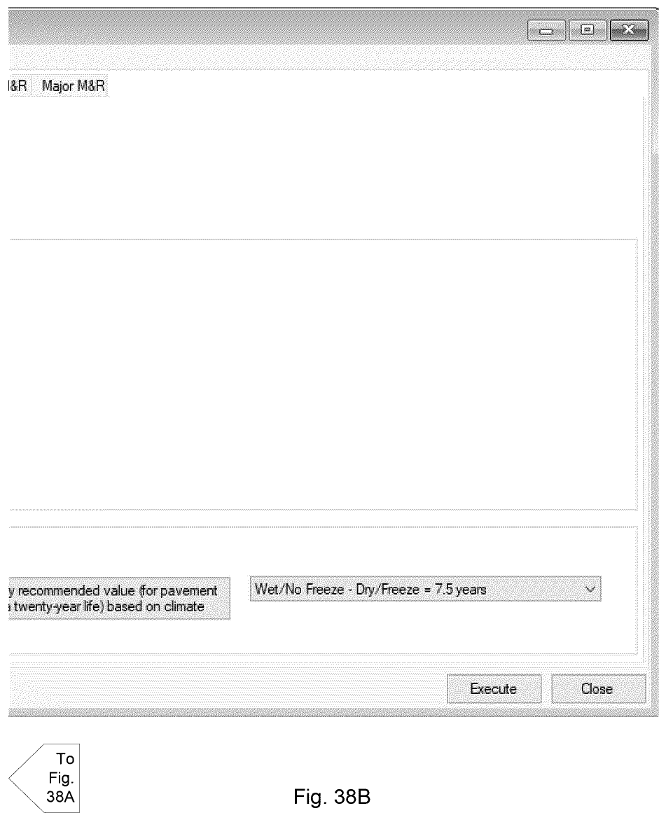

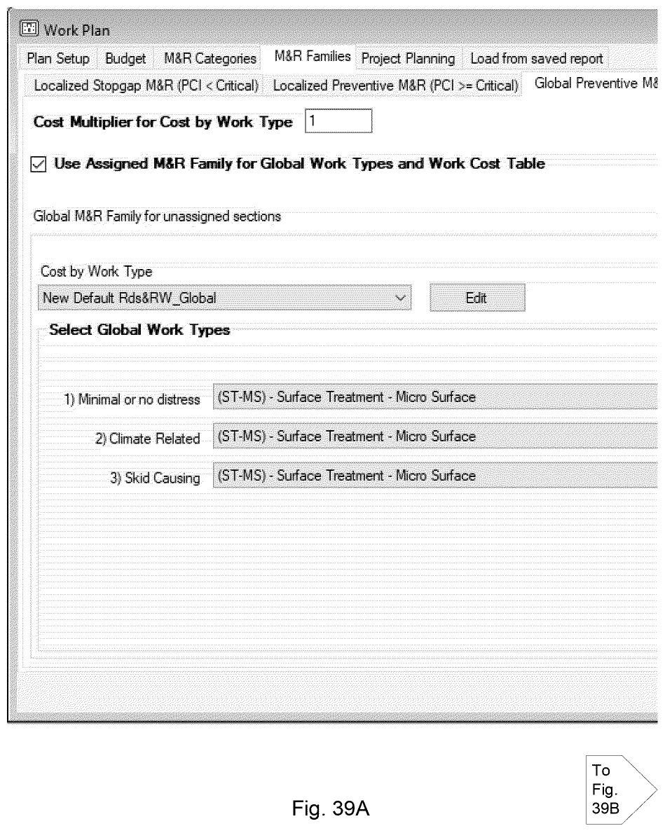

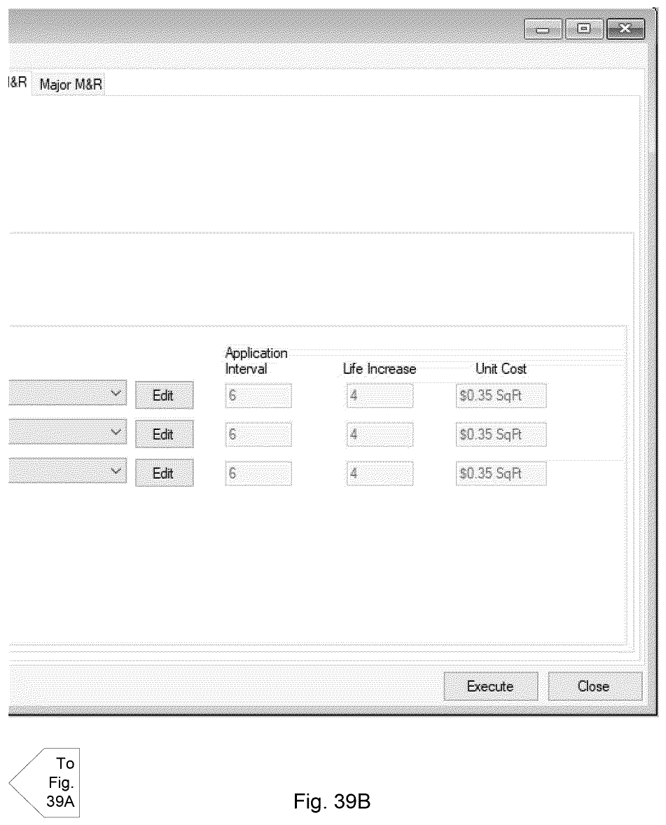

FIGS. 36A-36B, 37A-37B, and 38A-38B show risk calculation tabs.

FIGS. 39A-39B show a work plan analysis window with a global M&R family settings tab selected.

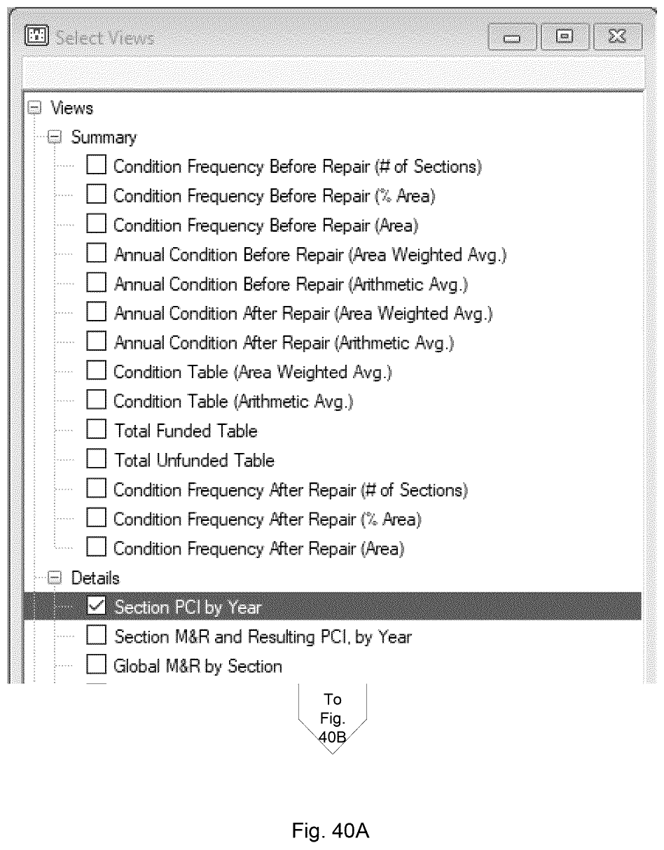

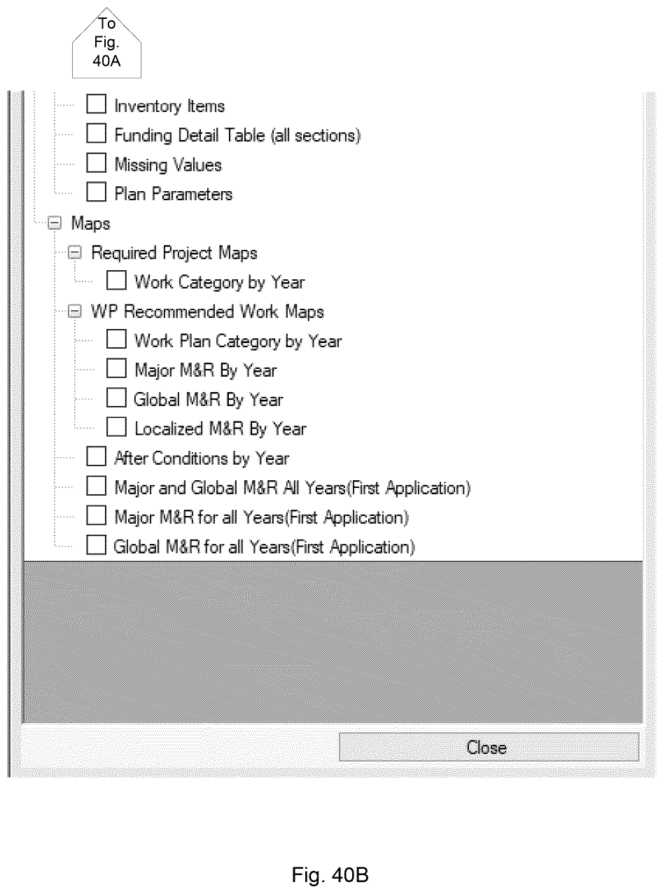

FIGS. 40A-40B show a results selection tool configured to cause PMA to display a result window such as a table, graph, map, menu, or display.

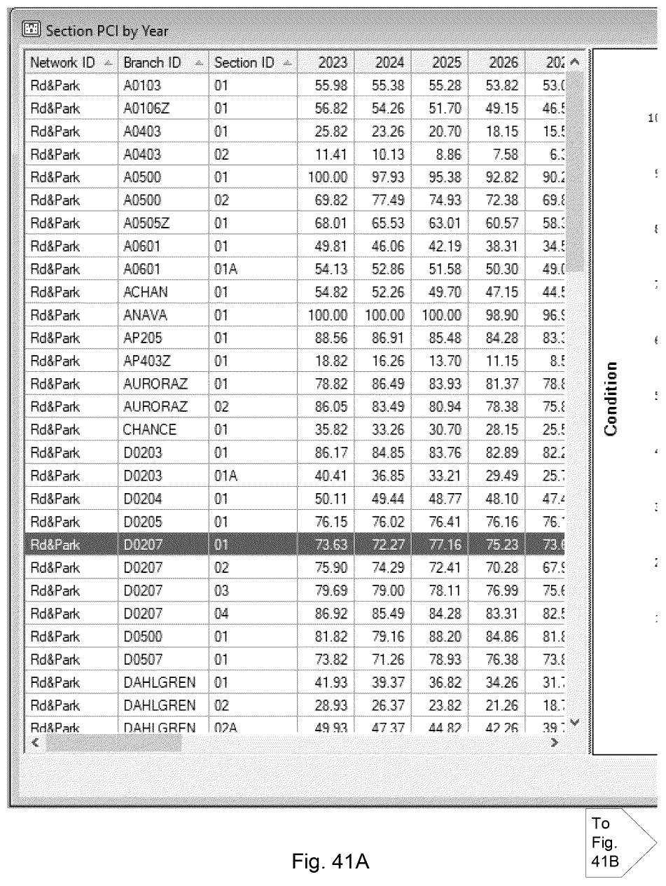

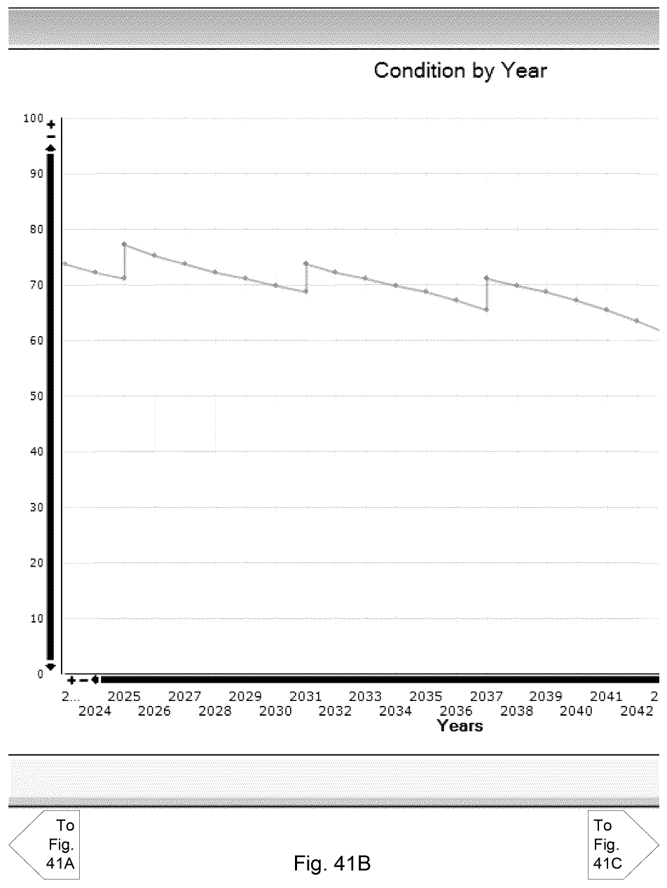

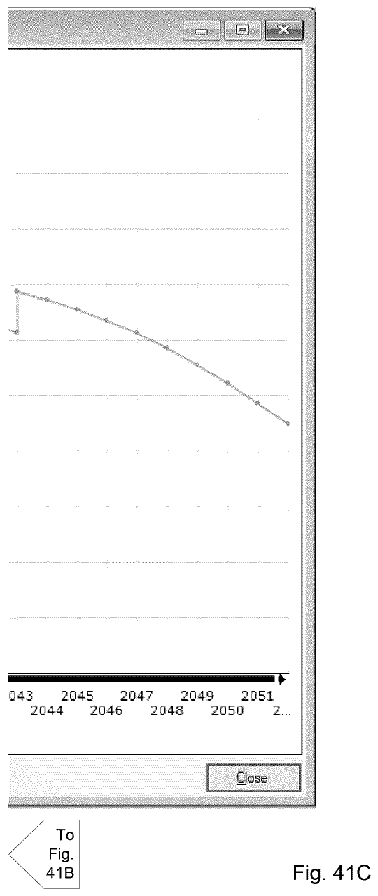

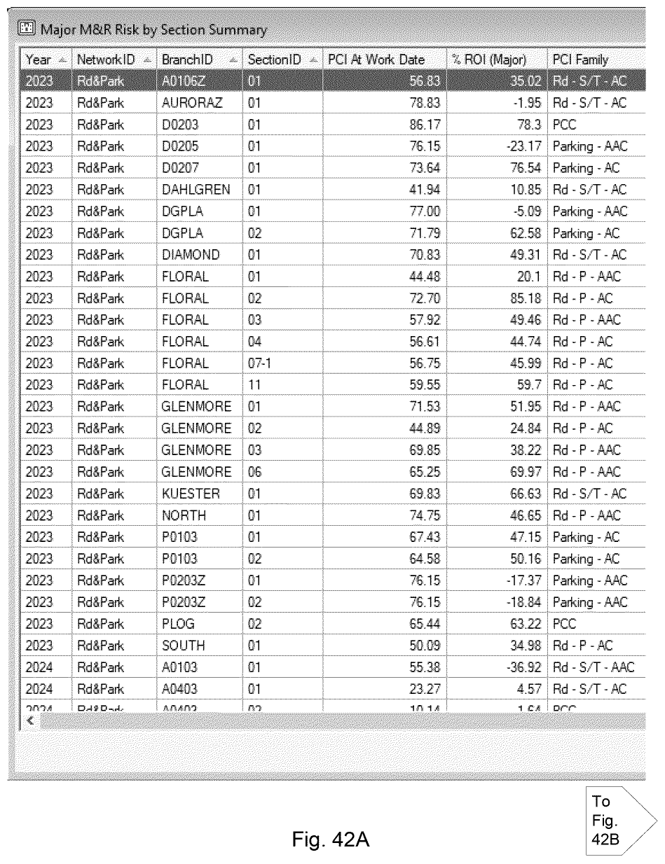

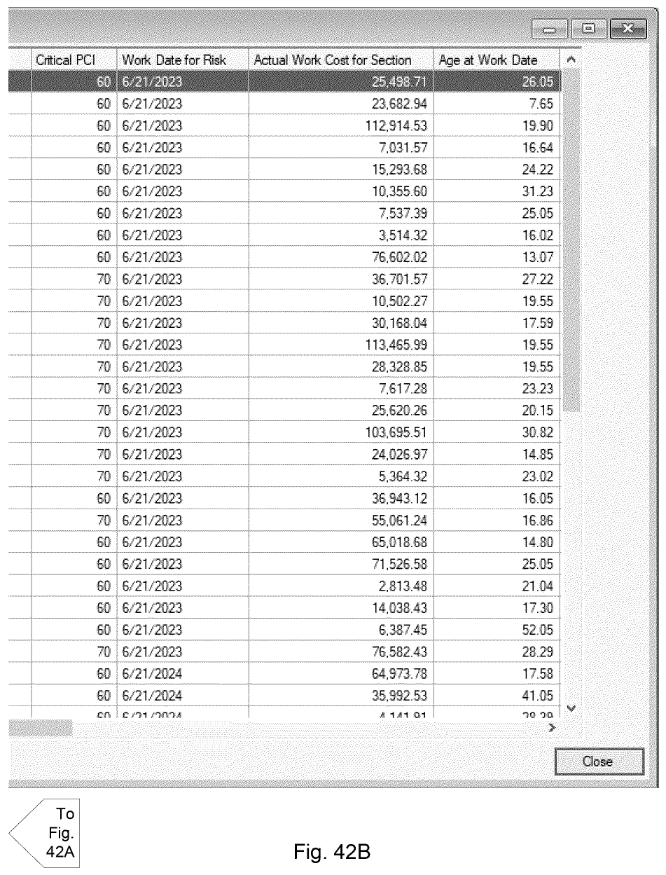

FIGS. 41A-41C show the results table Section PCI by Year table and graph.

FIGS. 42A-42B show a result window configured to display a major M&R risk by Section summary.

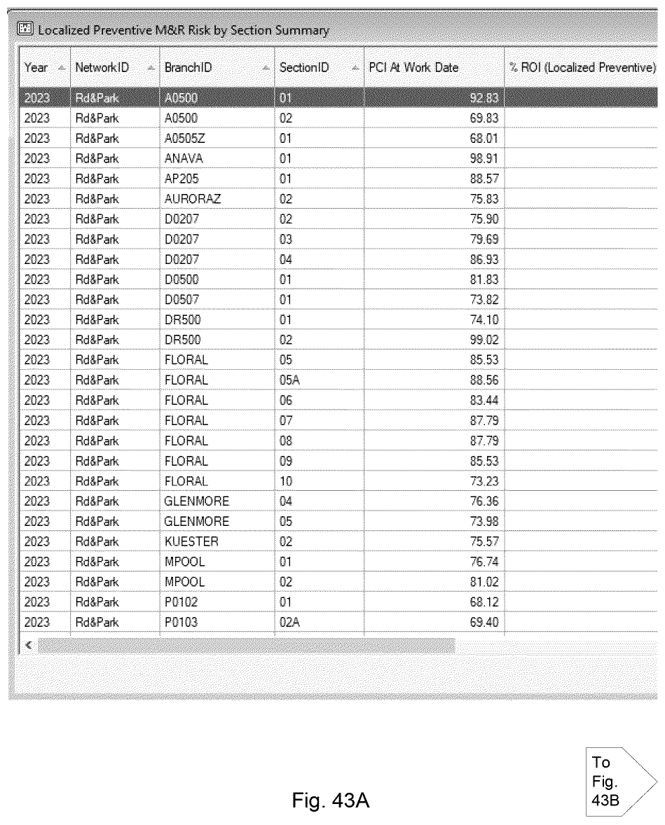

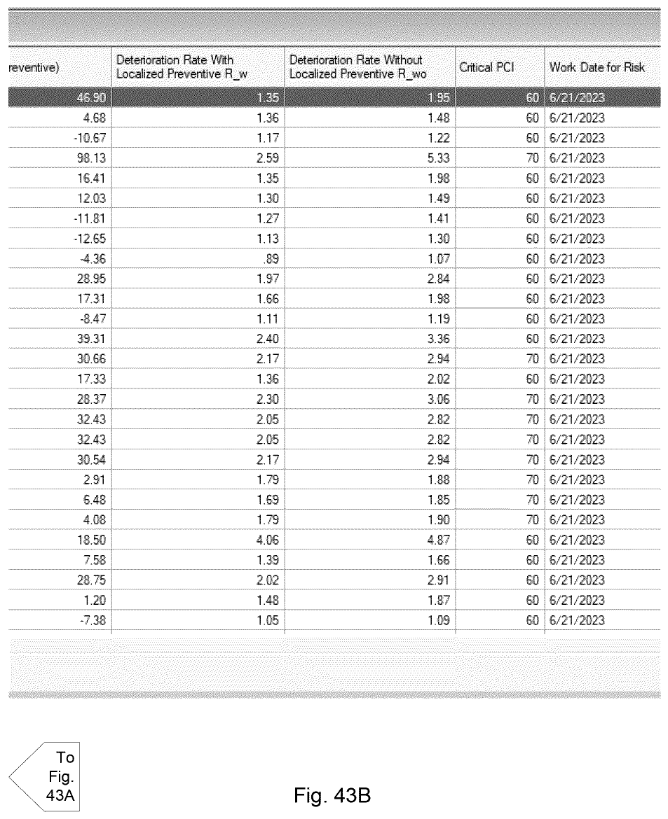

FIGS. 43A-43B show a result window configured to display a localized preventative M&R risk by section summary.

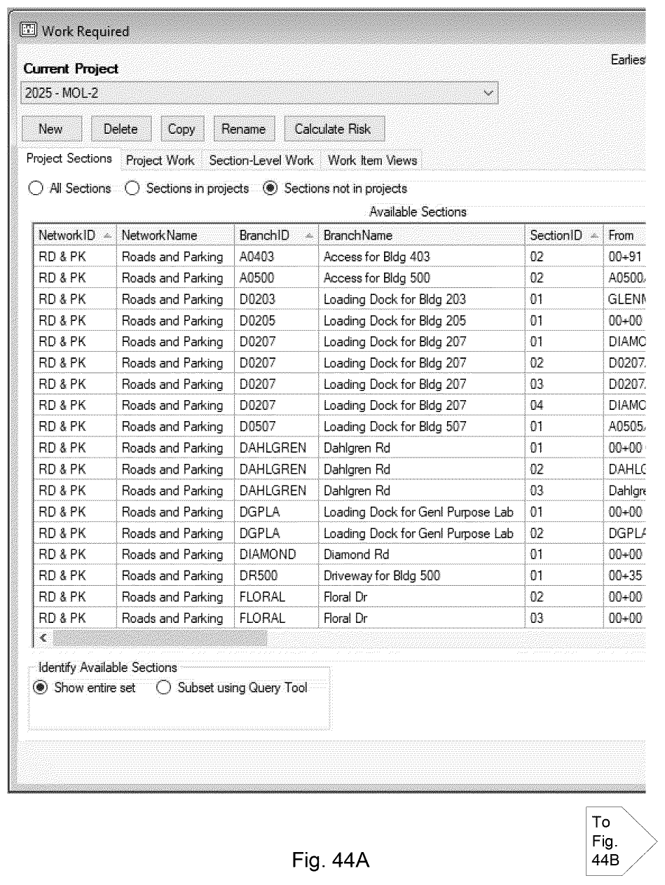

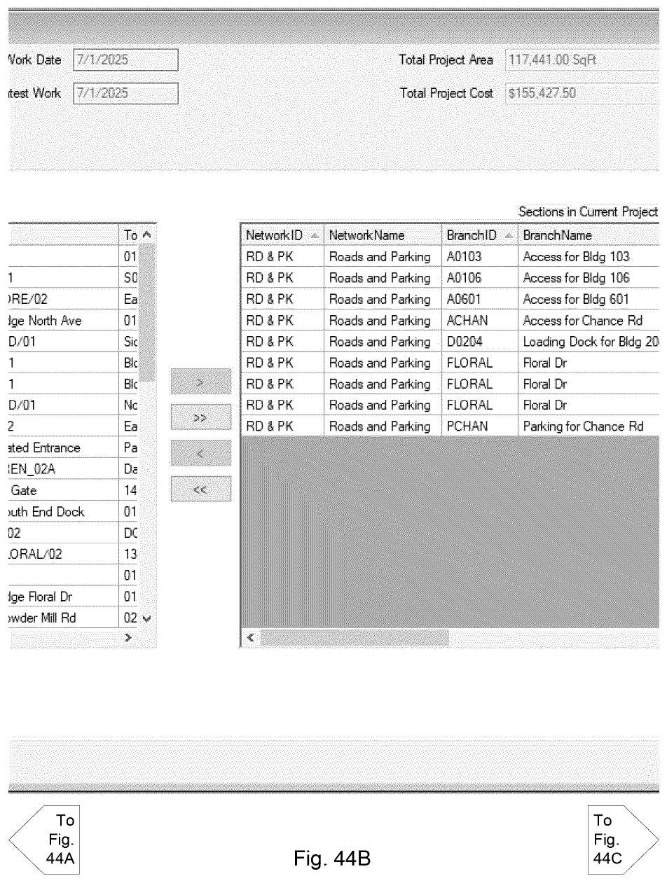

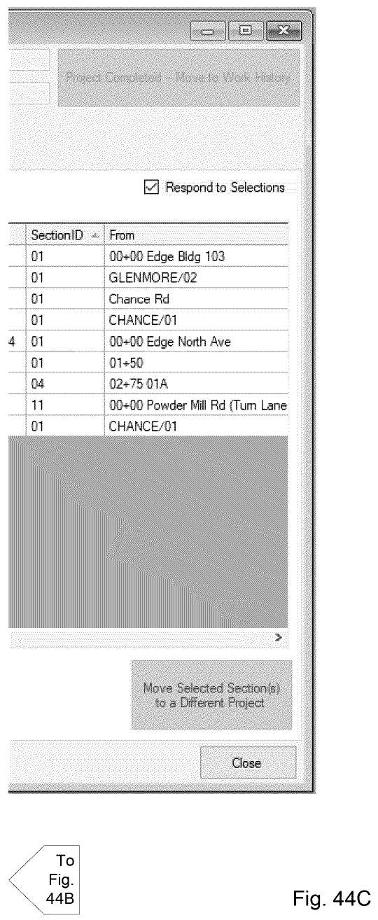

FIGS. 44A-44C show a project planning window.

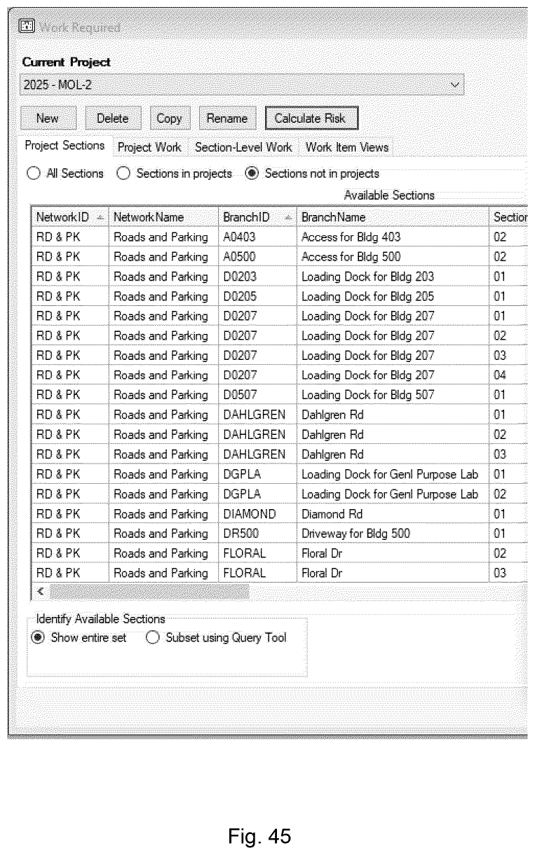

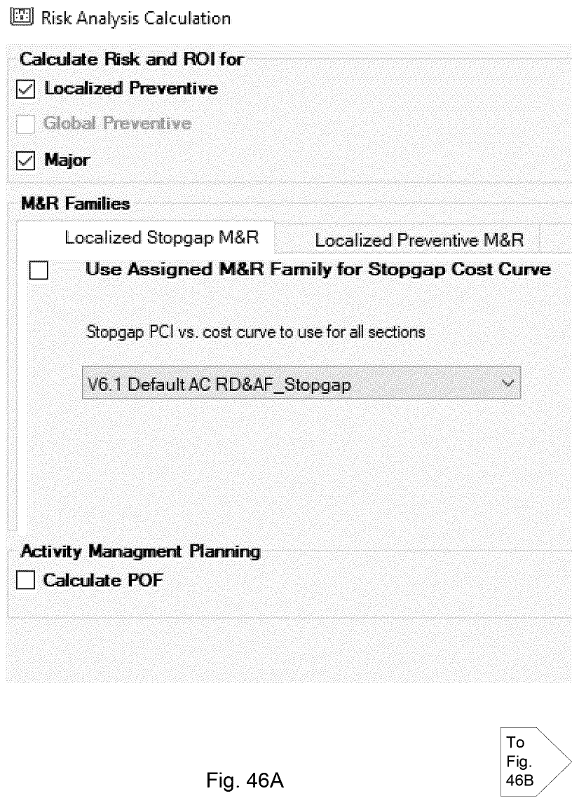

FIG. 45 shows a work required window.

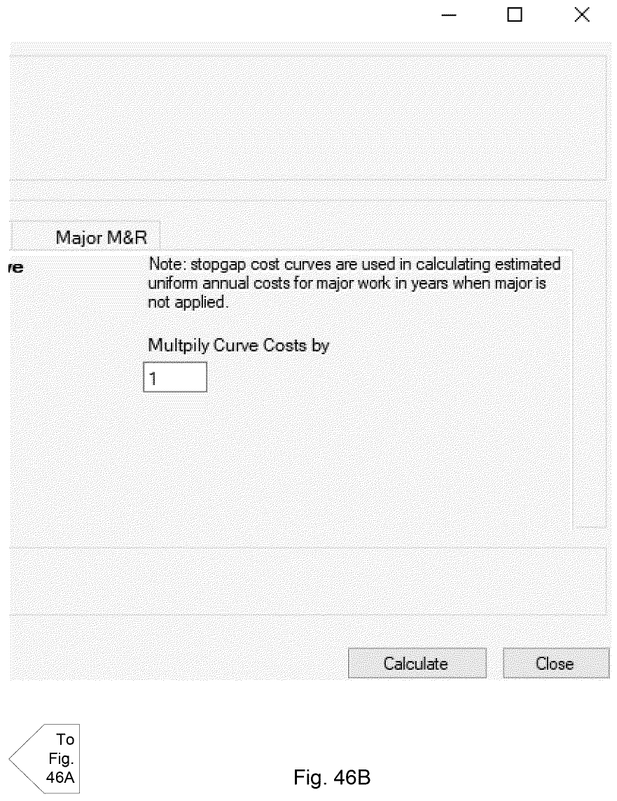

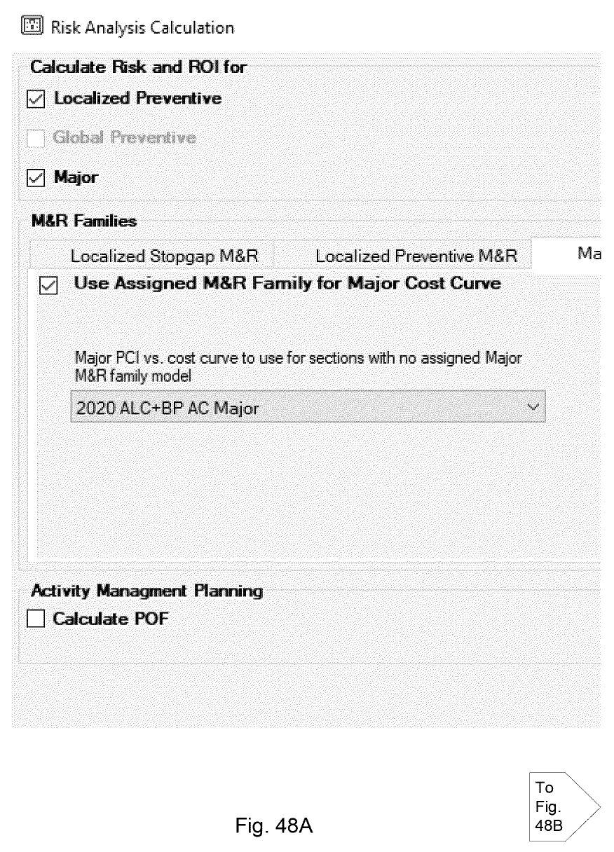

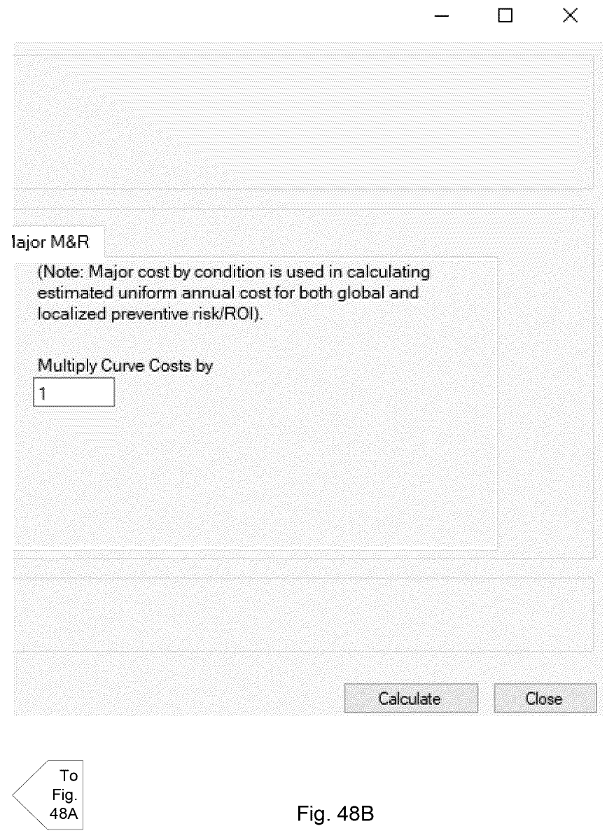

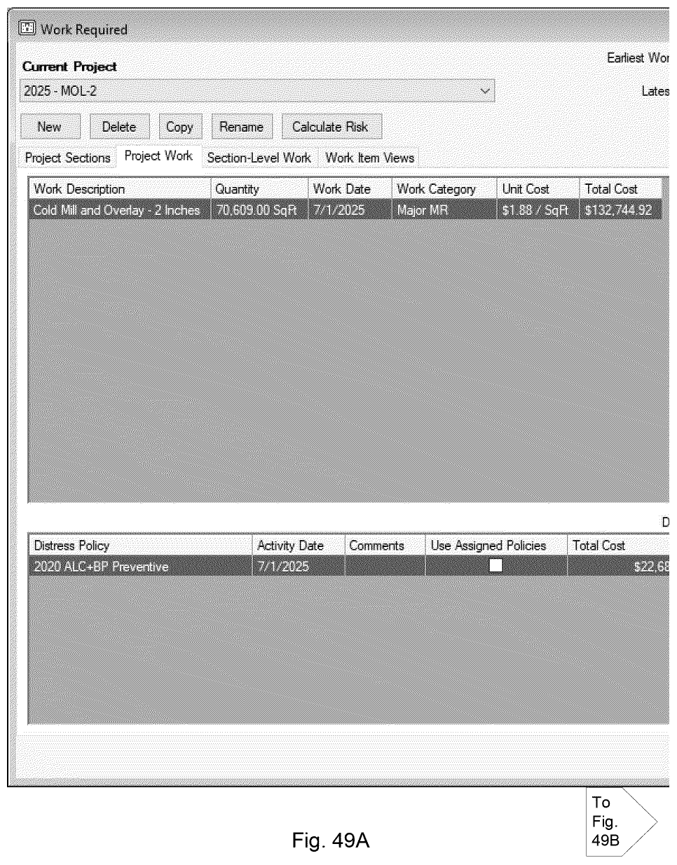

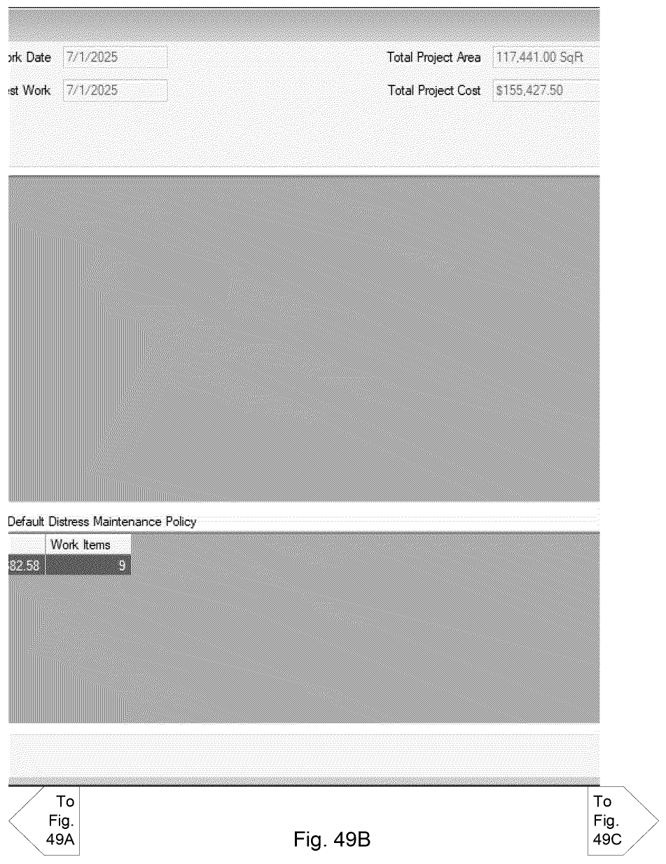

FIGS. 46A-46B, FIGS. 47A and 47B, and FIGS. 48A and 48B show additional risk calculation windows.

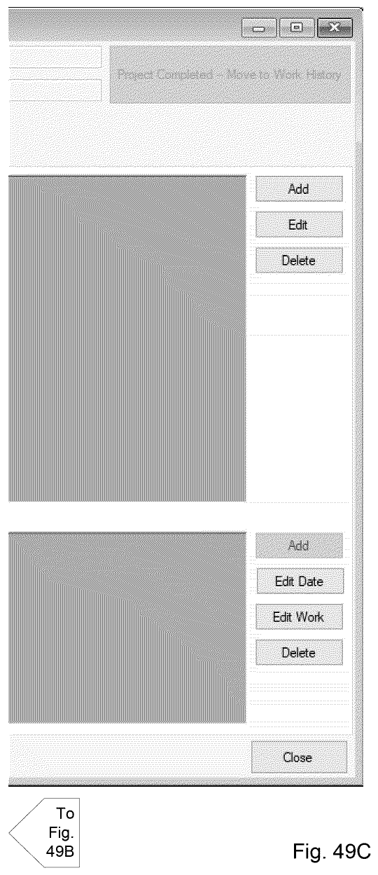

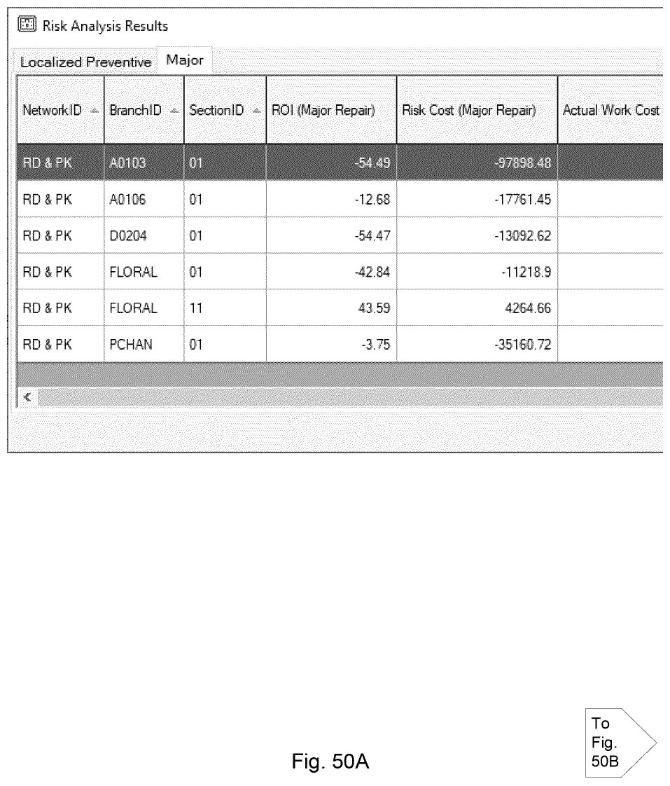

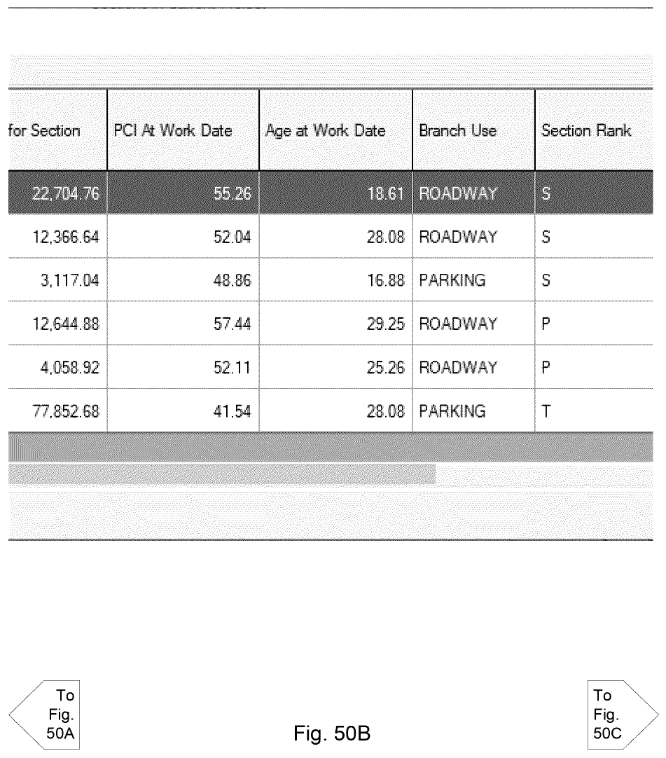

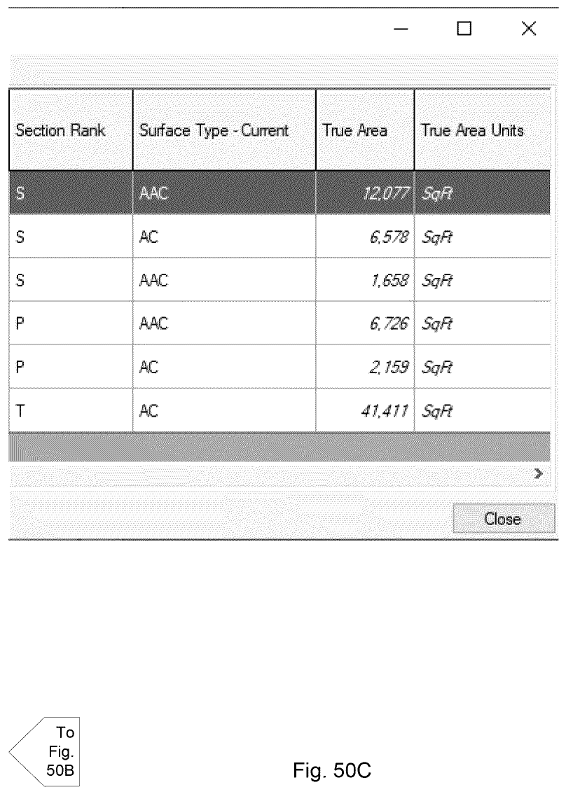

FIGS. 49A-49C and FIGS. 50A-50C show a risk analysis for project work window.

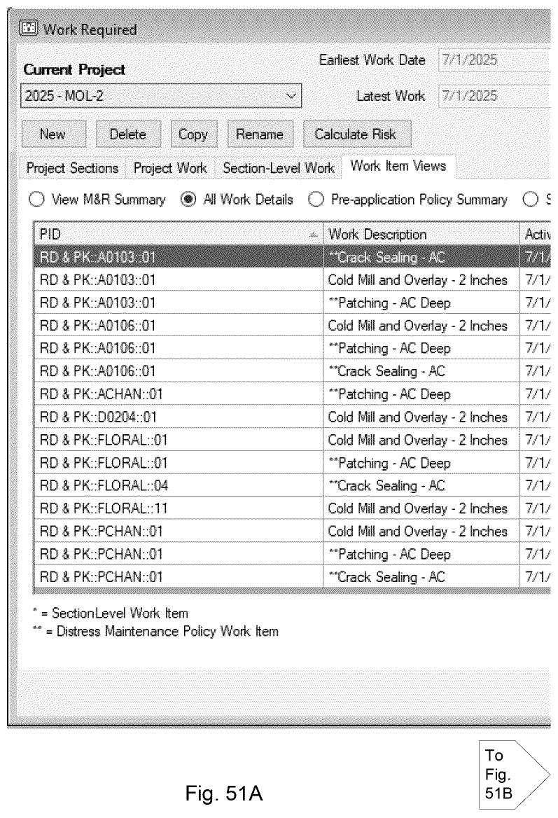

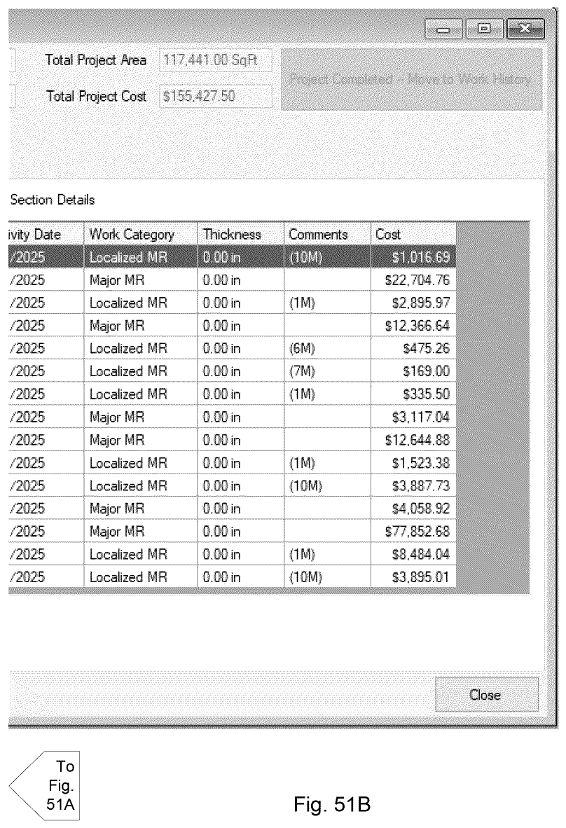

FIGS. 51A to 51B show a project work detail window.

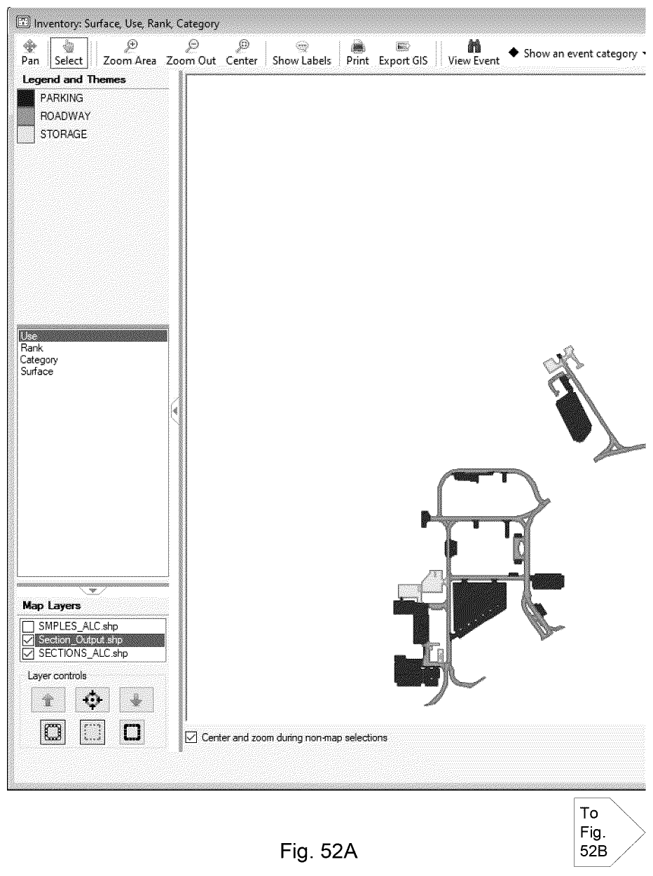

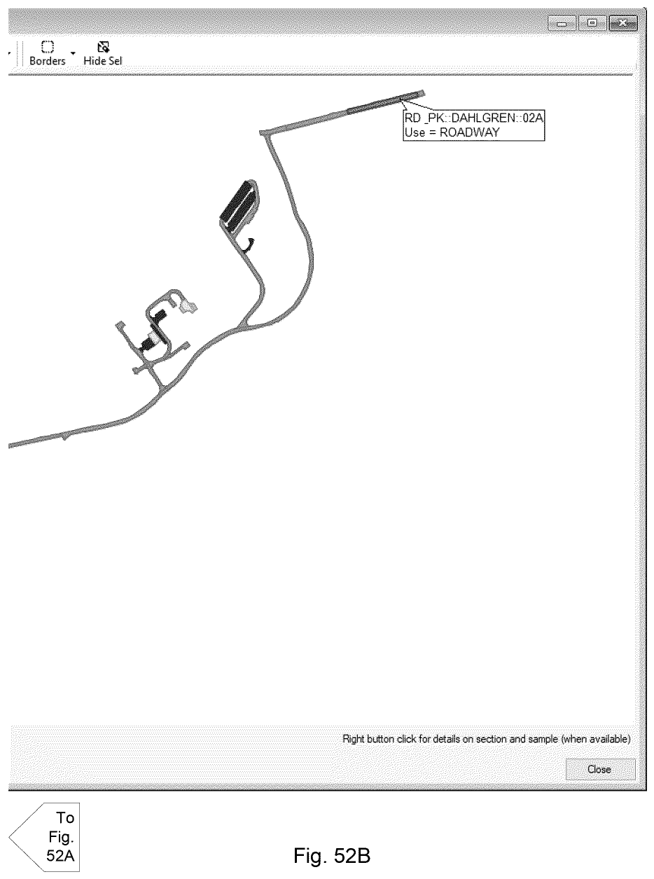

FIGS. 52A-52B show an inventory: surface, use, rank category window.

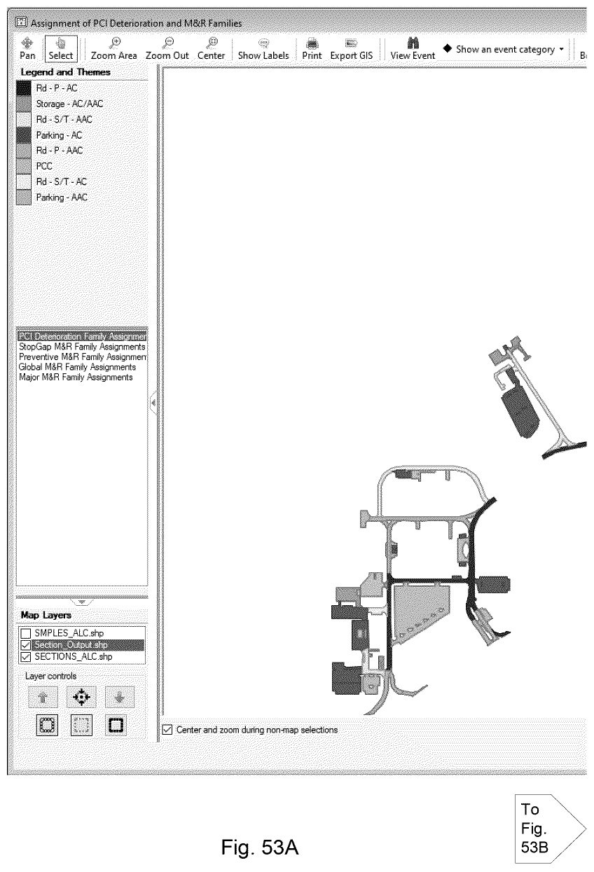

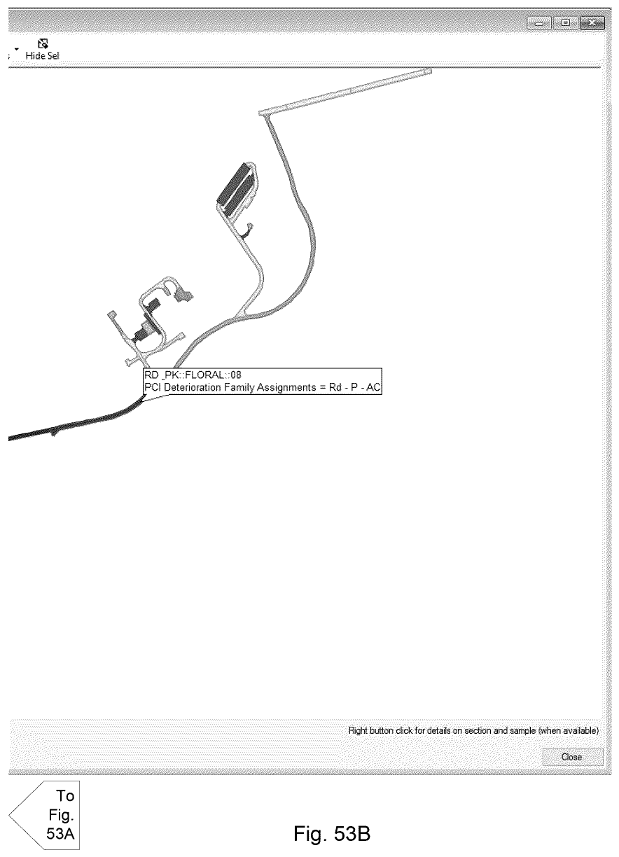

FIGS. 53A-53B show an assignment of PCI deterioration and M&R families window.

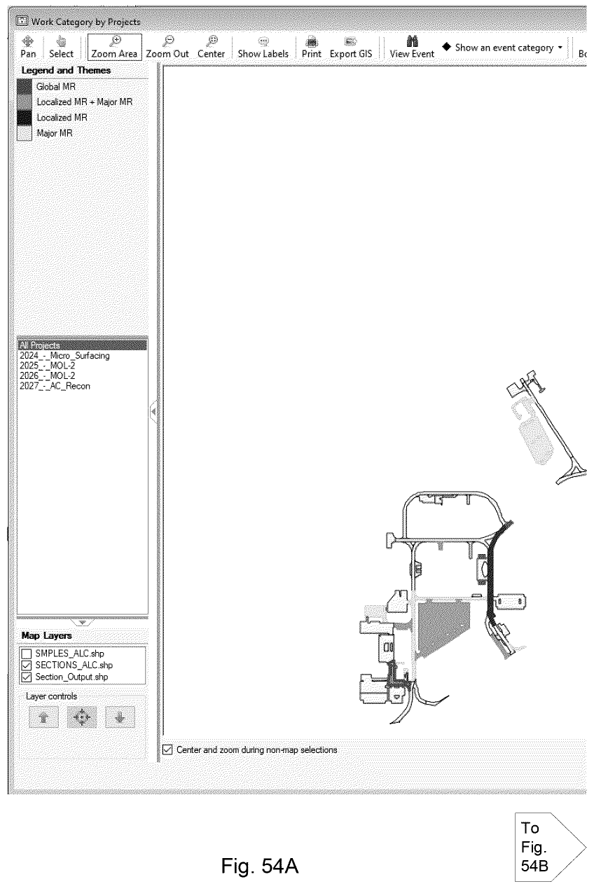

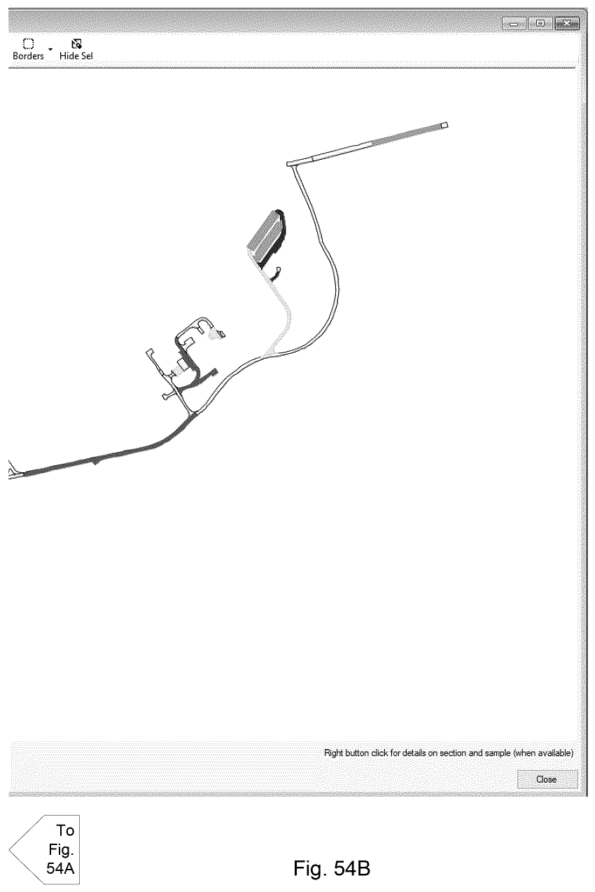

FIGS. 54A-54B show a work category by projects window.

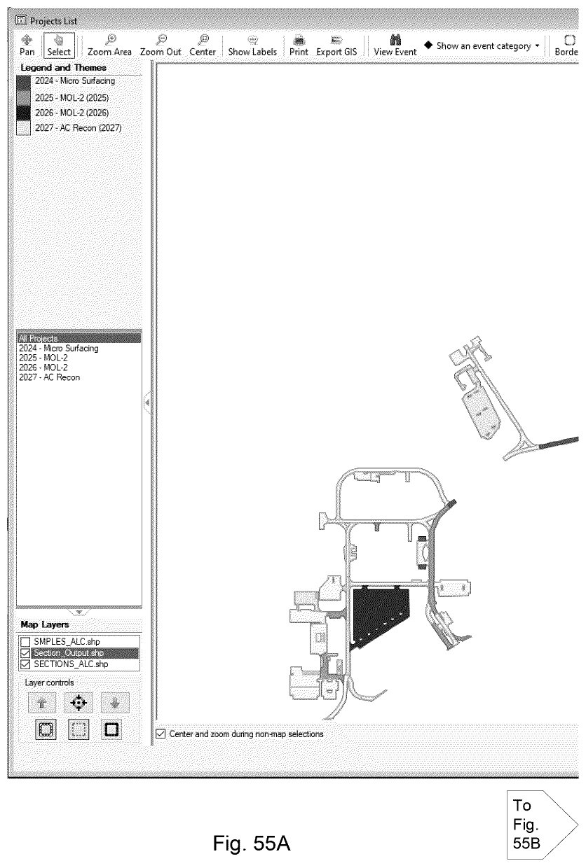

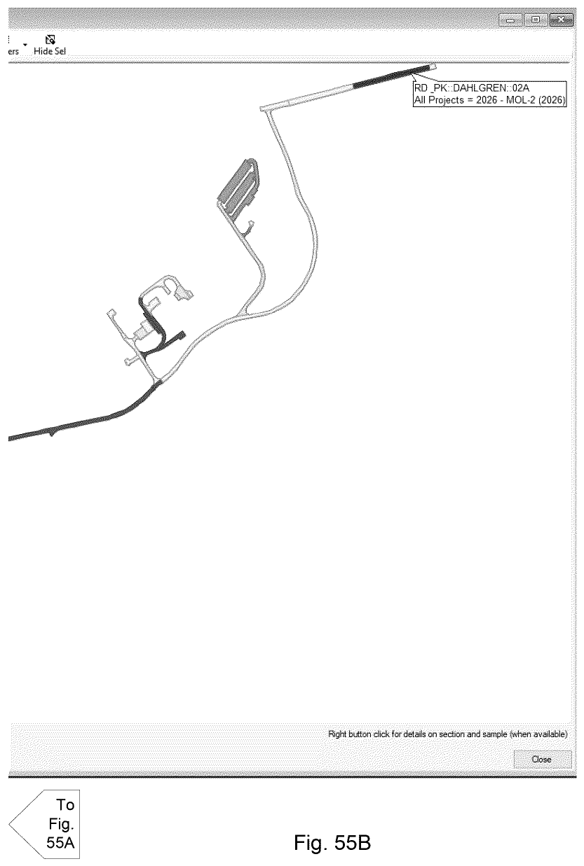

FIGS. 55A-55B show a projects list window.

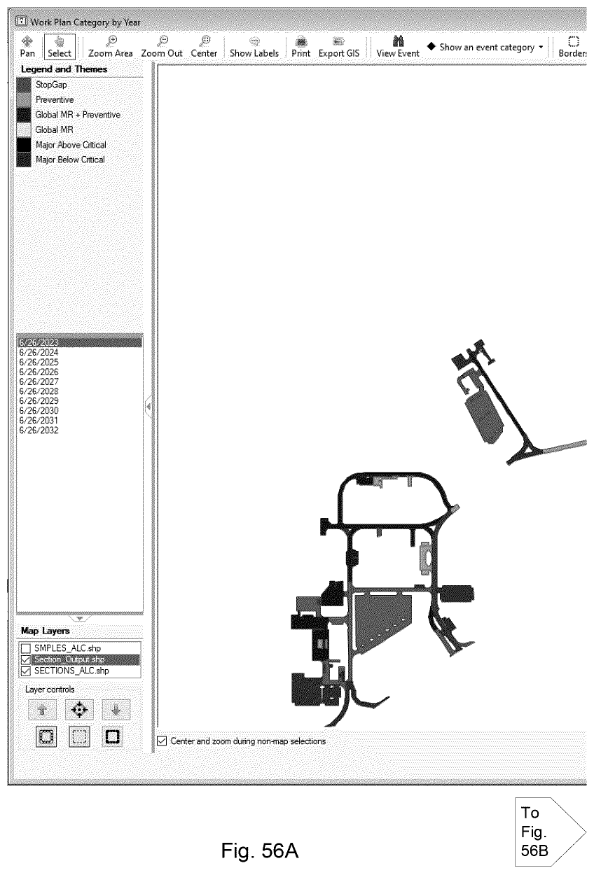

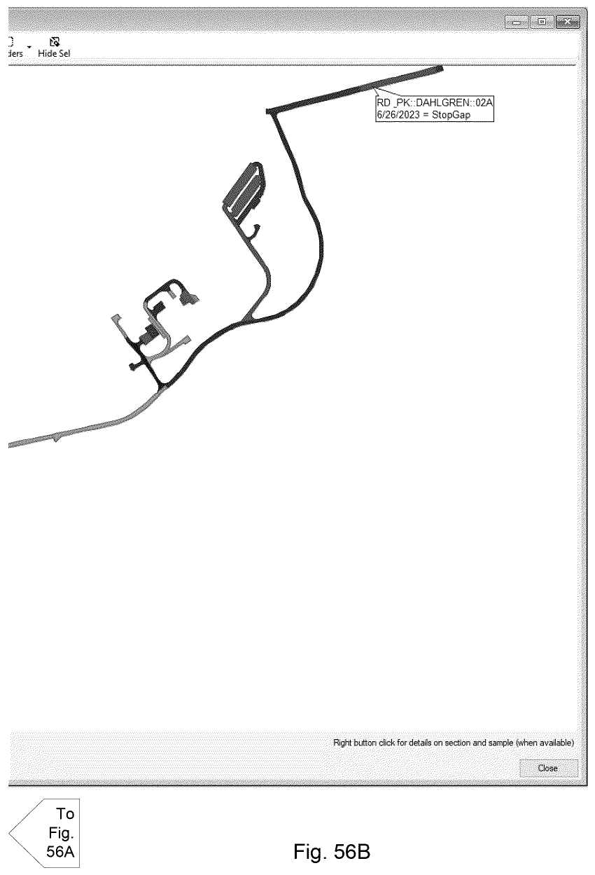

FIGS. 56A-56B show a work plan category by year window.

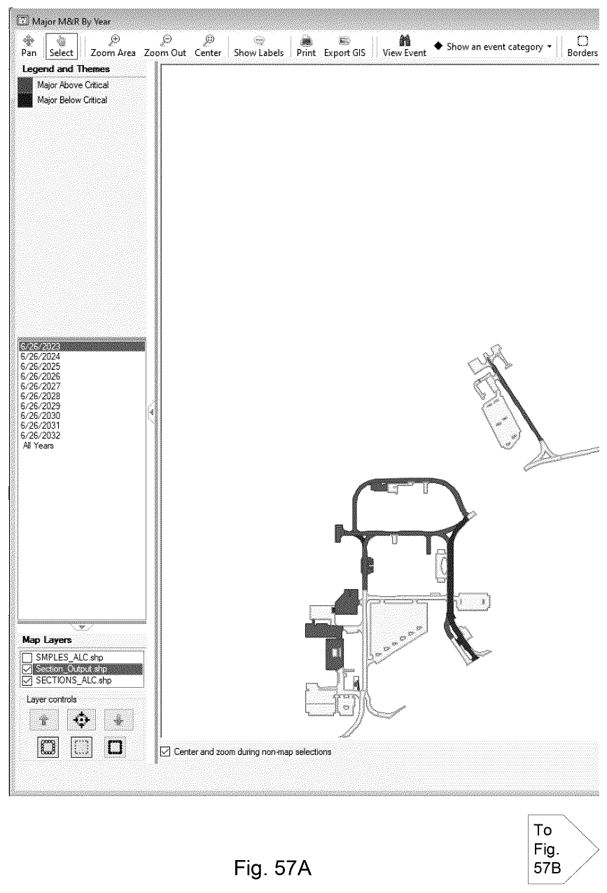

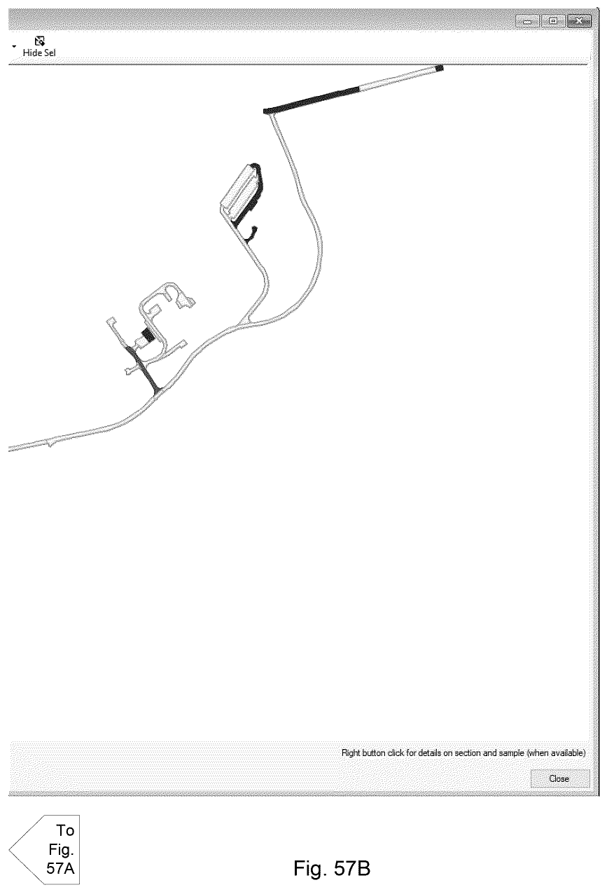

FIGS. 57A-57B show a workplan recommended for Major M&R by year window.

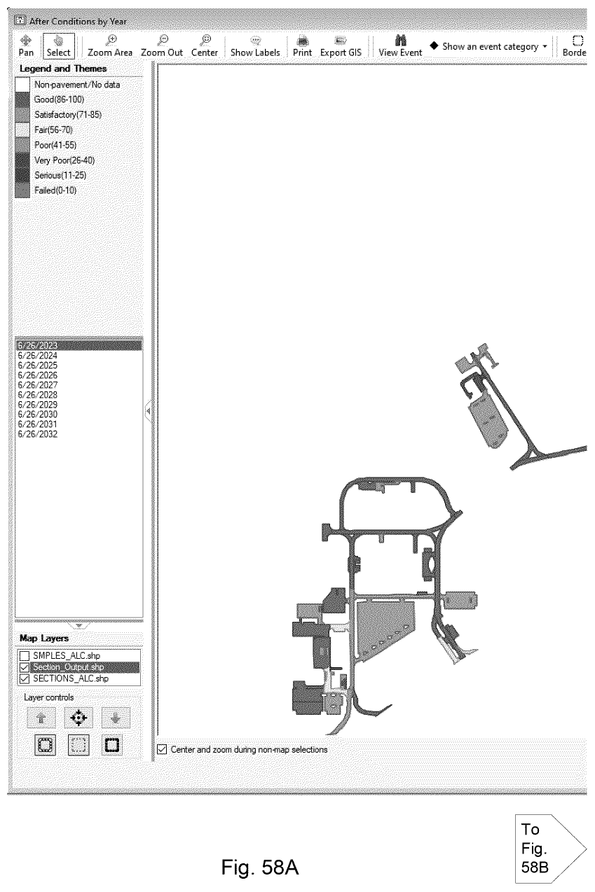

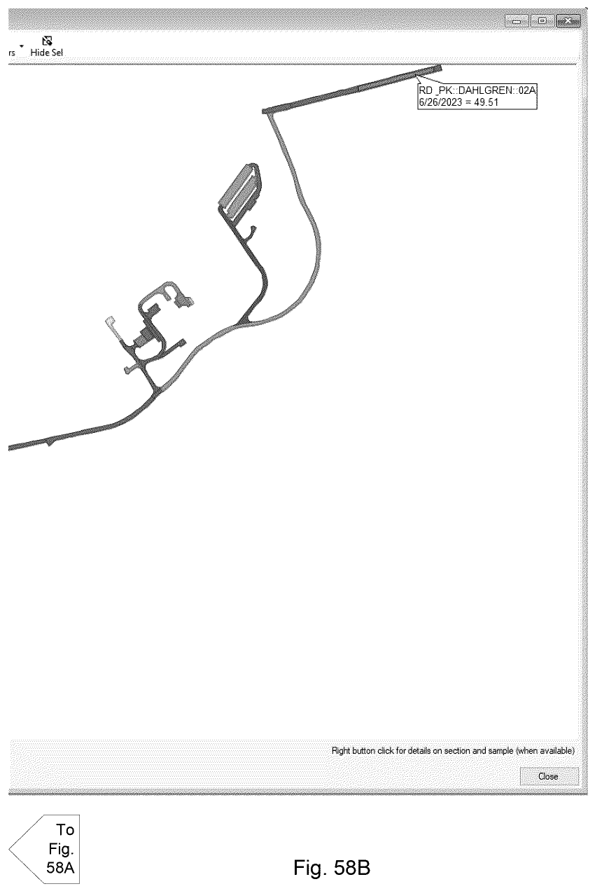

FIGS. 58A-58B shows a first year of an annual section PCI when recommended workplan is performed window.

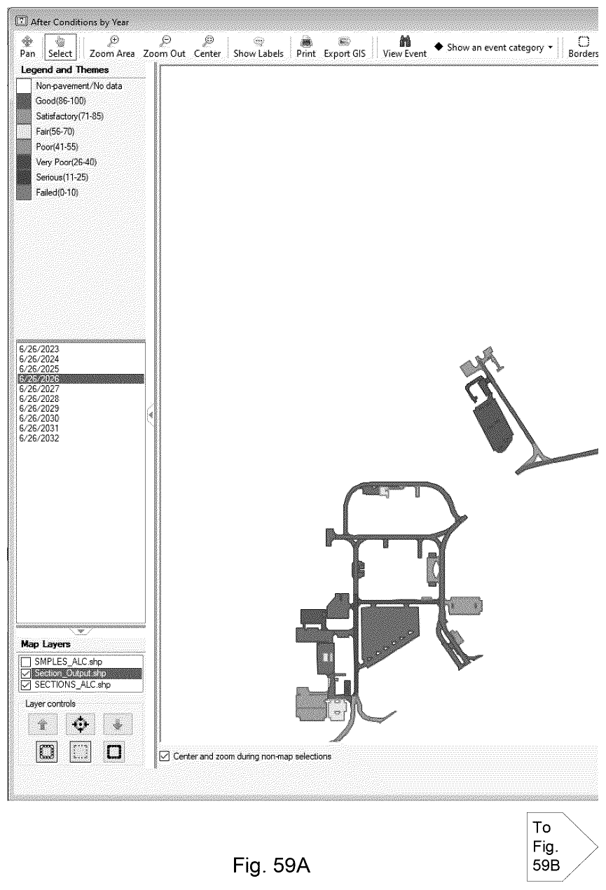

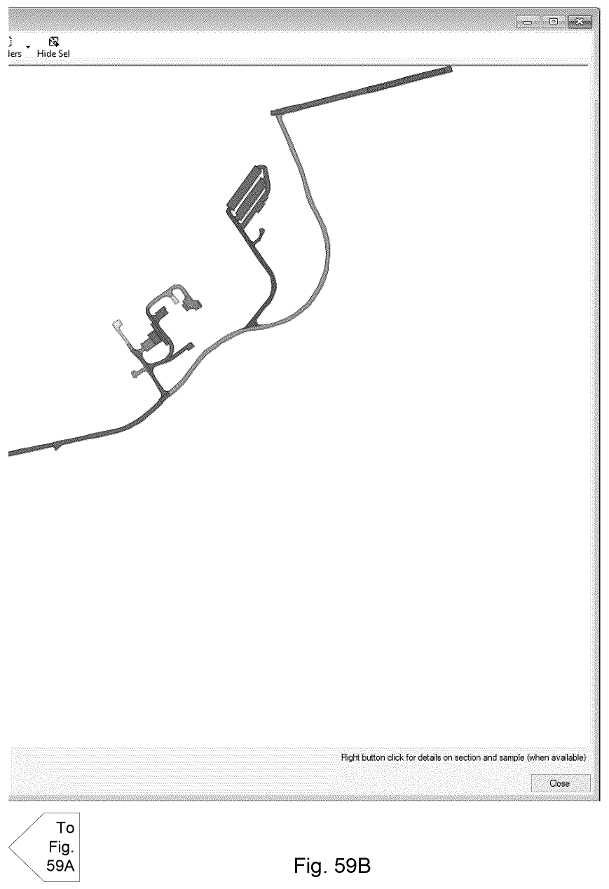

FIGS. 59A-59B show a second year of an annual section PCI when recommended workplan is performed window.

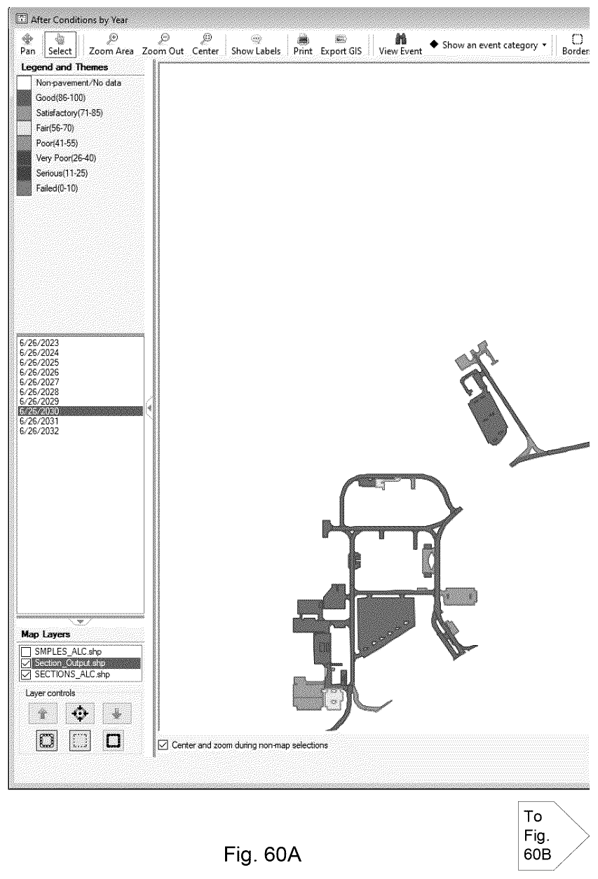

FIGS. 60A-60B show a third year of an annual section PCI when recommended workplan is performed window.

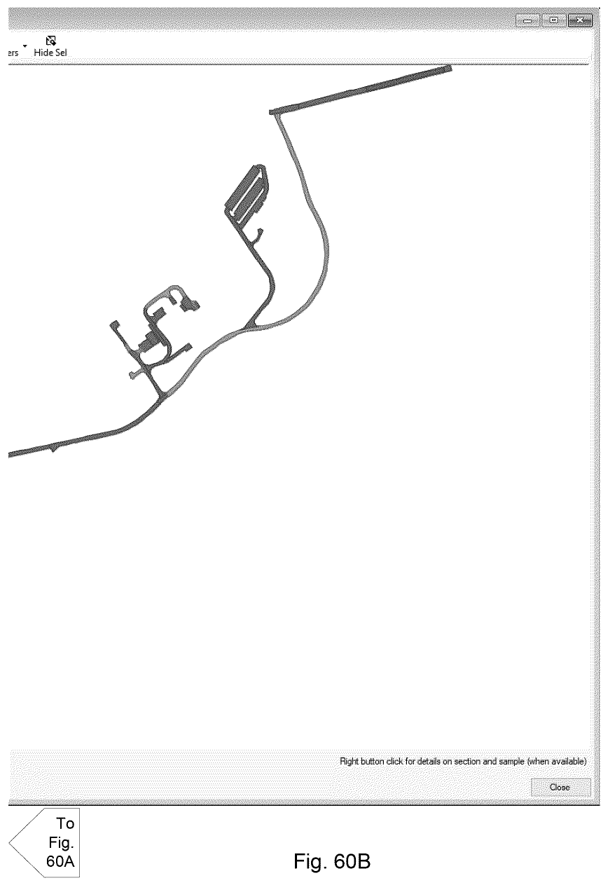

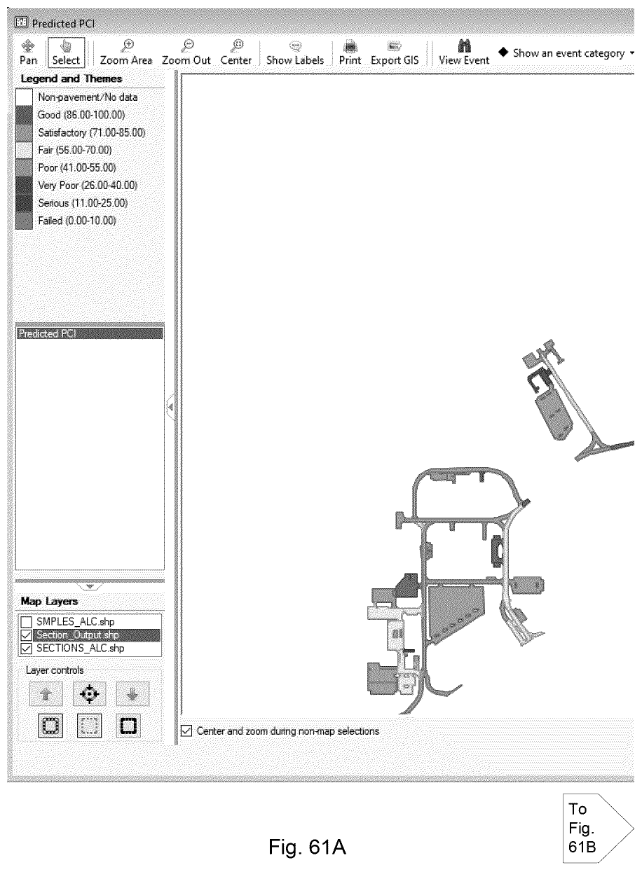

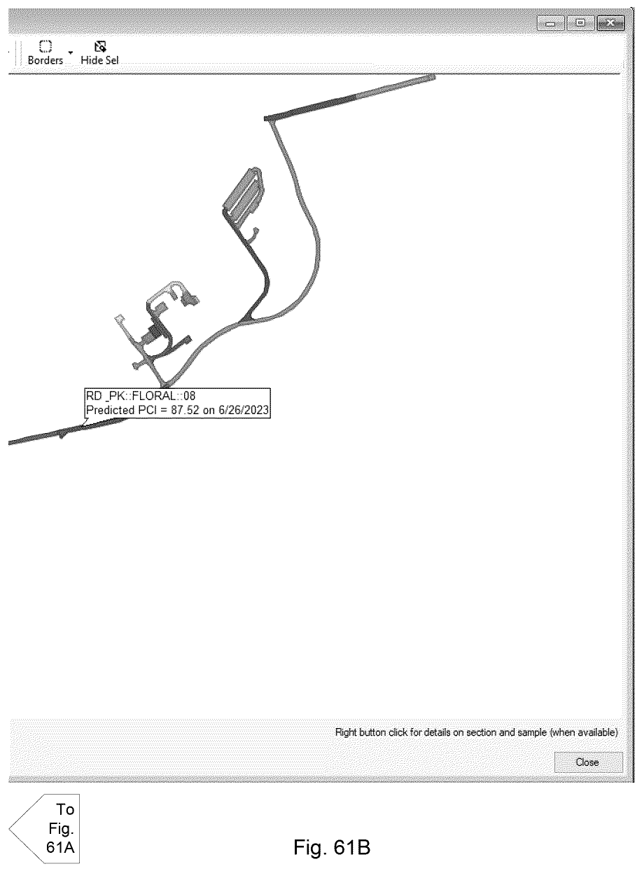

FIGS. 61A-61B show a predicted PCI when no work is performed window.

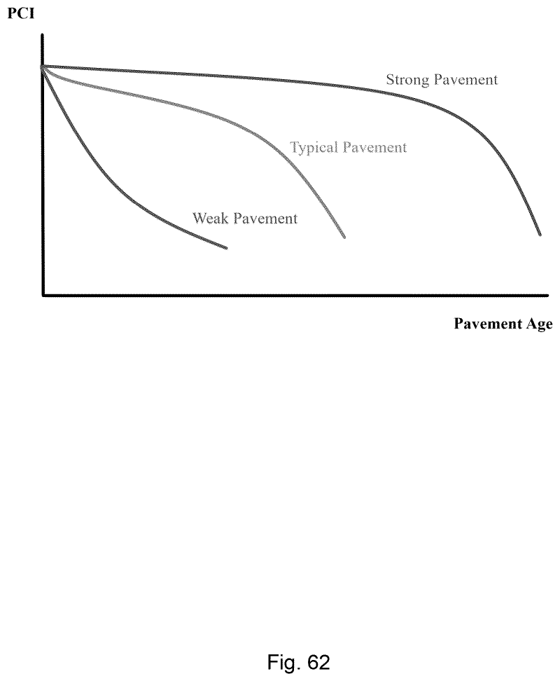

FIG. 62 shows a range of pavement performance.

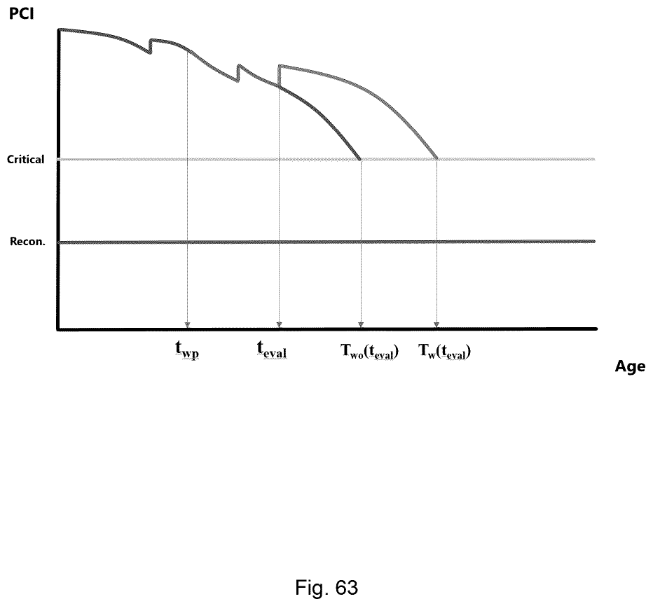

FIG. 63 shows a graph of pavement performance.

### DETAILED DESCRIPTION

Risk Cost (RC) and Return-On-Investment (ROI) provide useful data points for making investment decisions. These measures may be adapted to areas of application like pavement infrastructure maintenance management to be meaningful in those areas. For example, certain configurations of the invention provide methods and algorithms to determine an “estimated uniform annual cost” of a repairing and maintaining pavement section. Various equations can be used to facilitate estimations of costs and return-on-investments for maintenance and repair (M&R). PMA, a specialized computer running PMA software, may be configured to apply RC and ROI to pavement maintenance activities.

PMA may be designed to make calculations of RC and ROI more accurate by considering pavement models (“families”). Use of pavement models may provide a more accurate outcome than, for example, using a linear-decay model or uniform pavement repair costs. PMA may be configured to calculate RC and ROI more accurately by including historical data about the particular pavement section being evaluated. PMA may be configured to make the RC and ROI numbers more usable by integrating these numbers into existing maintenance planning tools such as a section M&R Computer, Section Maintenance and/or Repair System, and/or an Inspection system.

PMA may be configured to resolve the pavement maintenance management question “what is the most economically effective maintenance and repair (M&R) actions to perform on my pavement infrastructure?” PMA may be configured to manage a pavement repair calendar for a small network of roads (like a gated community), a military base, a city or county, or even an entire country of roads.

PMA may be configured to calculate estimated uniform annual cost (EUAC) of global, major and localized preventive M&R at a particular point in time, based on both pavement condition family and section history in which the pavement condition family may be adjusted based on historical work and inspections. The pavement condition family may be adjusted based on already planned work. The adjusted pavement condition family may be used to calculate the EUAC both when performing and not performing the particular type of M&R under consideration.

For localized preventive M&R, the method of calculating EUAC may be varied depending on (a) whether the pavement condition family was built including or not including preventive M&R, and (b) whether a work planning method is including localized preventive M&R or not.

PMA may be configured to determine a localized cost component of EUAC for Major M&R in which: the cost calculation may be adjusted based on whether the condition family is built with or without preventive M&R. The cost calculation may be adjusted based on whether the work planning method includes localized preventive M&R or not. The cost calculation may be adjusted based on whether the current estimated condition of the section is above or below the critical condition.

PMA may be configured to determine the critical condition for a condition family that employs an iterative algorithm to determine the PCI at which Major M&R has a maximum ROI and in which an initial estimated critical PCI may be used to begin the iteration. The ROI for major M&R may be calculated at each condition value using the configurations described above, and the maximum of which is used as the next estimate of critical PCI. The final estimated critical PCI may be the value at which the iteration stabilizes.

PMA may be configured to determine an effect of localized preventive M&R on a section's life that employs an iterative algorithm. The algorithm may be used either for estimating the life gain for doing preventive work on a section whose condition family does not include preventive, or for estimating the life loss for not doing preventive work on a section whose condition family does include preventive. PMA may generate an estimate of life gain/loss for a pavement with a twenty-year life is adjusted appropriately to estimate the life gain/loss for a particular pavement. PMA may adjust the algorithm based on the inspection and work history of the section by shifting the pavement condition family appropriately, then calculating an annual age adjustment needed to determine a proportionality factor to apply to a twenty-year life effect.

There may be three categories of M&R; Localized (spot maintenance such as patching or crack sealing), Global (pavement preservation by applying different types of seal coats to eth entire pavement surface), and Major (such as pavement overlay or reconstruction to bring the pavement to new condition). The RC and ROI methods for each of these categories are different and are included in this disclosure.

PMA may comprise a repair priority logic configured to: prioritize repairs into three priority categories: low priority repairs, medium priority repairs, and high priority repairs; determine a repair priority for each of the pavements within a user's network; and adjust the repair priority of the pavements to maximize a user's return-on-investment.

PMA may comprise a return-on-investment calculator configured to prioritize different types of repairs as high, medium, and low priority. The return-on-investment calculator may be configured to set and modify these priorities to maximize a user's budget. The software can determine which roads should be repaired first and what kind of repairs should be made. The software may be configured to analyze all the possibilities a user has (e.g., what types of equipment for repairs) and provide the user with recommendations as to which repairs to make. return-on-investment calculator may be configured to forecast deterioration of roads if repairs are not made. The return-on-investment calculator may be configured to calculate an ROI for each section of each road in a network of roads. The return-on-investment calculator may include in its calculations, costs associated with making repairs versus costs of not making repairs.

PMA may comprise a pavement condition prediction engine. The pavement condition prediction engine may contain algorithms that analyze and predict pavement deterioration based on pavement type, pavement families, repair history, and deterioration history. The pavement condition prediction engine may be configured to perform this analysis on a pavement section level based on the actual history of that section of the pavement. The pavement condition prediction engine may be configured to determine a cost curve for repairs for a pavement section and determine an exact point in time where repair costs get much more expensive. This point is known as the PCI Pavement Condition Index.

PMA may comprise budget & reports generation module (also referred to as a results module). The budget & reports module may be configured to optimize a user's budget if the software is given a budget to spend over the course of several years. The budget & reports module may be configured to generate a budget to maintain pavement condition (as specified by the user) at or above a certain pavement quality. The budget & reports module may be configured to generate various reports that contain recommendations on what pavement to repair and how to repair them over a course of time (e.g., a 5-year plan.) The budget & reports module may be configured to generate digital color code maps to aid the user in understanding what pavement to repair and what their roads will look like if roads are not repaired.

### Terminology

S: refers to a specific pavement section on which a Pavement Management Application (PMA) may be configured to determine M&R risk cost and return-on-investments. In some configurations, critical properties of S such as its surface type and its area (Areas) are known.

PF: refers to a PCI family. PMA may assign a PCI family to a Section under consideration or evaluation. A PCI family may comprise three properties. One, a deterioration curve from pavement age to pavement condition. Two, PCI_{crit}: a critical PCI value for the family. The critical PCI value may be the value below which global and localized preventive M&R (pavement preservation) are no longer performed, and safety M&R begins. Three, whether the deterioration curve is based on sections that have had localized preventive M&R performed.

PF^{S}(t) refers to the PCI family PMA may have assigned to a section S after PMA has made adjustments based on section history or predicted condition up to time/age t. Specifically, PMA may shift the deterioration curve for the family on the time axis so that the curve passes through a particularly observed (in the case of inspection) or calculated (in the case of global work or working planning) age×condition pair. It's possible that at different points in time t, the curve shift will be different, typically based on the latest work, inspection, or condition prediction prior to t.

MF: refers to an M&R family. PMA may assign an M&R family to a Section under consideration. The M&R family may have six properties. One, a cost curve from PCI to localized preventive M&R cost per unit area. Two, a cost curve from PCI to localized safety M&R cost per unit area. Three, a cost curve from PCI to major M&R cost per unit area. Four, the specific types of global work to perform for minimal, climate-related and skid-causing distresses. Five, a cost table specific global work type to cost per unit area. Six, the PCI at which sections in this M&R family are typically reconstructed (PCI_{recon}).

IH^{S}: refers to the inspection history for S. PMA may use each inspection in the section's history to identify the date, the age of the pavement at the time of inspection and its PCI value (based on observed distresses).

WH^{S}: refers to the work history of S. The work history of S may include the dates when the section received major or global M&R.

tₑᵥₐₗ: refers to the date at which the pavement management application computes estimated uniform annual cost.

T^{S}_{w}(tₑᵥₐₗ): refers to the lifetime of section S from last Major M&R to PCI_{crit} when work of a particular category of M&R is performed by a third party on S at tₑᵥₐₗ.

t_{wp}: refers to the date at which M&R work planning begins.

The pavement management application may be configured to integrate risk and ROI calculations into pavement work planning. The pavement management application may be configured to use a work planning method incorporating PCI families assigned to a Section to estimate the Section condition in future years. The work planning method may include an algorithm for determining what work to do in which year. The work planning method may utilize the M&R work family assigned to the Section to estimate work costs for each plan year. The work planning method may be configured such that the pavement management application can produce the following two outputs: WP^{S}(tₑᵥₐₗ): refers to work the work planner has planned for S from t_{wp} to tₑᵥₐₗ−1 and C^{S}(tₑᵥₐₗ): refers to the conditions the work planner has predicted for S from t_{wp} to tₑᵥₐₗ.

The pavement management application (PMA) may be configured with a date conversion module. The date conversion module may be configured to allow the pavement management application (PMA) to convert a Section's date (such as tₑᵥₐₗ) to a Section's age at that date. The date conversion module may utilize the information in the Section's work history WH^{S} to convert between Section data and Section age at that date. Throughout the application, date and ages are generally expressed in terms of fractional years, so an expression such as tₑᵥₐₗ−1 means “one year before the date/age given by tₑᵥₐₗ.”

The pavement management application (PMA) may be programmed to use the above elements to determine risk cost and return-on-investment.

EUAC^{S}_{w}(tₑᵥₐₗ): refers to an estimated uniform annual cost per unit area for S when performing work (w) of a particular category at time/age tₑᵥₐₗ.

EUAC^{S}_{wo}(tₑᵥₐₗ): refers to an estimated uniform annual cost per unit area for S without (wo) performing work of a particular category on S at time/age tₑᵥₐₗ.

ΔEUAC^{S}(tₑᵥₐₗ)=EUAC_{wo}^{S}(tₑᵥₐₗ)−EUAC_{w}^{S}(tₑᵥₐₗ): refers to the change in estimated uniform annual cost per unit area between doing work and not doing work of a particular category on S at time/age tₑᵥₐₗ.

$${ROI}^{S} ( {t}_{eval} ) = [ \frac{Δ E U A {C}^{S} ( {t}_{e v a l} )}{E U A {C}_{w}^{S} ( {t}_{e v a l} )} ] \times 100$$

refers to a return-on-investment for performing work of a particular category on S at tₑᵥₐₗ.

RC^{S}(tₑᵥₐₗ)=ΔEUAC^{S}(tₑᵥₐₗ)×Areas is the annual risk cost for performing work of a particular type on S at tₑᵥₐₗ. This is definition of risk cost based on estimated uniform annual cost includes a multiplier by section area. Since EUAC is expressed in terms of unit area, the pavement management application (PMA) may be configured to multiply the EUAC by the area of S to resolve risk cost.

PMA may be configured to use the equations for ΔEUAC, ROI and RC to accurately determine EUAC^{S}_{w}(tₑᵥₐₗ) and EUAC^{S}_{wo}(tₑᵥₐₗ) for a particular work category for a pavement section S at time/age tₑᵥₐₗ.

PMA may be configured to determine methods for each of three M&R categories: Global M&R, Localized Preventive and Major.

Referring to FIG. 1, PMA may be configured to determine EUAC^{S}_{w}(tₑᵥₐₗ) and EUAC^{S}_{wo}(tₑᵥₐₗ) for global M&R. To determine these values, PMA may utilize certain input information and determine certain costs in performing the calculations. Co-pending application (COE-871A) contains detailed information on the algorithm and method to resolve EUAC^{S}_{w}(tₑᵥₐₗ) and EUAC^{S}_{wo}(tₑᵥₐₗ) for global M&R. As shown, PMA may be configured to:
1. Calculate EUAC^{S}_{w}(tₑᵥₐₗ) and EUAC^{S}_{wo}(tₑᵥₐₗ) for global M&R (1.0.1);
2. Calculate the Common$ by adding the cost for work done before tₑᵥₐₗ (G$_{before})+the cost for reconstructing the section Major$_{crit} when the Section reaches critical PCI (1.0.2);
3. Use PF^{S}(tₑᵥₐₗ) to determine T^{S}_{wo}(tₑᵥₐₗ), the life (time to critical condition) for S without doing global work at tₑᵥₐₗ(1.0.3);
4. Use P^{S}(tₑᵥₐₗ+1) to determine T^{S}_{w}(tₑᵥₐₗ)), the lifespan for S with global work at tₑᵥₐₗ. PMA may be configured to use P^{S}(t) to compute the condition C_{w} for S in each year from tₑᵥₐₗ+1 to T^{S}_{w}(tₑᵥₐₗ) (1.0.4);
5. Use a LocalCostCalc method to determine localized cost up to T^{S}_{w}(tₑᵥₐₗ) (1.0.5);
6. Use the global work types identified in MF and whether the distresses recorded in IH^{S} are climate-related, skid-causing or other (1.0.6).

Referring to FIG. 2, the LocalCostCalc method (executed by PMA) can generate a sum of three cost vectors. PMA may use this Sum to determine the EUAC^{S}_{w}(tₑᵥₐₗ) and EUAC^{S}_{wo}(tₑᵥₐₗ). As shown, PMA may comprise:
1. A historical calculator for determining costs for the historical period; the historical calculator configured to generate a first cost vector (2.0.1);
2. A planned calculator for determining costs for the planned period; the planned calculator configured to generate a second cost vector (2.0.2);
3. A future calculator for determining costs for the future period; the future calculator configured to generate a third cost vector (2.0.3); and
4. A cost calculator may be configured to calculate a result cost generated by summing the first cost vector, a second cost vector, and a third cost vector (2.0.4).

A full explanation and detailed process flow for the LocalCostCalc method may be found in Co-pending application (COE-871A) (incorporated by reference in its entirety).

Referring to FIG. 3, PMA may be configured to determine estimate uniform annual cost with and without major M&R at time tₑᵥₐₗ. As shown, PMA may be configured to:
1. determine EUAC^{S}_{wo}(tₑᵥₐₗ) (3.0.1);
   a. determine the cost for reconstructing the section at PCI_{recon} (Major$_{recon}), the cost for doing global work through t_{recon}−1 (G$_{wo}) (3.0.2);
   b. determine the cost for doing local through t_{recon}—1 (L$_{wo}). PMA may be configured to determine t_{recon} (3.0.3);
   c. determine the age at which S will reach the reconstruction PCI PCI_{recon}. t_{recon} can be determined using PF^{S}(tᵥp) (3.0.4); and
2. determine EUAC^{S}_{w}(tₑᵥₐₗ) (3.0.5);
   a. determine the cost for reconstructing the section at tₑᵥₐₗ (Major$ₑᵥₐₗ) (3.0.6);
   b. determine the cost for doing global work through tₑᵥₐₗ−1 (G$_{w}) (3.0.7); and
   c. determine the cost for doing local through tₑᵥₐₗ−1 (L$_{w}) (3.0.8).

Co-pending application (COE-871A) (incorporated by reference in its entirety) contains detailed information on the algorithm and method to resolve estimate uniform annual cost with and without major M&R at time tₑᵥₐₗ.

### Algorithm for Using Major M&R ROI to Determine Family Critical PCI

PCI_{crit} is the critical PCI for the PCI Family PF used in the methods. The critical PCI is the point at which it is no longer economically reasonable to do preventive work (local or global) on a section in the family. PMA may be configured to estimate PCI_{crit} for a family of roads by identifying an inflection point in the family curve of road condition (Y-axis) and time (X-axis). See FIG. 62 as an example. PMA may also calculate the 2^{nd} derivative of the curve to identify inflection points. Additionally, PMA may be configured to calculate major ROI. Once major ROI is determined, PMA may estimate critical PCI. PMA may determine the critical PCI to be PCI at which the ROI for major work is maximized. However, since critical PCI may be an input to the ROI calculation (as presented above), PMA may need to be programmed to use an iterative method to arrive at the PCI_{crit} which maximizes ROI. A PCI_{crit} determination module may be configured to: determine a second derivative of a family curve to determine a point in the lifetime of a section of pavement where PCI begins to decrease; and determine a third derivative of a family curve to determine a point in the lifetime of section of payment where decay rate of the pavement quality accelerates. The PCI_{crit} determination module may be configured to: recommend major repair work for a section of pavement that has PCI lower than the critical PCI; and wherein the critical PCI is a point in the lifetime of a section of pavement wherein preventive maintenance no longer generates a positive ROI.

As shown in FIG. 4, PMA may accept through its input interface, a Section of pavement for evaluation (S); a PCI family (PF) assigned to Section (S) defined as PF^{S}; wherein PCI is a pavement condition index of the Section; an input estimated critical PCI (PCI_{crit}) for PF^{S}; a M&R family (MF^{S}) assigned to S; an inspection history (IH^{S}) for S; a work history (WH^{S}) for S; a work plan start (t_{WP}); a time of evaluation (tₑᵥₐₗ); a work-planned work for S before (tₑᵥₐₗ); and a work-plan predicted conditions (C^{S}(tₑᵥₐₗ)) for S up to tₑᵥₐₗ (4.0).

PMA may be configured to use t_{recon} (the age at which sections in PF reach PCI_{recon}) as the upper bound of a range of ages (4.1). PMA may maintain an iteration counter i initially set to 1 and the current estimated critical PCI (C_{curr}), initially set to the input estimate (4.2). PMA may be configured to loop setting PCI_{crit} for PF to the current estimate C_{curr}.

PMA may be programmed to compute EUAC for major repairs to calculate the ROI for major work at each age from 0 to t_{recon}. The general algorithm is shown in FIG. 3, but also see co-pending U.S. Patent Application COE-871A incorporated by reference which contains more detail on computing EUAC for major repairs. In some configurations, PMA might not be configured to compute the critical PCI for any particular Section (4.3). In such a configuration, PMA might not be configured to perform any inspection or work history data to shift the curve PF. Rather, PMA may be configured to use ROI^{PF}(t) to indicate the ROI (4.3.1).

PMA may be configured to resolve the t value where ROI^{PF}(t) is maximized (4.3.2). PMA may be programmed to select the PCI at this age as a candidate (starting place) for a next estimate. PMA may comprise a convergence detection logic programmed to determine whether a difference between the candidate new estimate and the previous is below a threshold value. The convergence detection logic may determine that the loop has converged when the difference is less than (below) the threshold value. (4.3.3) PMA may also comprise an outside range detection logic configured to determine whether a new candidate estimate is outside an acceptable range (4.3.3). PMA may also comprise boundary detection logic configured to check against an iteration boundary to avoid non-convergence of the iteration (4.3.4). PMA may also comprise an iteration manager configured to increment the iteration counter, set the new estimate to the new candidate, and proceed back to the start of the loop (4.3.5). Generally, PCI differences of 2 or larger are significant, so a threshold value could be less than 2. A threshold of 0 may be unreasonable because it may be unlikely to converge. So in some configurations, the threshold may be in the range (0, 2). PCI may be shown to a single digit after the decimal, so exemplary thresholds may be selected from the set of 0.1, 0.2, 0.3, . . . , 1.9. In some configurations, a user can pick a delta-h in this range. PCI values by definition are in the range [0, 100] so we must have C min >0 and C max <100. Generally, we would expect C min >20 and C max <90. This is an input to the algorithm so users can pick any subset of this range that makes sense for their area.

### Localized Preventive M&R

FIG. 5 details a program and algorithm to estimate uniform annual cost for localized preventive M&R. In estimating uniform annual cost for localized preventative M&R there are two different cases depending on whether the PCI family assigned to S was built using data from sections on which localized preventive was performed regularly (“family built with preventive”) or not (“family built without preventive”).

When the PCI family is built with preventive (maintenance), PMA may be configured to use the family to determine EUAC^{S}_{w}(tₑᵥₐₗ). There may be more steps for PMA to follow to compute EUAC^{S}_{wo}(tₑᵥₐₗ).

When the PCI family is built without preventive, PMA can be programmed to determine EUAC^{S}_{w}(tₑᵥₐₗ) by the algorithms explained next. As the algorithms are different, PMA may be configured to handle both cases by coding both algorithms into PMA subroutines and process flows.

In some cases, PMA may also need to be configured to determine the effect of localized preventive M&R on pavement life. When the PCI family is built with preventive, PMA may be configured with algorithm to estimate the lifespan loss for not doing preventive. When the PCI family is built without preventive, PMA may need to be configured to estimate the lifespan gain for doing preventive.

### Method for Determining the Effect of Localized Preventive on a Section's Life

PMA's algorithm to determine the effect of localized preventative on a Section's lifespan may comprise one or more assumptions. One, that localized preventive work has economic value. This first assumption may imply that the estimated uniform annual cost for a section when preventive is done is no more than that for the same section without preventive.

EUAC_{w}≤EUAC_{wo}

Two, that PMA is configured to use factors such as the local climate to arrive at a reasonable estimate of ΔT²⁰, the lifespan gain (for a family built without preventive) or lifespan loss (for a family built with preventive) for a pavement that has twenty-year life with preventive. Three, that ΔT^{S}, the lifespan gain or loss for section S, is proportional to ΔT²⁰, specifically that ΔT^{S}=P(PF, MF) ΔT²⁰, where P is a proportionality function based on PF and MF.

Major$_{crit}: represents the unit cost for doing major at the Section's critical PCI.

p$ᵢ: represents the unit cost of doing preventive work on the Section at age i.

s$ᵢ: represent the unit cost of doing safety work on the Section at age i.

T_{w}: represents the last age (in whole years) at which the section is above critical PCI when preventive work is done on the Section.

T_{wo}: represents the last age (in whole years) at which the section is above the critical PCI when preventive work NOT done on the Section.

In the above example, the PMA is configured to make calculations for change in lifespan over the course of 20 years. Of course, PMA could be configured to use any number of years (x years). The time/duration could also be months or portions of a year (in such modifications PMA's algorithm would simply be adjusted using dimensional analysis to convert years to months, etc.)

### Rewriting the Above Inequality:

$$\frac{Major {\$}_{crit} + {\sum }_{i = 0}^{{T}_{w}} p {\$}_{i}}{{T}_{w}} \leq \frac{Major {\$}_{crit} + {\sum }_{i = 0}^{{T}_{wo}} s {\$}_{i}}{{T}_{wo}}$$

Rearranging terms

$$\frac{{T}_{wo}}{{T}_{w}} \leq \frac{Major {\$}_{crit} + {\sum }_{i = 0}^{{T}_{wo}} s {\$}_{i}}{Major {\$}_{crit} + {\sum }_{i = 0}^{{T}_{w}} p {\$}_{i}}$$

Now define

$${k}_{w} = \frac{Major {\$}_{crit} + {\sum }_{i = 0}^{{T}_{wo}} s {\$}_{i}}{Major {\$}_{crit} + {\sum }_{i = 0}^{{T}_{w}} p {\$}_{i}}$$

Then

$$\frac{{T}_{w} - Δ {T}^{S}}{{T}_{w}} \leq {k}_{w}$$

So

$$1 - \frac{Δ {T}^{S}}{{T}_{w}} \leq {k}_{w}$$

or

$$\frac{Δ {T}^{S}}{{T}_{w}} \geq 1 - {k}_{w}$$

The above yields are final equation:

$$P ( PF , MF ) = \frac{1 - {k}_{w}}{1 - {k}_{20}}$$

With the above formula, the PMA repair program could be configured to calculate P(PF, MF) by solving the equation

$$P ( PF , MF ) = \frac{1 - {k}_{w}}{1 - {k}_{20}}$$

through determining values for K₂₀ and K_{w}; K₂₀ and K_{w} are constants; P is a proportionality function based on PF and MF; thus yielding a relationship of PCI family to M&R Family. K_{w} is a ratio of the lifetime cost without preventative maintenance divided by lifetime cost with preventative maintenance for a life with preventative of w; w is years of life of a section of pavement until the critical PCI is reached; K₂₀ is K_{w} wherein w is 20.

In other words, to determine the proportionality of PF to MF, PMA could be configured to determine values for k₂₀ and k_{w}.

The lifespan with preventive (T_{w}) may be 20 years. Therefore, PMA can compute ΔT²⁰, so we also know the life without preventive (T_{wo}). Thus, PMA can be configured to perform T_{w}=20. T_{wo}=20−ΔT²⁰ (5.1).

For families built without preventive, PMA may set PF²⁰ to be the family curve shifted to pass through T_{wo}, PCI_{crit} (5.2). PMA may be configured to calculate the annual age adjustment Aa as the life gain ΔT²⁰ divided by T. (5.2.1). PMA may be configured to use PF²⁰ to calculate conditions C_{w} from 0 to T_{w} but subtracting iΔa from the age when calculating condition for age I (5.2.2). PMA may use PF²⁰ to calculate conditions C_{w} from 0 to T_{w}. (5.2.3). For families built with preventive, PMA may set PF²⁰ be the family curve shifted to pass through T_{w}, PCI_{crit} (5.3.3). PMA may be configured to calculate the annual age adjustment Aa as the life loss ΔT²⁰ divided by T_{wo}. (5.4.1).

PMA may calculate the conditions without preventive from 0 to T_{wo} by applying PF²⁰ at each age I from 0 to T_{w} but first incrementing the age by iΔa (5.3.2). PMA may calculate the conditions with preventive C_{w} from 0 to T_{w} directly using PF²⁰. PMA may calculate k₂₀ can calculated using the equation for kw below given the inputs and the preventive and safety costs (5.4).

$$Calculate {k}_{20} = ( ( Major {\$}_{crit} + s {\$}_{wo} ) / ( Major {\$}_{crit} + p {\$}_{w} ) )$$

PMA may be configured to calculate safety costs. PMA may be configured to use the conditions C_{wo} from ages 0 to T_{wo} and use the safety cost curve in MF to get the total safety cost.

PMA may be configured to calculate preventive costs by using the conditions C_{w} from ages 0 to T_{w} and using the preventive cost curve in MF to get the total preventive cost (5.4.2).

PMA may be configured to comprise different algorithms to resolve K_{w} between families built with preventive and families built without preventive. For families built without preventive, PMA can directly resolve T_{wo}. PMA can use the family curve PF to compute the sum of the safety cost. PMA might not be able to directly determine T_{w}. In such cases, PMA would not be able to calculate the sum of the preventive cost.

For families built with preventive, the situation is the converse: PMA would be able to directly determine T_{w} and can calculate the preventive cost. However, PMA might not be able to directly determine T_{wo} and would not be able to calculate the safety costs.

In both situations, the unknown term is a function of ΔT^{S}, PF and MF. Since the proportionality equation has ΔT^{S} on both sides and on the right-hand side it is convolved with two other functions, there is no closed-form solution. If PMA is configured to assume that any reasonable preventive cost curve will increase with increasing age, both sides of the equation will be monotone increasing as PMA increases ΔT^{S}. Therefore, PMA can resolve a solution for ΔT^{S} by executing an iterative algorithm such as binary search. PMA may be configured to set ΔT^{S}≥0 so PMA can be configured to use 0 as the lower bound for its search.

For families built without preventive, PMA can use the family curve shifted based section history to determine T^{S}_{wo}. PMA may set an upper bound as U=max(2 ΔT²⁰, ΔT²⁰×T^{S}_{wo}/(20−ΔT²⁰)). Max means maximum.

For families built with preventive, PMA may be configured to use the family curve shifted based section history to determine T^{S}_{w}. PMA may set an upper bound as U=max(2 ΔT²⁰, ΔT²⁰×T^{S}_{w}/20). PMA could be configured to run a binary search beginning with an estimated ΔT^{S} of U/2 and an error bound will then converge to a solution in any realistic case.

Referring to FIG. 6, PMA may be configured to determine an estimated uniform annual cost for localized preventive M&R at tₑᵥₐₗ when the family is built with preventive to compute the ROI for continuing to do preventive work at tₑᵥₐₗ. To determine the annual cost, PMA may:
1. estimate uniform annual cost for localized preventive M&R at tₑᵥₐₗ when the family is built with preventive to compute the ROI for continuing to do preventive work at tₑᵥₐₗ; (6.0.1)
2. determine both EUAC^{S}_{wo} and EUAC^{S}_{w}, by determining Common$, the sum of global work cost up to tₑᵥₐₗ (G$_{before}), localized work costs before work planning (L$ₚᵣₑ₁), localized work costs from work plan start to tₑᵥₐₗ (L$ₚᵣₑ₂) and the cost for major at PCI_{crit} (Major$_{crit}); (6.0.2)
3. calculate localized costs before the workplan starts (L$ₚᵣₑ₁) from conditions by using the family curve shifted based on inspection and work history; (6.0.3)
4. obtain localized costs L$ₚᵣₑ₂ from workplan start to tₑᵥₐₗ; (6.0.4)
5. determine the localized cost term L$_{w}; (6.0.5)
6. resolve T^{S}_{wo}(tₗᵢ), the lifespan loss for not doing preventive on S after tₗᵢ; (6.0.6)
7. calculate an annual age increase Δa as Δt^{S}(tₗᵢ) divided by the interval from tₗᵢ to T^{S}_{wo}(tₗᵢ); (6.0.7) and
8. use the safety cost curve of MF to compute L$_{wo} and finally EUAC^{S}_{wo}(tₑᵥₐₗ) (6.0.8).

Co-pending application (COE-871C) (incorporated by reference in its entirety) contains detailed information on the algorithm and method to determine critical estimated uniform annual costs for preventive M&R at tₑᵥₐₗ when the family is built with preventive to compute the ROI for continuing to do preventive work at tₑᵥₐₗ.

PMA may be configured to determine an estimated uniform annual cost for localized preventive M&R at tₑᵥₐₗ when the family is built with preventive to compute the ROI for starting to do preventive work at tₑᵥₐₗ. Co-pending application (COE-871C) (incorporated by reference in its entirety) contains detailed information on the algorithm and method to determine critical estimated uniform annual costs for preventive M&R at tₑᵥₐₗ when the family is built with preventive to compute the ROI for starting to do preventive work at tₑᵥₐₗ (see FIG. 6B and related description).

Referring to FIG. 7, PMA may be configured to determine estimated uniform annual cost for localized preventive M&R at tₑᵥₐₗ when the family is built without preventive to compute the ROI for continuing to do preventive work at tₑᵥₐₗ. To determine the annual cost, PMA may utilize certain input information and determine certain costs in performing the calculations. Co-pending application (COE-871C) (incorporated by reference in its entirety) contains detailed information on the algorithm and method to estimated uniform annual cost for localized preventive M&R at tₑᵥₐₗ when the family is built without preventive to compute the ROI for continuing to do preventive work at tₑᵥₐₗ.
1. determine Global cost G$_{before} by summing two elements;
   a. determine G$ₚᵣₑ as the cost of actual global work recorded in the section work history WH^{S}; and
   b. determine global work included in work plan results WP^{S}(tₑᵥₐₗ) before tₑᵥₐₗ.
2. calculate localized costs before the workplan starts;
3. resolve localized costs L$ₚᵣₑ₂ from workplan start to tₑᵥₐₗ;
4. For families built without preventive, PMA may be configured to use the family curve to calculate the inputs for EUAC^{S}_{wo}(tₑᵥₐₗ);
5. For families built without preventive, PMA may be configured to determine T^{S}_{w} (the life of S when doing preventive on and after t_{wp}) and L$_{w} (the cost for localized work from tₑᵥₐₗ to T^{S}_{w}); and
6. PMA may be configured to use the preventive cost curve of MF to compute L$_{w} and finally EUAC^{S}_{w}(tₑᵥₐₗ) when C_{w} has been resolved.

PMA may be configured estimated uniform annual cost for localized preventive M&R at tₑᵥₐₗ when the family is built without preventive to compute the ROI for starting to do preventive work at tₑᵥₐₗ. To determine the annual cost, PMA may utilize certain input information and determine certain costs in performing the calculations. Co-pending application (COE-871C) (incorporated by reference in its entirety) contains detailed information on the algorithm and method to determine estimated uniform annual cost for localized preventive M&R at tₑᵥₐₗ when the family is built without preventive to compute the ROI for starting to do preventive work at tₑᵥₐₗ (see FIG. 7B and related description).

### PMA Configurations

Referring to FIG. 8, a user may operate a computer comprising a processor 802, memory 804, system bus 806, network interface 808, storage media 810, display 812, and controls 814 (like a mouse and keyboard). The processor 802 may run or execute a program stored in the storage media and/or memory to cause the processor to execute a sequence of steps and/or algorithms, i.e., run the program PMA 820. PMA is a software program that may be configured to analyze and prioritize repairs of Sections (S). PMA may comprise a data input module 822, solver 824, and result module 826 capable of determining optimized maintenance and repair schedules for a network of Sections. As shown, the computer operating PMA may be connected to a database 830 and a second computer—the Section M&R computer 850 (also having processor, memory, system bus, network, storage media, display, mouse, and keyboard).

The database 830 may be a component in the PMA computer 800 or be its own server. As a database, the server may comprise database management software capable of sorting, updating, retrieving, and manipulating records stored in the database. The server may comprise standard hardware found in servers such as processors, memory, network interface, storage media, etc.

The Section M&R computer may have a section maintenance and/or repair scheduler 852 configured to schedule maintenance and/or repairs on a section. The Section M&R Computer 850 may interface with a section maintenance and/or repair system. The section maintenance and/or repair system 860 may comprise various trucks 862, computers 864, supplies 866, paving equipment 868, and pavement repair technology 870 useful for paving and repairing roads. In some configurations, the PMA computer and the Section M&R computer can be a single computer.

An inspection system 880 may be a machine configured to inspect a condition for one or more sections. The inspection system may comprise computers 882 and cameras 884. The computer may comprise specialized software for determining pavement condition from images obtained by the cameras. An inspection system may be mounted in a plane, helicopter, truck, car, or other vehicle 886. An inspection system may contain controls 888 for local or remote operations of the inspection system by an inspector. An inspection system may be configured to generate inspection records. Inspection records may contain information recorded and/or obtained about distresses (such as degree and quantity) of a Section. PMA may be configured to store these records. PMA may be configured to display these records in the inspection ribbon. PMA may be configured to allow a user to manage, change, sort, and manage an inspection history of a Section. An inspection history is a collection of inspection records of the Section. A Section is a portion of a branch. Branches may include pavement, roads, streets, parking lots, highways, parkways, runways. PMA, taxiways, or aprons. A section may be surfaced with asphalt, concrete, brick, aggregate, or mat. Paver may be configured to manage sections as its primary unit.

PMA, like many programs/applications, may comprise a plurality of windows. A window may comprise one or more buttons, fields, labels, toggles, select boxes, drop down boxes, radial boxes, etc. Each window in PMA may comprise underlying or associated logic, algorithm, or software routine configured to accept inputs, process inputs, generate results, stores results, display results, and/or issue instructions to other logic and/or windows and/or systems. For example, the inspection window may comprise an inspection logic. The inspection logic may be configured to store inspections records for a Section. Or in another example, the inventory window may comprise an inventory logic. The inventory logic may be configured to divide a large area of pavement into groupings.

PMA may have a main menu and a ribbon menu. These menus may be configured organized various windows. The ribbon menu may have an inventory, reports, selectors, work, debug, inspection, family modeling, conditions performance analysis, M&R family models inventory, M&R work planning, project formulation wizard, and wizards. FIGS. 10A-10B shows the inventory ribbon menu.

FIG. 9 shows an overall view of various algorithms that PMA may be programmed to execute. FIG. 9 contains elements 1, 3, 4, 5, 6A, 6B, 7A and 7B. More details on each of these elements may be found in FIGS. 1-7B and in the other two co-pending applications incorporated by reference above.

FIGS. 10A-61B are screenshots of an embodiment of PMA. In these embodiments, PMA may be a software program running a specialized PMA computer. The PMA computer may comprise optimized hardware to more efficiently run the PMA software program. The PMA computer may comprise a monitor to display these screenshots to a user.

FIGS. 10A-10B shows an inventory window in PMA. PMA may have inventory. The inventory may be stored on the computer and/or remote database. The inventory can be used to divide a large area of pavement into groupings. As shown, the inventory window may have 3 tabs: a5 network tab, branch tab, and a section tab. FIG. 10A-FIG. 10B show the network tab in detail. The largest of these groupings may be a network such as a town or city. Within a network, there may be branches like a street. Branches may contain sections, i.e., a portion of a street reaching from one intersection to the next.

FIGS. 11A-11B show the inventory window of the branch tab, the branch tab may show branch properties. Example properties include branch ID, use, sum of section lengths, sum of true section areas, brand true area.

FIGS. 12A-12B shows the inventory window of the section tab. The section tab may show a table inventory section's properties. Sections (S) are represented by variable S in various algorithms in the application. The section tab may have several subtabs including: properties, conditions/families, and samples. FIGS. 12A-12B show the properties subtabs.

FIGS. 13A-13B shows a window of GIS maps. GIS Maps can be used to give context to the inventory. The GIS map shows a map of roadways in this figure, but may also be configured to show a map of an airfield. FIGS. 13A-13B show a current selection section.

FIGS. 14A-14B shows the inventory window with the conditions/families tab selected. The box indicates the inspection (IH^{S}) of a current Section. FIGS. 14A-14B show a radial selector including: view all latest conditions, view all indices and dates, view one condition index for all dates, view PCI Deteriorations Family Assignments, View M&R family assignments. The view one condition index for all dates is selected in FIGS. 14A-14B.

FIGS. 15A-15B shows the inventory window with the conditions/families tab selected and one condition index for all dates. The box indicates M&R families (MF) assigned to this section. The window shoes inspection dates, conditions, and method.

FIGS. 16A-16D shows an inspection window of the inspection submenu. Sections may be inspected by a user on a regular basis. An inspection system may be configured to record the distresses and their quantity. Inspections give us the condition across time (IH^{S}). Distresses may include a distress identifier, distress descriptions, distress severity, quantity, units (for the quantity), density, deduct, and/or comment. PMA may be configured to take, accept, and store pictures/video of distresses and sum distresses. The inspection system may be configured to capture images and/or videos of distresses. The inspection system may automatically transfer captured images and/or videos of section distresses to PMA. In some configurations, an algorithm executed a computer in the inspection system may be configured to determine which images and or video to transfer to PMA. In some configurations, the inspection system may comprise a selection tool configured to allow an inspector to make and/or override images and/or video to transfer to PMA. The Distresses selections shows 20 exemplary distresses such as alligator cracks, bleeding, block cracks, bumps, sags, corrugation, edge cracks, JT Ref. Cr, lane sh drop, L&T Crack, patch/UT cut, polished AG, pothole, rutting, shoving, slippage crack, swell, raveling, and weathering. JT=Joint; Ref.=Reflection; Cr=Crack; sh=Shoulder; L&T=Longitudinal and Transverse; UT=Utility; AG=Aggregate.

FIG. 17 shows a window called or displayed when the show conditions button is clicked. PMA may be configured to calculate multiple different condition values from the recorded distresses and quantities. PMA may be configured to use PCI for risk analysis. The window shows a network ID, branch ID, and section ID. It also shows section area, section width, and section length. The PCI index and condition value are also displayed.

FIGS. 18A and 18B show a PCI Family Models (PF) window. Records may be stored within a PCI family model. PMA may store conditions of similar sections across time as groups. PMA may use the groups to graph a point cloud of Age vs PCI. A point cloud of Age vs PCI is shown in FIGS. 18A and 18B. The PCI Family Models window may comprise tabs: review model data, use boundary/outlier, options, view equations and stats, and assign family.

FIGS. 19A and 19B show the PCI family model window with the view equations and stats tab selected. The PMA software may be configured to fit a curve to the point cloud. The equation of this curve is representative of how the condition of a section will change over time. In other words, the curve of the line models or is a prediction the condition of the section as a function of age of the pavement.

FIGS. 20A and 20B show the PCI family model window with the Assign Family tab selected. As the behavior of a Section's condition may depend on several factors, PMA may provide multiple models of the pavement's lifespan with a network. PMA may assign Sections to models built with data from similar Sections.

FIGS. 21A and 21B show the PCI family model window with the Options tab selected, but the top graph is not shown for illustration purposes. However, FIGS. 21A and 21B show the Critical PCI Nomination window (accessible by clicking the sweet spot analysis button). PMA may be configured to use risk calculations to perform a sweet spot analysis. PMA may be configured to compute ROI many times. PMA may change the PCI at time of work and the Critical PCI of the family to identify a combination (of PCI at time of work and the Critical PCI of the family) that generates a maximized (highest potential) ROI.

FIGS. 22A-22B, 23A-23B, 24A-24B, 25A-25B show examples of M&R Family windows. PMA may use M&R Families to group together M&R data that may be shared to all the Sections assigned to that M&R Family. The M&R data may include Cost by Condition, Cost by Work Type, and work types. PMA may use this M&R data when planning work.

FIGS. 26A and 26B show a major M&R cost table window. For major work, PMA may be configured to model a cost table. The cost table may be used by PMA to approximate a cost of doing road work on a Section based on the condition of the Section at the time of the work.

FIGS. 27A and 27B show a global M&R work type window. Global work types may have a Delta ΔT value. The Delta T value may be the expected life gain from application of the roadwork (e.g., completing recommended roadwork). The global M&R work type window may be configured to calculate a section specific Delta T value in the current fiscal year.

FIGS. 28A and 28B show a global work is priced by work types instead of condition. A table in the window displays a code, name, cost, and units.

FIGS. 29A-29B shows a window for preventative cost by condition. A table shows condition, cost, and unit area.

FIGS. 30A-30B shows a window for stopgap cost by condition. A table shows condition, cost, and unit area.

FIGS. 31A-31B shows a condition performance analysis window. PMA may be configured to generate condition analysis models. Condition analysis models may be configured to determine how Sections are going to decay if no M&R work is performed. PMA may be configured to shift the assigned PCI family to the latest inspection point for each section and compute the condition year by year for the duration of the work plan.

FIGS. 32A-32B shows a section condition list associated with the condition performance analysis window. PMA may be configured to collect condition values (C^{S}(tₑᵥₐₗ)) in the risk calculations of the pavement's life. PMA may be configured, for each of these conditions, to compute a cost using the appropriate cost by condition table and their sums become (C_{w}) and (C_{wo}).

FIGS. 33A-33B shows a work plan analysis window. The work plan analysis window may be configured to model conditions of Sections condition into the future. The work plan analysis window may be configured to apply M&R work to calculations regarding the condition of a Section in the present or in the future. Application of M&R work may result in an improvement of the condition and/or lifespan of the Section.

FIGS. 34A-34B shows a work plan analysis window with a budget tab selected. PMA may be configured to provide users with settings to constrain a budget available to a work plan. PMA may generate work recommendations. Work recommendations may be generated on a set schedule such as yearly or monthly. PMA may prioritize the work recommendation using a prioritization algorithm. PMA may reduce the work applied to fit within the budget limitations. In some configurations, PMA may comprise a prioritization method that utilizes risk analysis of ROI results.

FIGS. 35A-35B show a risk calculation window. The window can be turned on and off for each work category. As shown, there are checkboxes for localized stopgap M&R, localized preventative M&R. A global preventive M&R checkbox has sub-boxes: calculate risk and ROI, only plan global in PCI range, allow global for sections above critical with load defects, minimum age before global. A major M&R checkbox may comprise calculate risk and ROI.

FIGS. 36A-36B, 37A-37B, and 38A-38B show tabs. PMAM&R family tabs that may affect risk calculation. Paver may be configured to require the fill out these tabs when a risk calculation is turned on (enabled). The properties on these tabs may be configured to determine whether the assigned M&R Families are used to specify which cost tables to use or whether a single cost table should be used across all Sections.

FIGS. 39A-39B show a work plan analysis window with a global M&R family settings tab selected. PMA may be configured the user adjust/configure these global M&R family settings for the global risk calculations.

FIGS. 40A-40B show a results selection tool configured to cause PMA to display a result window such as a table, graph, map, menu, or display. In the example of FIGS. 40A-40B, PMA may be configured to generate thirty different results. In the example of FIGS. 40A-40B, a Section PCI by Year checkbox is selected. The result of Section PCI by Year is shown in FIGS. 41A-41C.

FIGS. 41A-41C show the results table Section PCI by Year table and graph. The table shows network ID, branch ID, and section ID. The screenshot also shows a graph of condition by year. Condition on the Y-axis, and year on the X axis.

FIGS. 42A-42B show a result window configured to display a major M&R risk by Section summary. In this window, PMA may be configured to calculate the ROI for each row and display them in the result window.

FIGS. 43A-43B show a result window configured to display a localized preventative M&R risk by section summary. The table shows year, NetworkID, BranchID, SectionlD, PCI at work date, % ROI (localized preventive), deterioration rate with localized preventive, Critical PCI, and Work Date for Risk.

FIGS. 44A-44C show a project planning window. PMA may be configured to generate projects. PMA may be configured to allow user to set projects as required or optional. These projects may define specific work to be done in the future. These projects may be included when running the work plan. A work planner (a software routine or logic) may be configured to take the project work into account when budgeting and making work recommendations. Once the work is completed, PMA may move these projects into a work history database for the relevant Sections.

FIG. 45 shows a work required window. Work required logic in the work required window may generate additional windows when the calculate risk button is selected. The additional windows generated may be configured to allow PMA to present options to the user. The options may be selected through three tabs: localized stopgap M&R, localized preventative M&R, and Major M&R.

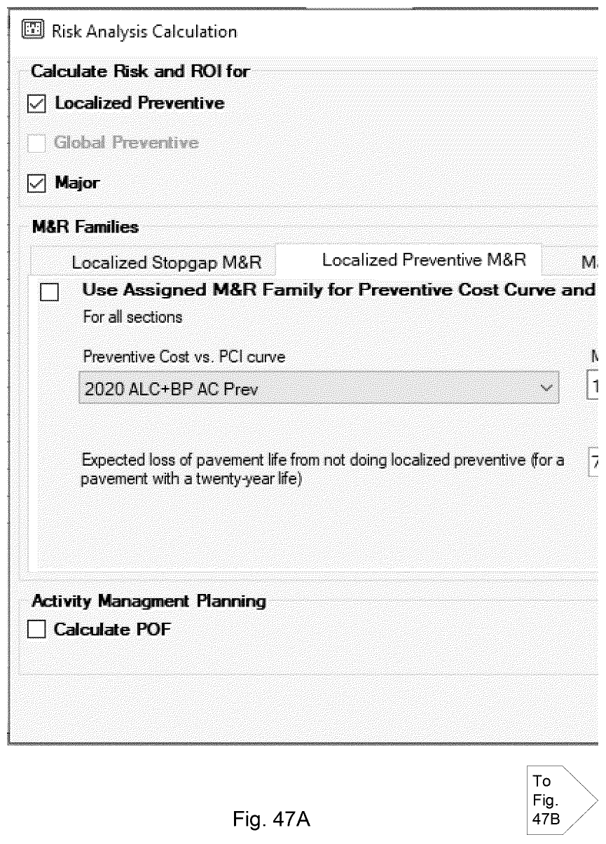

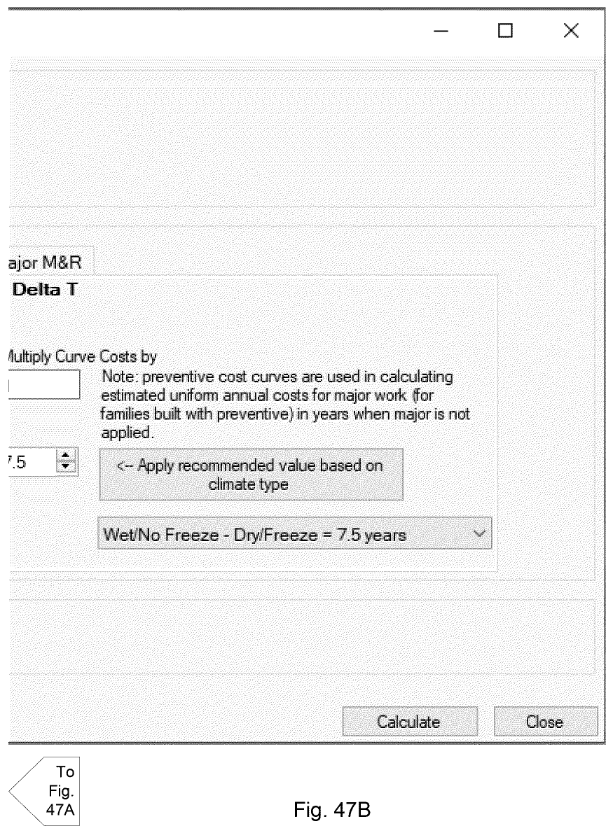

FIGS. 46A-46B, FIGS. 47A and 47B, and FIGS. 48A and 48B show additional risk calculation windows. FIG. 46 shows M&R Families calculations for localized stopgap M&R. FIG. 47 shows localized preventative M&R. Fig. shows a window to calculate risk and ROI.

FIGS. 49A-49C and FIGS. 50A-50C show a risk analysis for project work window. PMA may be configured to display this window as part of a results display. PMA may individually calculate risk for a project for each work item in the project. In some configurations, PMA may calculate an overall risk value at the project level.

FIGS. 51A to 51B show a project work detail window. The project work detail window may be configured to display individual work items risk value in an overview grid.

FIGS. 52A-52B show an inventory: surface, use, rank category window. The window shows parking in blue, roadways in green, and storage in yellow.

FIGS. 53A-53B show an assignment of PCI deterioration and M&R families window. The window may display an assignment of PCI deterioration families to pavement sections.

FIGS. 54A-54B show a work category by projects window. This window may display a list of projects—colors indicated M&R category.

FIGS. 55A-55B show a projects list window. This window may create a display of all projects—colors indicated M&R work type.

FIGS. 56A-56B show a work plan category by year window. This window may display a workplan recommended annual work categories for all pavement sections.

FIGS. 57A-57B show a workplan recommended for Major M&R by year window. Red is major above critical. Blue is major below critical.

FIGS. 58A-58B shows a first year of an annual section PCI when recommended workplan is performed window. White shows no data. Green is good. Teal is satisfactory. Yellow is fair. Salmon is poor. Red is very poor. Crimson is serious. Gray is failed.

FIGS. 59A-59B shows a second year of an annual section PCI when recommended workplan is performed window. White shows no data. Green is good. Teal is satisfactory. Yellow is fair. Salmon is poor. Red is very poor. Crimson is serious. Gray is failed.

FIGS. 60A-60B show a second year of an annual section PCI when recommended workplan is performed window. White shows no data. Green is good. Teal is satisfactory. Yellow is fair. Salmon is poor. Red is very poor. Crimson is serious. Gray is failed.

FIGS. 61A-61B show a predicted PCI when no work is performed window. The window features the same color legend as described for FIGS. 58-60.

Referring to FIG. 62, when the pavement is appropriately designed for traffic and the environment, one can expect the green curve. If the pavement is too weak to support the traffic, it normally fails very quickly and it performs as shown in the red graph. If the pavement is strong or overdesigned, it performs as shown in the blue graph. One can see strong pavement performance sometimes in concrete pavement performance. PMA may be configured to use the results of PCI inspection to develop the performance curve for each similar group of sections (family). A family curve may be somewhere between the red and blue curves.

Referring to FIG. 63, the figure shows how PMA might calculate pavement performance in the case when a Global is applied at tₑᵥₐₗ. The first blue portion of the curve (t₀ to t_{wp}) may be the pavement history prior to starting the work plan analysis. The second purple portion (t_{wp} to tₑᵥₐₗ) may be where the work plan applies the family curve and accounts for any Localized or Global applications in that period. PMA may be configured such that if Major is applied the PCI becomes 100 and a new life analysis begins. The rest of the figure shows what might happen if PMA were determining the ROI (or calculate risk) assuming Global is applied at tₑᵥₐₗ. The dark blue shows a family curve applied to the section based on the section PCI at that time. The increase in PCI at tₑᵥₐₗ may be calculated based on the value of ΔT₍ₜₑᵥₐₗ₎. The calculation may be done by shifting the curve so that the PCI value at tₑᵥₐₗ, (before the Global application), is equal to the PCI at tₑᵥₐₗ, (before the Global application), plus ΔT₍ₜₑᵥₐₗ₎.

The claimed invention is:

1. A PMA computer comprising a processor and tangible memory storing non-transitory computer readable software configured to cause the processor to execute a pavement repair program specialized in determining major maintenance and repair costs (Major M&R); the program comprising:
an input interface configured to allow a user to specify to the program:
a Section of pavement for evaluation (S) having a lifetime;
a PCI family (PF) assigned to Section (S) defined as PF^{S}; wherein PCI is a pavement condition index of the Section;
Cᵢₙᵢₜ an initial critical PCI estimate;
Δh: halting delta in the range [0,2];
B: integer iteration bound >1;
[Cₘᵢₙ,Cₘₐₓ]: acceptable critical PCI range; and
PCI_{recon}: Reconstruction PCI;
a PCI_{crit} determination module configured to indicate a point in time wherein spending additional resources on preventive maintenance work no longer economically makes sense to perform on a local or global level on a section in the family;
the pavement repair program configured to use a calculated value of critical PCI to determine an ROI calculation requiring a method of determining PCI_{crit} without relying on the calculated value of PCI_{crit};
loop setting PCI_{crit} for PF to the current estimate C_{curr};
a EUAC (estimated uniform annual cost) calculator configured to execute a program loop comprising steps of:
determining EUAC for major repairs to calculate the ROI for major work at each age from 0 to t_{recon};
using ROI^{PF}(t) to resolve the ROI (return-on-investment); and
determining a critical PCI for a PCI family PF.

2. The PMA computer of claim 1 wherein the PCI_{crit} determination module is configured to:
determine a second derivative of a family curve to determine a point in the lifetime of a section of pavement where PCI begins to decrease; and
determine a third derivative of a family curve to determine a point in the lifetime of section of payment where decay rate of the pavement quality accelerates.

3. The PMA computer of claim 2 wherein the PCI_{crit} determination module is configured to:
recommend major repair work for a section of pavement that has PCI lower than the critical PCI; and
wherein the critical PCI is a point in the lifetime of a section of pavement wherein preventive maintenance no longer generates a positive ROI.

4. The PMA computer of claim 1 wherein the pavement repair program configured to:
use t_{recon} (an age at which sections in PF reach PCI_{recon}) as an upper boundary of a range of ages;
execute an iteration counter (i) initially set to 1; and
initially set a current estimated critical PCI (C_{curr}) as an input estimate; C_{curr} means current condition.

5. The PMA computer of claim 1 wherein the EUAC calculator is configured to:
locate a t value wherein ROI^{PF}(t) is maximized; and
set the PCI at this age to be a candidate in a next estimate.

6. The PMA computer of claim 1 wherein the EUAC calculator is configured to determine a current program loop to have converged and selecting the current estimate as a result when a computed difference between a candidate in a new estimate and the candidate in the previous estimate is below a threshold value.

7. The PMA computer of claim 1 wherein the EUAC calculator is configured to determine a current program loop to have converged and selecting the current estimate as a result when a computed new candidate estimate is outside an acceptable range.

8. The PMA computer of claim 4 wherein the EUAC calculator is configured to:
check against an iteration boundary to avoid non-convergence of the iteration; and
increment the iteration counter, setting the new estimate, and repeating the program loop.

9. The PMA computer of claim 4 wherein the EUAC calculator is configured to use inspection or work history data to shift the curve PF.

10. A computer comprising a processor and tangible memory storing non-transitory computer readable software configured to cause the processor to execute a pavement repair program specialized in determining the effect on pavement life of localized prevent maintenance and repair and solving a proportionality function based on PF and MF; the program comprising:
an input interface configured to allow a user to specify to the program:
a Section of pavement for evaluation (S);
a PCI family (PF) assigned to Section (S) defined as PF^{S}; wherein PCI is a pavement condition index of the Section;
a critical PCI (PCI_{crit}) for PF^{S};
a M&R family (MF^{S}) assigned to S;
a Major$_{crit}: representing the unit cost for doing major at the Section's critical PCI;
an estimate for ΔT²⁰, the lifespan gain (for a family built without preventive) or lifespan loss (for a family built with preventive) for a pavement that has twenty-year life with preventive; and
a decision as to whether the PCI family assigned to S was built using data from sections on which localized preventative maintenance was performed regularly or not;
the pavement repair program is configured to analyze two different scenarios depending on whether the PCI family assigned to S was built using data from sections on which localized preventive was performed regularly (“family built with preventive maintenance”) or not (“family built without preventive maintenance”);
for scenarios involving a PCI family built with preventive maintenance, the pavement repair program is configured to:
use the PCI family to determine EUAC^{S}_{w}(tₑᵥₐₗ); and
estimate a lifespan loss of the Section for not doing preventive maintenance;
for scenarios involving a PCI family built without preventive maintenance, the pavement repair program is configured to estimate the lifespan gain for doing preventive maintenance; and
the repair program is configured to calculate P(PF, MF) by solving the equation
$$P ( PF , MF ) = \frac{1 - {k}_{w}}{1 - {k}_{20}}$$
through determining values for K₂₀ and K_{w}; P is a proportionality function based on PF and MF; K_{w} is a ratio of the lifetime cost without preventative maintenance divided by lifetime cost with preventative maintenance for a life with preventative of w; w is years of life of a section of pavement until the critical PCI is reached; K₂₀ is K_{w} wherein w is 20.

11. The PMA computer of claim 10 wherein the repair program is configured to analyze localized preventive work that has economic value.

12. The PMA computer of claim 10 wherein the repair program is configured to analyze local climate and environmental to arrive at an estimate of ΔT^{x}; ΔT^{X} being a lifespan gain in X time (for a family built without preventive) or lifespan loss in X time (for a family built with preventive) for a pavement that has a lifespan of X time with preventive maintenance.

13. The PMA computer of claim 12 wherein X is 20 and time is in years, such that ΔT²⁰ is a lifespan change over 20 years.

14. The PMA computer of claim 10 wherein the repair program is configured to calculate a lifespan gain or loss for section S such that ΔT^{S} is proportional to ΔT²⁰; wherein ΔT^{S}=P(PF, MF) ΔT²⁰, P is a proportionality function based on PF and MF, and the lifespan with preventive maintenance (T_{w}) is 20 years.

15. The PMA computer of claim 10 wherein the repair program is configured to set PF²⁰ to be a family curve shifted to pass through T_{wo}, PCI_{crit} for families of Sections built without preventive maintenance.

16. The PMA computer of claim 10 wherein the repair program is configured to calculate the annual age adjustment Aa as the lifespan gain ΔT²⁰ divided by T_{w}.

17. The PMA computer of claim 10 wherein the repair program is configured to calculate conditions with preventive from 0 to T_{w} by applying PF²⁰ at each age i from 0 to T_{w} but first decrementing the age by iΔa.

18. The PMA computer of claim 10 wherein the repair program is configured to calculate conditions without preventive C_{wo} from 0 to T_{wo} by directly using PF²⁰.

19. The PMA computer of claim 10 wherein the repair program is configured to set PF²⁰ to be the family curve shifted to pass through T_{w}, PCI_{crit} for families built with preventive maintenance.

20. The PMA computer of claim 10 wherein the repair program is configured to calculate the annual age adjustment Aa as the life loss ΔT²⁰ divided by T_{wo}.

21. The PMA computer of claim 10 wherein the repair program is configured to apply PF²⁰ at each age i from 0 to T_{w} but first incrementing the age by iΔa for the conditions without preventive maintenance from 0 to T_{wo}.

22. The PMA computer of claim 10 wherein the repair program is configured to calculate directly using PF²⁰ for the conditions with preventive C_{w} from 0 to T_{w}.

23. The PMA computer of claim 10 wherein the repair program is configured to calculate k₂₀ using an KW equation using provided inputs and preventive and safety costs; the KW equation is: ((Major$_{crit}+s$_{wo})/(Major$_{crit}+p$_{w})); p$ᵢ represents a unit cost of doing preventive work on the section at age i; s$ᵢ represents a unit cost of doing safety work on the section at age i.

24. The PMA computer of claim 10 wherein the repair program is configured to calculate safety costs by using the conditions C_{wo} from ages 0 to T_{wo} and a safety cost curve in MF to yield the total safety costs.

25. The PMA computer of claim 10 wherein the repair program is configured to calculate preventive costs by using the conditions C_{w} from ages 0 to T_{w} and a preventive cost curve in MF to get the total preventive cost.

26. The PMA computer of claim 10 wherein the repair program is configured to determine T^{S}_{wo} using the family curve shifted based section history for families built without preventative maintenance.

27. The PMA computer of claim 10 wherein the repair program is configured to set an upper bound (U) to be U=max(2 ΔT²⁰, ΔT²⁰×T^{S}_{wo}/(20−ΔT²⁰)) for families built without preventative maintenance.

28. The PMA computer of claim 10 wherein the repair program is configured to determine T^{S}_{w} using the family curve shifted based section history for families built with preventative maintenance.

29. The PMA computer of claim 10 wherein the repair program is configured to set an upper bound (U) to be U=max(2 ΔT²⁰, ΔT²⁰×T^{S}_{w}/(20−ΔT²⁰)) for families built with preventative maintenance; and execute a binary search beginning with an estimated ΔT^{S} of U/2; max means maximum.
